(19) United States
(12) Patent Application Publication
(10) Pub. No.: US 2026/0210830 A1
(43) Pub. Date: Jul. 23, 2026

(54) READY TO USE DAILY QC FLUOROSPHERES

(71) Applicant: BECKMAN COULTER, INC., Brea, CA (US)

(72) Inventors: James TUNG, Brea, CA (US); Kelly ANDREWS, Brea, CA (US); Milan POPOVIC, Brea, CA (US); Jonel LAWSON, Brea, CA (US)

(21) Appl. No.: 19/138,438

(22) PCT Filed: Jan. 10, 2024
(86) PCT No.: PCT/US2024/011073

§ 371 Date: Jun. 12, 2025

Related U.S. Application Data
(60) Provisional application No. 63/479,305, filed on Jan. 10, 2023.

(51) Int. Cl. G01N 15/10

(52) U.S. Cl. CPC G01N 15/1012; G01N 2015/1014; G01N 2015/1026

(57) ABSTRACT

The present disclosure provides compositions, methods, and kits to improve the quality control of a flow cytometer by using fluorospheres encapsulated with at least one dye having an infrared fluorescence emission and at least one dye having at least one fluorescence emission between 355 nm and 800 nm. In an embodiment, a composition is a suspension for quality control of a flow cytometer comprising fluorospheres, wherein the suspension of fluorospheres include individual fluorospheres having an infrared fluorescence emission greater than 800 nm when excited with an infrared laser and at least one fluorescence emission between 355 nm and 800 nm when excited at a wavelength of less than 800 nm, at least one surfactant, and at least one stabilizer or preservative.

This application is being filed on Jan. 10, 2024, as a PCT International Patent Application and claims the benefit of and priority to U.S. Provisional Patent Application Ser. No. 63/479,305, filed on Jan. 10, 2023, the entire disclosure of which is incorporated by reference in its entirety.

### INTRODUCTION

Biological laboratory instruments automatically measure analytes and compositions. Using automated instruments to perform blood chemistry and cell analysis increases laboratory efficiency and the test accuracy. As laboratories became more dependent on these instruments, and as the instruments became more sensitive at measuring samples at lower and lower concentrations, it became necessary to calibrate the instruments frequently to assure that the data produced was both accurate and precise. One such instrument is a flow cytometer. In flow cytometry, single cells in solution flow through a beam of laser light resulting in light scattered in the forward and the side directions. The scattered light is then collected by photodetectors, analyzed and the cells are counted according to the analyzed characteristics. In addition to measuring scattered light, flow cytometers can also measure fluorescence, e.g., fluorescence labeled antibodies or markers. Flow cytometers have become more sensitive and capable of measuring more parameters as the technology has matured. With this technological maturity has come complexity such that a flow cytometer is now able to measure the intensity of multiple fluorescent stains, particle size, and structure as measured by scattering angle at substantially the same time.

To ensure the quality of patient results, flow cytometers require frequent, multiple calibrations and quality control prior to analyzing and reporting patient results. Such calibrations can be time consuming, adding cost and reducing the useful daily working hours of the instrument in the lab.

Currently, flow cytometers equipped with both an infrared (“IR”) laser (e.g., 808 nm) and additional lasers (e.g., less than 800 nm) require the use of two different quality control kits or processes (e.g., two different sets of fluorospheres) before the performance of all lasers in the flow cytometer is verified. For example, a Beckman Coulter CytoFLEX Platform flow cytometer equipped with an IR (808 nm) laser requires the use of two different single peak quality control (“QC”) fluorospheres to perform quality control on the instrument: CytoFLEX Ready to Use Daily QC Fluorospheres (PN C65719) are used to evaluate the performance of the five non IR lasers (UV, Violet, Blue, Yellow, and Red) while the CytoFLEX Daily IR QC Fluorospheres (PN C06147) are used to evaluate the performance of the IR laser on the instrument.

Quality control fluorospheres designed for non-IR lasers, like the CytoFLEX Ready to Use QC Fluorospheres, are not excited by the IR laser and are therefore not suitable to qualify IR channels on a flow cytometer with an IR laser. In contrast, quality control fluorospheres designed for IR lasers, like the CytoFLEX IR QC Fluorospheres, contain dye that is excited by the IR laser and cannot be used to qualify UV, Violet, Blue, Yellow-Green, or Red lasers on a flow cytometer.

Accordingly, a user of a flow cytometer with an IR laser must currently use two different quality control fluorospheres to confirm the flow cytometer is calibrated and ready for samples. The need to use two different quality control fluorospheres, one for non-IR lasers and one for an IR laser, is time consuming and burdensome for the user.

The present invention eliminates the need for two different sets of quality control fluorospheres when performing quality control on a flow cytometer equipped with an IR laser by providing one set of QC fluorospheres that can be used for quality control. Simply, the present invention provides a single set of fluorospheres, rather than two different sets of fluorospheres, for quality control of all lasers on a flow cytometer, thereby eliminating the need to quality control a flow cytometer twice with two different sets of fluorospheres.

An embodiment of the present compositions, methods, and kits will contain fluorospheres composed of at least two dyes incorporated in the polystyrene beads that can be excited by all lasers (UV, Violet, Blue, Yellow, Red, and IR) in a flow cytometer. The present invention includes a complete daily quality control fluorosphere solution for a flow cytometer. Fluorosphere suspensions, methods of use, and kits of the present invention can be used to evaluate alignment of all lasers, calculate laser delay, and evaluate fluidic stability on a flow cytometer.

An embodiment of the present invention will have specifications of less than 5 us difference in delay settings, less than 20% percent difference in target gain settings, and less than 5% percent difference in target median fluorescence intensity. In an embodiment of the present invention, the robust coefficient of variation (“rCV”) must be less than 6% in target detector channels. In an embodiment, the target detector channel will either be detector 3 or detector 4 for UV, Violet, Blue, Yellow-Green, and Red channels, and detector 1 or detector 2 for IR channels. These channels are selected because the dyes are brightest in these regions with low rCVs.

Currently, non-IR fluorospheres, are sold in a 1-peak, 3-peak, 4-peak, 6-peak, 8-peak, and 9-peak formats for molecules of equivalent soluble fluorochrome (“MESF”) calibration to determine detector sensitivity, but these fluorospheres do not contain IR dye and are not suitable for quality control of an IR laser in a flow cytometer. In order to meet the needs of users who desire flow cytometry sensitivity assessment as part of their QC process, an alternative embodiment of the present invention includes QC Fluorospheres in a multipeak format (Peak 7, Peak 4, Peak 2) and assigned molecules of equivalent soluble fluorochrome (“MESF”) values. This embodiment is used to calculate the MESF sensitivity of the instrument. This embodiment is an optional quality control composition, method, and kit for determining sensitivity and can be used in conjunction with single peak embodiments.

### BRIEF SUMMARY OF THE INVENTION

The compositions, methods, and kits of the present invention offer significant advantages over the currently available fluorospheres used for quality control of a flow cytometer having both IR and non-IR lasers. The compositions, methods, and kits of the present invention eliminate the need to use two different quality control fluorospheres, and perform two different quality controls, by combining dyes that are excited by both non-IR and IR lasers into a single fluorosphere. Accordingly, a single suspension of the present invention has fluorophores comprising both IR and non-IR excitable dyes and therefore eliminates the need to quality control IR lasers with one set of quality control fluorospheres and quality control non-IR lasers with a second set of quality control fluorospheres.

### Compositions for Quality Control of a Flow Cytometer.

An embodiment of the present invention is a suspension for quality control of a flow cytometer comprising fluorospheres, wherein the suspension of fluorospheres include individual fluorospheres having an infrared fluorescence emission greater than 800 nm when excited with an infrared laser and at least one fluorescence emission between 355 nm and 800 nm when excited at a wavelength of less than 800 nm, at least one surfactant, and at least one stabilizer or preservative. The individual fluorospheres are encapsulated with at least one dye having an infrared fluorescence emission greater than 800 nm when excited with an infrared laser and at least one dye having at least one fluorescence emission between 355 nm and 800 nm when excited at a wavelength of less than 800 nm.

In an embodiment, the at least one dye having an infrared fluorescence emission greater than 800 nm when excited with an infrared laser is selected from the group consisting of: Aqua Green, Jade Green, Cy Green, Indo cyanine green (ICG), Cy7, or Cy7.5, IR dye 800CW, or any combination thereof. In an embodiment, the at least one dye having an infrared fluorescence emission greater than 800 nm is excited with an infrared laser at a wavelength of 808 nm.

In an embodiment, the at least one dye having at least one fluorescence emission between 355 nm and 800 nm when excited at a wavelength of less than 800 nm is selected from the group consisting of: a small organic dye, a phycobiliprotein, quantum dots, a polymer dye, a fluorescent protein, a tandem dye, UV, Light Yellow, Yellow, Nile Red, Purple, Blue, Sky Blue, or any combination thereof. In certain embodiments, the individual fluorospheres are encapsulated with at least seven dyes having seven fluorescence emissions between 355 nm and 800 nm when excited at a wavelength of less than 800 nm selected from the group consisting of: a small organic dye, a phycobiliprotein, quantum dots, a polymer dye, a fluorescent protein, a tandem dye, UV, Light Yellow, Yellow, Nile Red, Purple, Blue, Sky Blue, or any combination thereof. In certain embodiments, the individual fluorospheres are encapsulated with seven dyes having seven fluorescence emissions between 355 nm and 800 nm when excited by five or six lasers having the following wavelengths: 355 nm, 375 nm, 405 nm, 488 nm, 561 nm, and 638 nm. In certain embodiments, the individual fluorospheres are encapsulated with eight dyes having eight fluorescence emissions when excited by six or seven lasers having the following wavelengths: 355 nm (UV), 375 nm, 405 nm (Violet), 488 nm (Blue), 561 nm (Yellow-Green), 638 nm (Red), and 808 nm (Infrared).

The fluorospheres of the present invention may be polystyrene beads. In an embodiment, the fluorospheres have a diameter of between 2.5 μm and 6.5 μm, between 2.8 μm and 3.4 μm, or are about 3.0 μm.

In certain embodiments, the fluorospheres in the suspension have a concentration between 0.4×10⁶ fluorospheres/mL and 1.5×10⁶ fluorospheres/mL, a concentration between 0.9×10⁶ fluorospheres/mL and 1.1×10⁶ fluorospheres/mL, or concentration of about 1.0×10⁶ fluorospheres/mL.

In an embodiment of the present invention, the at least one surfactant is selected from the group consisting of: an ionic surfactant, a non-ionic surfactant, Sodium Dodecyl Sulfate (SDS), NP-40s, Ecosurf EH-9, Ecosurf SA-9, Ecosurf Tween 20, Triton X-11, or any combination thereof. In certain embodiments, the at least one surfactant is at a concentration between 0.01% and 1% based on the total volume of the suspension. In certain embodiments, the at least one surfactant is EcoSurf EH-9 at a concentration is 0.05% based on the total volume of the suspension.

In an embodiment of the present invention, the at least one stabilizer is selected from the group consisting of: a stabilized reducing agent, a stabilized thiol containing compound, (S)-2-Aminobutane-1,4-dithiol hydrochloride, dithiothreitol (DTT), Tris(2-carboxyethyl)phosphine (TCEP) or any combination thereof. In an embodiment of the present invention, the at least one preservative is selected from the group consisting of: sodium azide, thimerosal, or any combination thereof

### Methods for Quality Control of a Flow Cytometer.

An embodiment of the present invention includes a method for quality controlling a flow cytometer using a single peak comprising: (a) loading a quality control suspension of the present invention, (b) evaluating at least one of the following: (i) evaluating power of at least one laser in the flow cytometer based on a single peak analysis, (ii) evaluating EPS of at least one laser in the flow cytometer based on a single peak analysis, (iii) evaluating laser delay of at least one laser in the flow cytometer based on a single peak analysis, (iv) evaluating gain of at least one laser in the flow cytometer based on a single peak analysis, (v) evaluating rCV of at least one laser in the flow cytometer based on a single peak analysis, and (c) determining whether the flow cytometer passes or fails quality control based on the evaluations in step (b).

In an embodiment, the evaluating in step (b) includes evaluating each of steps (b)(i) through (b)(v). In an embodiment, the evaluation in step (b) is performed on an infrared laser and at least one laser with a wavelength of less than 800 nm. In certain embodiments, the evaluation in step (b) is performed on seven lasers including the following wavelengths: 355 nm (UV), 375 nm (UV), 405 nm (Violet), 488 nm (Blue), 561 nm (Yellow-Green), 638 nm (Red), and 808 nm (Infrared). In certain embodiments, the 355 nm (UV) laser, 405 nm (Violet) laser, 488 nm (Blue) laser, 561 nm (Yellow-Green) laser, and 638 nm (Red) laser are evaluated on selected detector channel 3 or detector channel 4 of the flow cytometer, and the 808 nm (Infrared) laser is evaluated on selected detector channel 1 or detector channel 2 of the flow cytometer.

In certain embodiments, the method includes generating a quality control report following step (c). In additional embodiments, the method for quality controlling a flow cytometer is performed at least once per day. In certain embodiments, the method for quality controlling a flow cytometer is performed before using the flow cytometer to analyze samples.

An alternative embodiment of the present invention includes a method for quality controlling a flow cytometer using multiple peaks comprising: (a) loading a quality control suspension of the present invention into the flow cytometer to perform a quality control analysis based on more than one peak, (b) adjusting the brightest peak to a target median fluorescence intensity, (c) reading the median fluorescence intensity and rCV for each of the peaks, (d) unloading the quality control suspension from the flow cytometer following step (c), (e) loading polystyrene beads without encapsulated fluorescence into the flow cytometer, (f) reading the median fluorescence intensity for the polystyrene beads without encapsulated fluorescence, and (g) calculating a sensitivity and background. In certain embodiments, the multiple peaks include three peaks comprising a bright peak, a mild peak, and a dim peak.

In an embodiment, the target median fluorescence intensity for step (f) is between 500,000 and 4×10⁶. In certain embodiments, the sensitivity and background comprise MESF sensitivity, Quantum efficiency, or Background.

In certain embodiments, step (a) loading a quality control suspension of the present invention into the flow cytometer to perform a quality control analysis based on more than one peak is concurrent with step (e) loading polystyrene beads without fluorescence into the flow cytometer. In certain embodiments, a method further includes generating a quality control report following step (k).

### Kits for Quality Control of a Flow Cytometer.

An embodiment of the present invention includes a kit for performing a method of the present invention, the kit comprising a suspension of the present invention, at least one vial to hold the suspension, and instructions for using the kit. In certain embodiments, a kit may further comprise a second vial to hold a suspension of the present invention. In certain embodiments, the vials are each 10 mls.

In certain embodiments, a kit will include a second vial containing a suspension of polystyrene beads with no dye. In certain embodiments, the diameter of the polystyrene beads with no dye in a second vial is about 1 μm. In certain embodiments, the concentration of the polystyrene beads in the second vial is between 0.4×10⁶ fluorospheres/mL and 1.5×10⁶ fluorospheres/mL.

### BRIEF DESCRIPTION OF THE FIGURES

FIG. 1 shows an embodiment of a presently disclosed method for quality controlling a flow cytometer with a suspension of the present invention using a single peak.

FIG. 2 shows an alternative embodiment of a presently disclosed method for quality controlling a flow cytometer with a suspension of the present invention using multiple peaks.

FIG. 3 shows an analysis of dye leak over time from fluorospheres with a single dye in order to understand dye leak and its impact on rCVs and singlet percentage. Specially, FIG. 3 shows the gating strategy for each dye. FIG. 3A shows the gating strategy for fluorospheres with UV dye. FIG. 3B shows the gating strategy for fluorophores with Light Yellow dye. FIG. 3C shows the gating strategy for fluorophores with Yellow dye. FIG. 3D shows the gating strategy for fluorospheres with Nile Red dye. FIG. 3E shows the gating strategy for fluorospheres with Purple dye. FIG. 3F shows the gating strategy for fluorospheres with Blue dye. FIG. 3G shows the gating strategy for fluorospheres with Sky Blue dye. FIG. 3H shows the gating strategy for fluorospheres with Aqua Green dye (IR excitable dye). FIG. 3I shows the gating strategy for fluorospheres with CyGreen dye (IR excitable dye). FIG. 3J shows the mean diameter (um) for each of the single dyes.

FIG. 4 shows an analysis of dye leak over time (Day 0, Day 3, Day 16, Day 22, and Day 24) from fluorospheres with a single dye. Specifically, FIG. 4 shows the median fluorescence intensity (“MdFl”) % difference on emitted channels (FIGS. 4A, 4C, 4E) at Day 0, Day 3, Day 16, Day 22, and Day 24, and the MdFl for all the spectrum (FIGS. 4B, 4D, 4F) at Day 0, Day 3, Day 16, Day 22, and Day 24. FIG. 4A shows the MdFl % difference for fluorospheres with UV on emitted channels and FIG. 4B shows the MdFl for the same fluorospheres across the spectrum at Day 0, Day 3, Day 16, Day 22, and Day 24. FIG. 4C shows the MdFl % difference for fluorospheres with Light Yellow dye on emitted channels and FIG. 4D shows the MdFl for the same fluorospheres across the spectrum at Day 0, Day 3, Day 16, Day 22, and Day 24. FIG. 4E shows the MdFl % difference for fluorospheres with Yellow dye on emitted channels and FIG. 4F shows the MdFl for the same fluorospheres across the spectrum at Day 0, Day 3, Day 16, Day 22, and Day 24. FIG. 4G shows the MdFl % difference for fluorospheres with Nile Red dye on emitted channels and FIG. 4H shows the MdFl for the same fluorospheres across the spectrum at Day 0, Day 3, Day 16, Day 22, and Day 24. FIG. 4I shows the MdFl % difference for fluorospheres with Purple dye on emitted channels and FIG. 4J shows the MdFl for the same fluorospheres across the spectrum at Day 0, Day 3, Day 16, Day 22, and Day 24. FIG. 4K shows the MdFl % difference for fluorospheres with Blue dye on emitted channels and FIG. 4L shows the MdFl for the same fluorospheres across the spectrum at Day 0, Day 3, Day 16, Day 22, and Day 24. FIG. 4M shows the MdFl % difference for fluorospheres with Sky Blue dye on emitted channels and FIG. 4N shows the MdFl for the same fluorospheres across the spectrum at Day 0, Day 3, Day 16, Day 22, and Day 24. FIG. 4O shows the MdFl % difference for fluorospheres with Jade Green dye (IR excited) on emitted channels and FIG. 4P shows the MdFl for the same fluorospheres across the spectrum at Day 0, Day 3, Day 16, Day 22, and Day 24. FIG. 4Q shows the MdFl % difference for fluorospheres with CyGreen dye (IR excited) on emitted channels and FIG. 4R shows the MdFl for the same fluorospheres across the spectrum at Day 0, Day 3, Day 16, Day 22, and Day 24. FIG. 4S shows the MdFl % difference for fluorospheres with Aqua Green dye (IR excited) on emitted channels and FIG. 4T shows the MdFl for the same fluorospheres across the spectrum at Day 0, Day 3, Day 16, Day 22, and Day 24.

FIG. 5 shows the analysis of dye leak from fluorospheres of the present invention based upon dilution at three different volumes (0.5 ml, 1.0 ml, and 2.0 ml) to a concentration of 1×10⁶ beads/sample using two different buffers Ecosurf EH-9 (CAS: 64366-70-7) and Ecosurf SA-9 (CAS: 68937-66-6). FIG. 5A-5C are based upon Table 10 herein and disclose the gate analysis for fluorospheres of the present invention (Set 7.2) diluted to 0.5 ml with Ecosurf EH-9 four days after dilution (FIG. 5A), diluted to 1.0 ml with Ecosurf EH-9 four days after dilution (FIG. 5B), and diluted to 2.5 mls with Ecosurf EH-9 four days after dilution (FIG. 5C). FIGS. 5D-5F shows the MdFl % difference for the samples analyzed in FIGS. 5A-5C, respectively. FIGS. 5G-5I show the MdFl % difference for fluorospheres of the present invention diluted to 0.5 ml with Ecosurf SA-9 (FIG. 5G), diluted to 1.0 ml with Ecosurf SA-9 (FIG. 5H), and diluted to 2.5 ml with Ecosurf SA-9 (FIG. 5I). FIGS. 5J-5K shows MdFl over time (Day 0, Day 4, Day 7, Day 18, Day 20, Day 25, Day 27) for fluorospheres of the present invention diluted to 0.5 ml in Ecosurf EH-9 (FIG. 5J) and diluted to 2.5 ml in Ecosurf EH-9 (FIG. 5K). FIGS. 5L-5M show MdFl over time (Day 0, Day 4, Day 7, Day 18, Day 20, Day 25, Day 27 (only for Ecosurf EH-9)) for fluorospheres of the present invention diluted to 2.5 ml in Ecosurf EH-9 (FIG. 5L) and diluted to 2.5 ml in Ecosurf SA-9 (FIG. 5M).

FIG. 6 shows the analysis of light exposure (1500 lux at different time points) to fluorospheres of the present invention based upon an analysis of rCV in comparison to Day 0. FIGS. 6A-6D show rCV analysis of fluorospheres of the present invention (Set 7.2 compared to Set 10.1 and Set 10.2) at channel U3A at 15 minutes, 30 minutes, 1 hour, 2 hours, 3 hours, 4 hours, 6 hours, and 9 hours. Specifically, FIG. 6A shows the rCV analysis of Set 7.2. FIG. 6B shows the rCV analysis of set 10.1 diluted in sodium dodecyl sulfate (“SDS”) to 1×10⁶ fluorospheres per ml. FIG. 6C shows the rCV analysis of Set 10.2 diluted and resuspended in SDS with 0.05% Ecosurf EH-9 and 0.02% sodium azide. FIG. 6D shows the rCV analysis of Set 10.2 diluted and resuspended in SDS with 0.1% ethanolamine, 0.05% Ecosurf EH-9, and 0.02% sodium azide.

FIG. 7 shows the analysis of light exposure (1500 lux at different time points) to fluorospheres of the present invention based upon an analysis of rCV in comparison to Day 0. FIGS. 7A-7D show rCV analysis of fluorospheres of the present invention (Set 7.2 compared to Set 10.1 and Set 10.2) at channel U3A at 15 minutes, 30 minutes, 1 hour, 2 hours, 3 hours, 4 hours, 6 hours, and 9 hours. Specifically, FIG. 7A shows the rCV analysis of Set 7.2. FIG. 7B shows the rCV analysis of set 10.1 diluted in SDS to 1×10⁶ fluorospheres per ml. FIG. 7C shows the rCV analysis of Set 10.2 diluted and resuspended in SDS with 0.05% Ecosurf EH-9 and 0.02% sodium azide. FIG. 7D shows the rCV analysis of Set 10.2 diluted and resuspended in SDS with 0.1% ethanolamine, 0.05% Ecosurf EH-9, and 0.02% sodium azide.

FIG. 8 shows the analysis of light exposure (1500 lux at different time points) to fluorospheres of the present invention based upon an analysis of rCV in comparison to Day 0. FIGS. 8A-8D show rCV analysis of fluorospheres of the present invention (Set 7.2 compared to Set 10.1 and Set 10.2) at channel B3A at 15 minutes, 30 minutes, 1 hour, 2 hours, 3 hours, 4 hours, 6 hours, and 9 hours. Specifically, FIG. 8A shows the rCV analysis of Set 7.2. FIG. 8B shows the rCV analysis of Set 10.1 diluted in SDS to 1×10⁶ fluorospheres per ml. FIG. 8C shows the rCV analysis of Set 10.2 diluted and resuspended in SDS with 0.05% Ecosurf EH-9 and 0.02% sodium azide. FIG. 8D shows the rCV analysis of Set 10.2 diluted and resuspended in SDS with 0.1% ethanolamine, 0.05% Ecosurf EH-9, and 0.02% sodium azide.

FIG. 9 shows the analysis of light exposure (1500 lux at different time points) to fluorospheres of the present invention based upon an analysis of rCV in comparison to Day 0. FIGS. 9A-9D show rCV analysis of fluorospheres of the present invention (Set 7.2 compared to Set 10.1 and Set 10.2) at channel Y3A at 15 minutes, 30 minutes, 1 hour, 2 hours, 3 hours, 4 hours, 6 hours, and 9 hours. Specifically, FIG. 9A shows the rCV analysis of Set 7.2. FIG. 9B shows the rCV analysis of Set 10.1 diluted in SDS to 1×10⁶ fluorospheres per ml. FIG. 9C shows the rCV analysis of Set 10.2 diluted and resuspended in SDS with 0.05% Ecosurf EH-9 and 0.02% sodium azide. FIG. 9D shows the rCV analysis of Set 10.2 diluted and resuspended in SDS with 0.1% ethanolamine, 0.05% Ecosurf EH-9, and 0.02% sodium azide.

FIG. 10 shows the analysis of light exposure (1500 lux at different time points) to fluorospheres of the present invention based upon an analysis of rCV in comparison to Day 0. FIGS. 10A-10D show rCV analysis of fluorospheres of the present invention (Set 7.2 compared to Set 10.1 and Set 10.2) at channel R3A at 15 minutes, 30 minutes, 1 hour, 2 hours, 3 hours, 4 hours, 6 hours, and 9 hours. Specifically, FIG. 10A shows the rCV analysis of Set 7.2. FIG. 10B shows the rCV analysis of Set 10.1 diluted in SDS to 1×10⁶ fluorospheres per ml. FIG. 10C shows the rCV analysis of Set 10.2 diluted and resuspended in SDS with 0.05% Ecosurf EH-9 and 0.02% sodium azide. FIG. 10D shows the rCV analysis of Set 10.2 diluted and resuspended in SDS with 0.1% ethanolamine, 0.05% Ecosurf EH-9, and 0.02% sodium azide.

FIG. 11 shows the analysis of light exposure (1500 lux at different time points) to fluorospheres of the present invention based upon an analysis of rCV in comparison to Day 0. FIGS. 11A-11D show rCV analysis of fluorospheres of the present invention (Set 7.2 compared to Set 10.1 and Set 10.2) at channel IRIA at 15 minutes, 30 minutes, 1 hour, 2 hours, 3 hours, 4 hours, 6 hours, and 9 hours. Specifically, FIG. 11A shows the rCV analysis of Set 7.2. FIG. 11B shows the rCV analysis of Set 10.1 diluted in SDS to 1×10⁶ fluorospheres per ml. FIG. 11C shows the rCV analysis of Set 10.2 diluted and resuspended in SDS with 0.05% Ecosurf EH-9 and 0.02% sodium azide. FIG. 11D shows the rCV analysis of Set 10.2 diluted and resuspended in SDS with 0.1% ethanolamine, 0.05% Ecosurf EH-9, and 0.02% sodium azide.

FIG. 12 shows a comparison of the MdFl for channels IRIA (FIGS. 12A-12C) and IR2A (FIGS. 12D-12F) for the same samples evaluated in FIG. 11 and FIG. 13. Specifically, FIG. 12A shows the MdFl analysis of Set 10.1 diluted in SDS to 1×10⁶ fluorospheres per ml. FIG. 12B shows the MdFl analysis of Set 10.2 diluted and resuspended in SDS with 0.05% Ecosurf EH-9 and 0.02% sodium azide. FIG. 12C shows the MdFl analysis of Set 10.2 diluted and resuspended in SDS with 0.1% ethanolamine, 0.05% Ecosurf EH-9, and 0.02% sodium azide. FIG. 12D shows the MdFl analysis of Set 10.1 diluted in SDS to 1×10⁶ fluorospheres per ml. FIG. 12E shows the MdFl analysis of Set 10.2 diluted and resuspended in SDS with 0.05% Ecosurf EH-9 and 0.02% sodium azide. FIG. 12F shows the MdFl analysis of Set 10.2 diluted and resuspended in SDS with 0.1% ethanolamine, 0.05% Ecosurf EH-9, and 0.02% sodium azide.

FIG. 13 shows the analysis of light exposure (1500 lux at different time points) to fluorospheres of the present invention based upon an analysis of rCV in comparison to Day 0. FIGS. 13A-13D show rCV analysis of fluorospheres of the present invention (Set 7.2 compared to Set 10.1 and Set 10.2) at channel IR2A at 15 minutes, 30 minutes, 1 hour, 2 hours, 3 hours, 4 hours, 6 hours, and 9 hours. Specifically, FIG. 13A shows the rCV analysis of Set 7.2. FIG. 13B shows the rCV analysis of Set 10.1 diluted in SDS to 1×10⁶ fluorospheres per ml. FIG. 13C shows the rCV analysis of Set 10.2 diluted and resuspended in SDS with 0.05% Ecosurf EH-9 and 0.02% sodium azide. FIG. 13D shows the rCV analysis of Set 10.2 diluted and resuspended in SDS with 0.1% ethanolamine, 0.05% Ecosurf EH-9, and 0.02% sodium azide.

FIG. 14 shows the analysis of light exposure (1500 lux at different time points) to fluorospheres of the present invention based upon an analysis of rCV in comparison to Day 0. FIGS. 14A-14D show rCV analysis of fluorospheres of the present invention (Set 7.2 compared to Set 10.1 and Set 10.2) at channel IR3A at 15 minutes, 30 minutes, 1 hour, 2 hours, 3 hours, 4 hours, 6 hours, and 9 hours. Specifically, FIG. 14A shows the rCV analysis of Set 7.2. FIG. 14B shows the rCV analysis of Set 10.1 diluted in SDS to 1×10⁶ fluorospheres per ml. FIG. 14C shows the rCV analysis of Set 10.2 diluted and resuspended in SDS with 0.05% Ecosurf EH-9 and 0.02% sodium azide. FIG. 14D shows the rCV analysis of Set 10.2 diluted and resuspended in SDS with 0.1% ethanolamine, 0.05% Ecosurf EH-9, and 0.02% sodium azide.

FIG. 15 shows an MdFl analysis (channel IRIA and IR2A) of Set 10.1 and Set 10.2 based upon light exposure of 1500 lux or 3500 lux at 0 Hours, 15 minutes, 30 minutes, 1 hour, 2 hours, 4 hours, and 6 hours. FIG. 15A shows the MdFl analysis of Set 10.1 diluted in SDS to 1×10⁶ fluorospheres per ml with a light exposure of 3500 lux (channel IRIA). FIG. 15B shows the MdFl analysis of Set 10.1 washed in SDS and resuspended in SDS with 0.05% Ecosurf EH-9 and 0.02% sodium azide with a light exposure of 3500 lux (channel IRIA). FIG. 15C shows the MdFl analysis of Set 10.2 diluted and resuspended in SDS with 0.05% Ecosurf EH-9 and 0.02% sodium azide (channel IRIA). FIG. 15D shows the MdFl analysis of Set 10.2 diluted and resuspended in SDS with 0.1% ethanolamine, 0.05% Ecosurf EH-9 and 0.02% sodium azide with a light exposure of 1500 lux (channel IRIA). FIG. 15E shows the MdFl analysis of Set 10.2 washed with SDS and resuspended in 0.1% ethanolamine, 0.05% Ecosurf EH-9 and 0.02% sodium azide with a light exposure of 1500 lux (channel IRIA). FIG. 15F shows the MdFl analysis of Set 10.1 diluted in SDS to 1×10⁶ fluorospheres per ml with a light exposure of 1500 lux (channel IR2A). FIG. 15G shows the MdFl analysis of Set 10.1 washed in SDS and resuspended in SDS with 0.05% Ecosurf EH-9, and 0.02% sodium azide with a light exposure of 1500 lux (channel IR2A). FIG. 15H shows the MdFl analysis of Set 10.2 diluted and resuspended in SDS with 0.05% Ecosurf EH-9 and 0.02% sodium azide with a light exposure of 1500 lux (channel IR2A). FIG. 15I shows the MdFl analysis of Set 10.2 diluted in SDS with 0.1% ethanolamine, 0.05% Ecosurf EH-9, and 0.02% sodium azide with a light exposure of 1500 lux (channel IR2A). FIG. 15J shows the MdFl analysis of Set 10.2 washed in SDS and resuspended in SDS with 0.1% ethanolamine, 0.05% Ecosurf EH-9, and 0.02% sodium azide with a light exposure of 1500 lux (channel IR2A).

FIG. 16 shows the fluorosphere preparation process for an embodiment of the present invention, specifically, Set 11 and Set 12. Fluorosphere polymerization (300) is followed by the addition of non-IR dyes (302). IR dyes are added next (304) followed by dialysis (306), washing (308), and resuspension (310).

FIG. 17 shows the evaluation of fluorospheres of the present invention containing either Aqua Green dye or Jade Green dye as the IR excited dye. Both sets of fluorospheres were prepared as shown in FIG. 16. The MdFl analysis is for Peak 2 (FIGS. 17A-17F), Peak 4 (FIGS. 17G-17L), and Peak 7 (FIGS. 17M-17R). FIG. 17A shows the MdFl analysis (Peak 2) of fluorospheres with Aqua Green dye that were incubated at 22° C. at Day 0, Day 5, Day 7, Day 11, Day 14, and Day 18. FIG. 17B shows the MdFl analysis (Peak 2) of fluorospheres with Jade Green dye that were incubated at 22° C. at Day 0, Day 5, Day 7, Day 11, Day 14, and Day 18. FIG. 17C shows the MdFl analysis (Peak 2) of fluorospheres with Aqua Green dye that were incubated at 32° C. at Day 0, Day 5, Day 7, Day 11, Day 14, and Day 18. FIG. 17D shows the MdFl analysis (Peak 2) of fluorospheres with Jade Green dye that were incubated at 32° C. at Day 0, Day 5, Day 7, Day 11, Day 14, and Day 18. FIG. 17E shows the MdFl analysis (Peak 2) of fluorospheres with Aqua Green dye that were incubated at 50° C. at Day 0, Day 5, Day 7, Day 11, Day 14, and Day 18. FIG. 17F shows the MdFl analysis (Peak 2) of fluorospheres with Jade Green dye that were incubated at 50° C. at Day 0, Day 5, Day 7, Day 11, Day 14, and Day 18. FIG. 17G shows the MdFl analysis (Peak 4) of fluorospheres with Aqua Green dye that were incubated at 22° C. at Day 0, Day 5, Day 7, Day 11, Day 14, and Day 18. FIG. 17H shows the MdFl analysis (Peak 4) of fluorospheres with Jade Green dye that were incubated at 22° C. at Day 0, Day 5, Day 7, Day 11, Day 14, and Day 18. FIG. 17I shows the MdFl analysis (Peak 4) of fluorospheres with Aqua Green dye that were incubated at 32° C. at Day 0, Day 5, Day 7, Day 11, Day 14, and Day 18. FIG. 17J shows the MdFl analysis (Peak 4) of fluorospheres with Jade Green dye that were incubated at 32° C. at Day 0, Day 5, Day 7, Day 11, Day 14, and Day 18. FIG. 17K shows the MdFl analysis (Peak 4) of fluorospheres with Aqua Green dye that were incubated at 50° C. at Day 0, Day 5, Day 7, Day 11, Day 14, and Day 18. FIG. 17L shows the MdFl analysis (Peak 4) of fluorospheres with Jade Green dye that were incubated at 50° C. at Day 0, Day 5, Day 7, Day 11, Day 14, and Day 18. FIG. 17M shows the MdFl analysis (Peak 7) of fluorospheres with Aqua Green dye that were incubated at 22° C. at Day 0, Day 5, Day 7, Day 11, Day 14, and Day 18. FIG. 17N shows the MdFl analysis (Peak 7) of fluorospheres with Jade Green dye that were incubated at 22° C. at Day 0, Day 5, Day 7, Day 11, Day 14, and Day 18. FIG. 17O shows the MdFl analysis (Peak 7) of fluorospheres with Aqua Green dye that were incubated at 32° C. at Day 0, Day 5, Day 7, Day 11, Day 14, and Day 18. FIG. 17P shows the MdFl analysis (Peak 7) of fluorospheres with Jade Green dye that were incubated at 32° C. at Day 0, Day 5, Day 7, Day 11, Day 14, and Day 18. FIG. 17Q shows the MdFl analysis (Peak 7) of fluorospheres with Aqua Green dye that were incubated at 50° C. at Day 0, Day 5, Day 7, Day 11, Day 14, and Day 18. FIG. 17R shows the MdFl analysis (Peak 7) of fluorospheres with Jade Green dye that were incubated at 50° C. at Day 0, Day 5, Day 7, Day 11, Day 14, and Day 18. FIG. 17S and FIG. 17T shows the differences at Peak 2, Peak 4, and Peak 7 between fluorospheres with Aqua Green dye (FIG. 17S) and fluorospheres with Jade Green dye (FIG. 17T) at channel IRIA. FIG. 17U and FIG. 17V show the differences at Peak 2, Peak 4, and Peak 7 between fluorospheres with Aqua Green dye (FIG. 17S) and fluorospheres with Jade Green dye (FIG. 17T) at channels U3A, V3A, B3A, Y3A, and R3A.

### DETAILED DESCRIPTION

While the concepts of the present disclosure are illustrated and described in detail in the figures and descriptions herein, results in the figures and their description are to be considered as examples and not restrictive in character; it being understood that only the illustrative embodiments are shown and described and that all changes and modifications that come within the spirit of the disclosure are desired to be protected. Unless defined otherwise, the scientific and technology nomenclatures have the same meaning as commonly understood by a person in the ordinary skill in the art pertaining to this disclosure.

It will be understood by one of ordinary skill in the relevant arts that other suitable modifications and adaptations to the compositions, methods, and kits described herein are readily apparent from the description of the disclosure contained herein in view of information known to the ordinarily skilled artisan, and may be made without departing from the scope of the disclosure or any embodiment thereof.

Although any methods and materials similar or equivalent to those described herein can be used in the practice or testing of the present disclosure, preferred methods and materials are now described.

### Definitions

As used herein, “g” represents gram; “L” represents liter; “mg” represents “milligram (10-3 gram);” “mL” or “cc” represents milliliter (10-3 liter). One “μL” equals to one microliter (10-6 liter). The unit of temperature used herein is degree Celsius (° C.). The term “about” is used in conjunction with numeric values to include normal variations in measurements as expected by persons skilled in the art, and is understood to have the same meaning as “approximately” and to cover a typical margin of error, such as ±15%, ±10%, ±5%, ±1%, ±0.5%, or even ±0.1% of the stated value. Whether or not modified by the term “about,” the claims include equivalents to the quantities. It should be noted that, as used in this specification and the appended claims, the singular forms “a,” “an,” and “the” include plural referents unless the content clearly dictates otherwise. For example, reference to “a method” includes having two or more methods that are either the same or different from each other. It should also be noted that the term “or” is generally employed in its sense including “and/or” unless the content clearly dictates otherwise. As used herein, “and/or” refers to and encompasses any and all possible combinations of one or more of the associated listed items, as well as the lack of combinations when interpreted in the alternative (“or”).

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially” or “about” is utilized herein to represent the inherent degree of uncertainty that can be attributed to any quantitative comparison, value, measurement, or other representation. The term “substantially” or “about” is also utilized herein to represent the degree by which a quantitative representation can vary from a stated reference without resulting in a change in the basic function of the subject matter at issue.

The term “comprise,” “comprises,” and “comprising” as used herein, specify the presence of the stated features, integers, steps, operations, elements, and/or components, but do not preclude the presence or addition of one or more other features, integers, steps, operations, elements, components, and/or groups thereof. The term “quality control” or “quality controlling” as used herein, specify the use of disclosed compositions, methods, and kits to standardize a flow cytometer in order to ensure the reliability and accuracy of data collected by the flow cytometer.

### General Description

The present invention includes a suspension for quality control of a flow cytometer comprising fluorospheres, wherein the suspension of fluorospheres include individual fluorospheres having an infrared fluorescence emission greater than 800 nm when excited with an infrared laser and at least one fluorescence emission between 355 nm and 800 nm when excited at a wavelength of less than 800 nm, at least one surfactant, and at least one stabilizer or preservative.

The individual fluorospheres are encapsulated with at least one dye having an infrared fluorescence emission greater than 800 nm when excited with an infrared laser and at least one dye having at least one fluorescence emission between 355 nm and 800 nm when excited at a wavelength of less than 800 nm.

Embodiments of the present invention have at least two dyes (one IR excitable dye and one non-IR excitable dye) but may have more than two dyes. Fluorospheres of the present invention may between 2 and 15 dyes, between 2 and 13 dyes, between 2 and 11 dyes, between 2 and 9 dyes, between 2 and 8 dyes, or between 2 and 7 dyes. Fluorospheres of the present invention may have greater than 2 dyes, greater than 3 dyes, greater than 4 dyes, greater than 5 dyes, greater than 6 dyes, greater than 7 dyes, or greater than 8 dyes. Fluorospheres of the present invention may have less than 15 dyes, less than 13 dyes, less than 11 dyes, less than 9 dyes, less than 7 dyes, less than 5 dyes, or less than 3 dyes.

In an embodiment, the at least one dye having an infrared fluorescence emission greater than 800 nm when excited with an infrared laser is selected from the group consisting of: Aqua Green, Jade Green, Cy Green, Indo cyanine green (ICG), Cy7, or Cy7.5, IR dye 800CW, or any combination thereof. Embodiments can include any commercially available dye that is excitable by IR lasers. In certain embodiments, fluorospheres contain more than 1 IR excitable dye, more than 2 IR excitable dyes, or more than 3 IR excitable dyes. In an embodiment, the at least one dye having an infrared fluorescence emission greater than 800 nm is excited with an infrared laser at a wavelength of 808 nm. In certain embodiments, the at least one dye having an infrared fluorescence emission is excited with an IR laser having any suitable wavelength.

In an embodiment, the at least one dye having at least one fluorescence emission between 355 nm and 800 nm when excited at a wavelength of less than 800 nm is selected from the group consisting of: a small organic dye, a phycobiliprotein, quantum dots, a polymer dye, a fluorescent protein, a tandem dye, UV, Light Yellow, Yellow, Nile Red, Purple, Blue, Sky Blue, or any combination thereof. Embodiments can include any commercially available dye that is excitable at a wavelength of less than 800 nm. In certain embodiments, fluorospheres have between 1 and 12 non-IR excitable dyes (e.g., dyes excitable at less than 800 nm with a fluorescence emission of between 355 nm and 800 nm), between 1 and 10 non-IR excitable dyes, between 1 and 8 non-IR excitable dyes, between 1 and 6 non-IR excitable dyes, between 1 and 4 non-IR excitable dyes, between 1-3 non-IR excitable dyes. In certain embodiments, fluorospheres have greater than 2 non-IR excitable dyes, greater than 4 non-IR excitable dyes, greater than 6 non-IR excitable dyes, greater than 8 non-IR excitable dyes, or greater than 10 non-IR excitable dyes. In certain embodiments, fluorospheres have less than 12 non-IR excitable dyes, less than 10 non-IR excitable dyes, less than 8 non-IR excitable dyes, less than 6 non-IR excitable dyes, less than 4 non-IR excitable dyes, or less than 2 non-IR excitable dyes.

In certain embodiments, the individual fluorospheres are encapsulated with at least seven dyes having seven fluorescence emissions between 355 nm and 800 nm when excited at a wavelength of less than 800 nm selected from the group consisting of: a small organic dye, a phycobiliprotein, quantum dots, a polymer dye, a fluorescent protein, a tandem dye, UV, Light Yellow, Yellow, Nile Red, Purple, Blue, Sky Blue, or any combination thereof. In certain embodiments, the individual fluorospheres are encapsulated with seven dyes having seven fluorescence emissions between 355 nm and 800 nm when excited by six lasers having the following wavelengths: 355 nm, 405 nm, 488 nm, 561 nm, and 638 nm. While specific laser wavelengths are mentioned, any commercially available laser with a non-IR wavelength is contemplated by the present invention. In certain embodiments, the individual fluorospheres are encapsulated with eight dyes having eight fluorescence emissions when excited by seven lasers having the following wavelengths: 355 nm (UV), 375 nm (UV), 405 nm (Violet), 488 nm (Blue), 561 nm (Yellow-Green), 638 nm (Red), and 808 nm (Infrared). In certain embodiments, the fluorospheres may be excited by at least 2 lasers (one IR and one non-IR). In embodiments, the fluorospheres are excited by at least 3 lasers, at least 4 lasers, at least 5 lasers, at least 6 lasers, at least 7 lasers, or at least 8 lasers. In embodiments, the fluorospheres are excited by between 2 and 12 lasers, between 2 and 10 lasers, between 2 and 8 lasers, between 2 and 6 lasers, or between 2 and 4 lasers.

The fluorospheres of the present invention may be polystyrene beads. The present invention is not limited to polystyrene beads and contemplates the use of fluorospheres made of any material that is suitable for application of more than one dye and use with a flow cytometer. In an embodiment, the fluorospheres have a diameter of between 2.5 μm and 6.5 μm, between 2.8 μm and 3.4 μm, or are about 3.0 μm. In embodiments, the fluorospheres have a diameter of less than 10 μm, less than 8.0 μm, less than 6.5 μm, less than 5.0 μm, less than 4.0 μm, less than 3.5 μm, or less than 3.0 μm. In embodiments, the fluorospheres have a diameter of greater than 1.0 μm, greater than 2.0 μm, greater than 2.5 μm, greater than 2.8 μm, greater than 3.0 μm, greater than 4.0 μm, or greater than 4.0 μm. In embodiments, the fluorospheres within a suspension have different diameters and are not all the same diameters. In embodiments, the fluorophores within a suspension are substantially the same diameter.

In certain embodiments, the fluorospheres in the suspension have a concentration between 0.4×10⁶ fluorospheres/mL and 1.5×10⁶ fluorospheres/mL, a concentration between 0.9×10⁶ fluorospheres/mL and 1.1×10⁶ fluorospheres/mL, or concentration of about 1.0×10⁶ fluorospheres/mL. In embodiments, the fluorospheres in a suspension have a concentration of less than 2.0×10⁶ fluorospheres/mL, less than 1.5×10⁶ fluorospheres/mL, or less than 1.0×10⁶ fluorospheres/mL. In embodiments, the fluorospheres in a suspension have a concentration of greater than 0.3×10⁶ fluorospheres/mL, greater than 0.8×10⁶ fluorospheres/mL, greater than 1.0×10⁶ fluorospheres/mL, greater than 1.1×10⁶ fluorospheres/mL, or greater than 1.5×10⁶ fluorospheres/mL. The above concentrations of fluorospheres refers to the concentration of fluorospheres when the fluorospheres are used for quality control of a flow cytometer. Higher or lower concentrations are contemplated for storage and shipping of the fluorospheres.

In an embodiment of the present invention, the at least one surfactant is selected from the group consisting of: an ionic surfactant, a non-ionic surfactant, Sodium Dodecyl Sulfate (SDS), NP-40s, Ecosurf EH-9, Ecosurf SA-9, Ecosurf Tween 20, Triton X-11, or any combination thereof. The present invention contemplates the use of any commercially available surfactant. In certain embodiments, the at least one surfactant is at a concentration between 0.01% and 1% based on the total volume of the suspension, at a concentration of between 0.05% and 0.9% based on the total volume of the suspension, between 0.1% and 0.8% based on the total volume of the suspension, or between 0.3% and 0.6% based on the total volume of the suspension. In embodiments, the at least one surfactant is at a concentration of less than 1.0% based on the total volume of the suspension, less than 0.8% based on the total volume of the suspension, or less than 0.6% based on the total volume of the suspension. In certain embodiments, the at least one surfactant is at a concentration of greater than 0.01% based on the total volume of the suspension, greater than 0.1% based on the total volume of the suspension, greater than 0.3% based on the total volume of the suspension, or greater than 0.5% based on the total volume of the suspension. In certain embodiments, the at least one surfactant is EcoSurf EH-9 at a concentration is 0.05% based on the total volume of the suspension. The above concentration of surfactant refers to the concentration of surfactant when the fluorosphere suspension is used for quality control of a flow cytometer. Higher or lower concentrations are contemplated for storage and shipping.

In embodiments, there is at least 2 surfactants, at least 3 surfactants, at least 4 surfactants, or at least 5 surfactants in a suspension. In embodiments, there are less than 5 surfactants, less than 4 surfactants, less than 3 surfactants, or less than 2 surfactants in a suspension.

In an embodiment of the present invention, the at least one stabilizer is selected from the group consisting of: a stabilized reducing agent, a stabilized thiol containing compound, (S)-2-Aminobutane-1,4-dithiol hydrochloride, dithiothreitol (DTT), Tris(2-carboxyethyl)phosphine (TCEP) or any combination thereof. The present invention contemplates the use of any commercially available stabilizer.

In embodiments, there is at least 2 stabilizers, at least 3 stabilizers, at least 4 stabilizers, or at least 5 stabilizers in a suspension. In embodiments, there are less than 5 stabilizers, less than 4 stabilizers, less than 3 stabilizers, or less than 2 stabilizers in a suspension.

In an embodiment of the present invention, the at least one preservative is selected from the group consisting of: sodium azide, thimerosal, or any combination thereof. The present invention contemplates the use of any commercially available preservative.

In embodiments, there is at least 2 preservatives, at least 3 preservatives, at least 4 preservatives, or at least 5 preservatives in a suspension. In embodiments, there are less than 5 preservatives, less than 4 preservatives, less than 3 preservatives, or less than 2 preservatives in a suspension.

An embodiment of the present invention includes a method for quality controlling a flow cytometer using a single peak comprising: (a) loading a quality control suspension of the present invention, (b) evaluating at least one of the following: (i) evaluating power of at least one laser in the flow cytometer based on a single peak analysis, (ii) evaluating EPS of at least one laser in the flow cytometer based on a single peak analysis, (iii) evaluating laser delay of at least one laser in the flow cytometer based on a single peak analysis, (iv) evaluating gain of at least one laser in the flow cytometer based on a single peak analysis, (v) evaluating rCV of at least one laser in the flow cytometer based on a single peak analysis, and (c) determining whether the flow cytometer passes or fails quality control based on the at least one evaluation in step (b). In an embodiment, the evaluating in step (b) includes evaluating each of steps (b)(i) through (b)(v) or any combination thereof.

In an embodiment, the evaluation in step (b) is performed on an infrared laser and at least one laser with a wavelength of less than 800 nm. In embodiments, the evaluation in step (b) is performed on less than all the lasers in the flow cytometer, and can include evaluation of any combination of lasers in the flow cytometer. In certain embodiments, the evaluation in step (b) is performed on seven lasers having the following wavelengths: 355 nm (UV), 375 nm (UV), 405 nm (Violet), 488 nm (Blue), 561 nm (Yellow-Green), 638 nm (Red), and 808 nm (Infrared). In certain embodiments, the 355 nm (UV) laser, 405 nm (Violet) laser, 488 nm (Blue) laser, 561 nm (Yellow-Green) laser, and 638 nm (Red) laser are evaluated on detector channel 3 or detector channel 4 of the flow cytometer, and the 808 nm (Infrared) laser is evaluated on detector channel 1 or detector channel 2 of the flow cytometer. In other embodiments, the lasers evaluated in step (b) are evaluated on additional detector channels.

In certain embodiments, the method includes generating a quality control report following step (c). The quality control report may include a pass or fail analysis of each evaluated laser in the flow cytometer. It may also include specific measurements for each evaluated laser in the flow cytometer. In additional embodiments, the method for quality controlling a flow cytometer is performed at least once per day. In certain embodiments, the method for quality controlling a flow cytometer is performed before using the flow cytometer.

An alternative embodiment of the present invention includes a method for quality controlling a flow cytometer using multiple peaks, rather than a single peak, comprising: (a) loading a quality control suspension of the present invention into the flow cytometer to perform a quality control analysis based on more than one peak, (b) adjusting the brightest peak to a target median fluorescence intensity, (c) reading the median fluorescence intensity and rCV for each of the peaks, (d) unloading the quality control suspension from the flow cytometer following step (c), (e) loading polystyrene beads without fluorescence (e.g., no dye) into the flow cytometer (or loading a mixture of polystyrene beads with and without fluorescence), (f) reading the median fluorescence intensity for the polystyrene beads without fluorescence (e.g., no dye) and (g) calculating a sensitivity and background. In certain embodiments, the multiple peaks include three peaks comprising a bright peak, a mild peak, and a dim peak. In an embodiment, the multiple peaks include more than 1 peak, more than 2 peaks, more than 3 peaks, more than 4 peaks, more than 5 peaks, or more than 6 peaks. In an embodiment, the at multiple peaks includes more than 1 peak but less than 7 peaks, less than 6 peaks, less than 5 peaks, or less than 4 peaks.

In an embodiment, the target median fluorescence intensity for step (f) is between 500,000 and 4×10⁶. In an embodiment, the target median fluorescence intensity is greater than 500,000, greater than 1×10⁶, greater than 2×10⁶, or greater than 4×10⁶. In an embodiment, the target median fluorescence intensity if less than 5×10⁶, less than 4×10⁶, less than 3×10⁶, or less than 2×10⁶. In certain embodiments, the sensitivity and background comprise MESF sensitivity, Quantum efficiency, or Background.

In certain embodiments, step (a) loading a quality control suspension of the present invention into the flow cytometer to perform a quality control analysis based on more than one peak is concurrent with step (e) loading polystyrene beads without fluorescence into the flow cytometer. In certain embodiments, a method further includes generating a quality control report following step (k). In embodiments, the quality control report may include a pass or fail analysis of each evaluated laser in the flow cytometer. It may also include specific measurements for each evaluated laser in the flow cytometer.

An embodiment of the present invention includes a kit for performing a method of the present invention, the kit comprising a suspension of the present invention, at least one vial to hold the suspension, and instructions for using the kit. In certain embodiments, a kit may further comprise a second vial to hold a suspension of the present invention. In certain embodiments, the vials are each 10 mls. In embodiments, a kit may include more than 1 vial, more than 2 vials, more than 3 vials, more than 4 vials, or more than 5 vials. In embodiments, a kit may include less than 5 vials, less than 4 vials, less than 3 vials, or less than 2 vials. The vials may be of appropriate size and the vials within the kit may be of different sizes.

In certain embodiments, a kit will include at least a second vial (but may include additional vials) containing a suspension of fluorospheres with no dye, e.g., polystyrene beads with no dye. In certain embodiments, the diameter of the polystyrene beads with no dye in a second vial is about 1 μm but can also be of different diameter or a mix of diameters. In certain embodiments, the concentration of the polystyrene beads in the second vial is between 0.4×10⁶ fluorospheres/mL and 1.5×10⁶ fluorospheres/mL, a concentration between 0.9×10⁶ fluorospheres/mL and 1.1×10⁶ fluorospheres/mL, or concentration of about 1.0×10⁶ fluorospheres/mL. In embodiments, the polystyrene beads in the second vial have a concentration of less than 2.0×10⁶ fluorospheres/mL, less than 1.5×10⁶ fluorospheres/mL, or less than 1.0×10⁶ fluorospheres/mL. In embodiments, the polystyrene beads in the second vial have a concentration of greater than 0.3×10⁶ fluorospheres/mL, greater than 0.8×10⁶ fluorospheres/mL, greater than 1.0×10⁶ fluorospheres/mL, greater than 1.1×10⁶ fluorospheres/mL, or greater than 1.5×10⁶ fluorospheres/mL. The above concentrations of polystyrene beads with no dye refers to the concentration of polystyrene beads when the polystyrene beads are used for quality control of a flow cytometer. Higher or lower concentrations are contemplated for storage and shipping of the fluorospheres.

Having now described the present disclosure in detail, the same will be more clearly understood by reference to the following examples, which are included herewith for purposes of illustration only and are not intended to be limiting of the disclosure.

### EXAMPLES

The following examples are put forth so as to provide those of ordinary skill in the art with a complete disclosure and description of how to make and use the methods and compositions of the disclosure, and are not intended to limit the scope of what the inventors regard as their invention. Efforts have been made to ensure accuracy with respect to numbers used (e.g., amounts, temperature, etc.) but some experimental errors and deviations should be accounted for. Unless indicated otherwise, molecular weight is average molecular weight, temperature is in degrees Celsius, and pressure is at or near atmospheric.

### Example 1

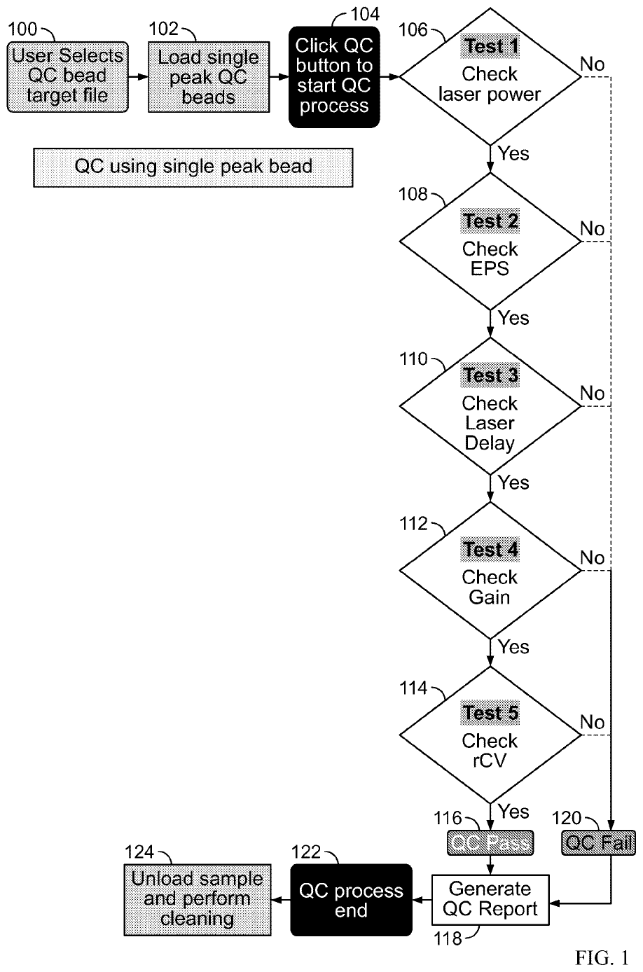

An embodiment of the presently disclosed method for quality controlling a flow cytometer using a single peak is shown in FIG. 1. Referring to FIG. 1, which depicts a flow chart for steps to quality control a flow cytometer, a user of a flow cytometer selects a quality control bead target file on the flow cytometer (100). A user then loads a suspension for quality control of a flow cytometer of the present invention designed for single peak analysis into the flow cytometer (102). The user then starts the quality control process (104) and brings bead fluorescence to target value. The quality control process does one or more of the following: evaluates the laser power for one or more lasers in the flow cytometer (106), evaluates the EPS for one or more lasers in the flow cytometer (108), evaluates laser delay for one or more lasers in the flow cytometer (110), evaluates the gain for one or more lasers in the flow cytometer (112), and/or evaluates rCV for one or more lasers in the flow cytometer (114). If any evaluation step fails for any laser, then the quality control fails (120) and the user is notified by a quality control report (118). If each evaluation step passes, then the quality control passes (116) and a user is notified by a quality control report (118). Following the generation of the quality control report (pass or fail) (118), the quality control process ends (122) and a user unloads the quality control suspension and cleans the flow cytometer (124).

### Example 2

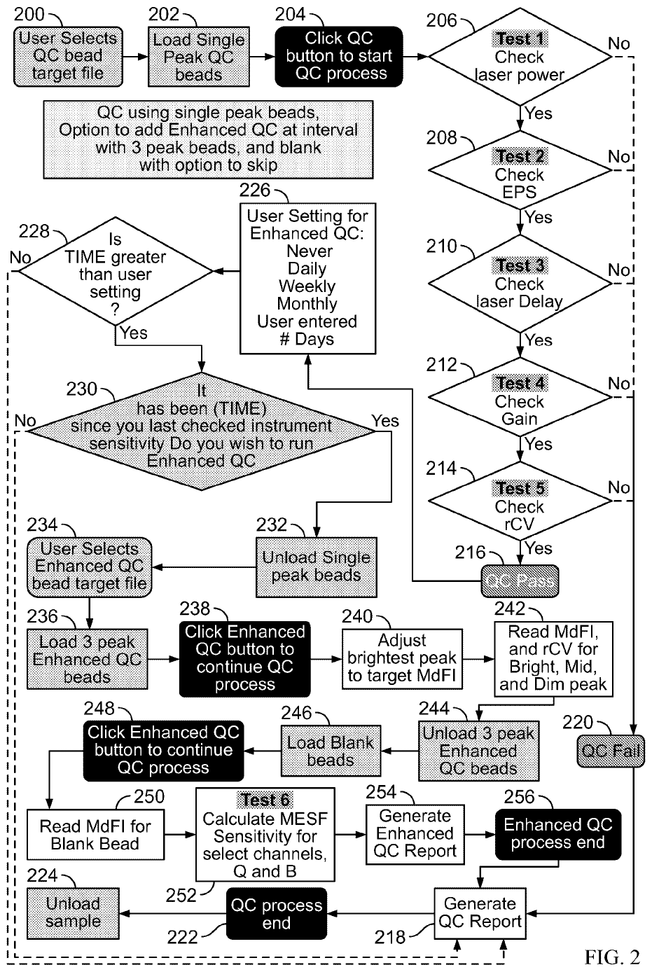

An embodiment of the presently disclosed method for quality controlling a flow cytometer using a single peak followed by using multiple peaks is shown in FIG. 2. Referring to FIG. 2, steps 200 through 224 are the same as shown in FIG. 1 and represent the steps for quality controlling a flow cytometer using a single peak. Following step 216, a user has the ability to perform an additional quality control analysis using multiple peaks, which begins by the user selecting an enhanced quality control analysis (226). An enhanced quality control analysis can be performed daily, weekly, monthly, a specific number of days, or never (226). If the timing for performing an enhanced quality control analysis has not occurred yet, e.g., it has only been 1 day since the last enhance quality control analysis and the timing is set for every 3 days (228), then the flow cytometer does not perform the enhanced quality control analysis and generates a quality control report (218). If it is time to perform an enhance quality control analysis (228) then the user can decide whether to perform an enhanced quality control analysis (230). If the user elects to move forward with an enhanced quality control analysis then the user unloads the single peak suspension (232), selects an enhanced quality control target file (234), and loads an enhanced multiple peak suspension of the present invention into the flow cytometer (236). The user then selects an enhanced quality control analysis (238), adjusts the brightest peak to target MdFl (240), and the flow cytometer reads the MdFl and rCV for the Bright, Middle, and Dim peaks in an embodiment using a 3-peak analysis (242). The user then unloads the enhanced multiple peak suspension of the present invention (244) and loads blank fluorospheres (beads with no dye) (246) before selecting continuation of the enhanced quality control analysis (248). The MdFl is read for the blank fluorospheres (250), followed by calculation of MESF sensitivity for specific channels 252, and generation of an enhanced quality control report (254), and the termination of the enhanced quality control analysis (256).

### Example 3

To better understand the dye leak from fluorospheres, thereby providing a better understanding of how best to combine and use non-IR and IR dyes in a single fluorosphere, single dye fluorospheres were evaluated for dye leak, rCV, and singlets percentage over time. Fluorospheres with the following single dyes were evaluated: UV, Light Yellow, Yellow, Nile Red, Purple, Blue, Sky Blue, Aqua Green, and Cy Green. All fluorospheres were prepared by and ordered from Spherotech, Inc. (https://www.spherotech.com/), 27845 Irma Lee Circle, Unit 101, Lake Forest, IL 60045.

Each single dye fluorosphere suspension was diluted to 1×10⁶ fluorospheres/mL in 0.05% Ecosurf EH-9, available from Sigma Aldrich (CAS: 64366-70-7). Once diluted, samples were stored in FACS tubes, covered with foil to protect them from the light, and stored at 4° C. The dilution day is Day 0. Prior to measurement, samples were vortexed for 5 seconds and acquired for 60 seconds with a threshold of FSC Height at 600,000. Each single dye suspension was acquired and assessed for rCV, singlet percentage, and MdFl difference in comparison to Day 0. An rCV of less than 5% was considered passing. Singlet events divided by total fluorosphere events (% singlets) of greater than 85% was considered passing. MdFl minus MdFl at Day 0 divided by MdFl at Day 0 equals the % MdFl difference.

Table 1 represents the preparation of each single dye fluorosphere suspension evaluated.

TABLE 1
Preparation of Single Bead Peaks.

| | Weight % | Number | Mean | Amount from |
|---|---|---|---|---|
| | Solids | of Micro- | diameter | stock sln for |
| | (w/v) | spheres/mL | (um) | 1*10\hat{ }6/mL (uL) |
| UV | 1 | 2.08E+09 | 2.06 | 0.48 |
| Light Yellow | 1 | 1.81E+09 | 2.16 | 0.55 |
| Yellow | 1 | 2.27E+09 | 2.00 | 0.44 |
| Nile Red | 1 | 2.49E+09 | 1.94 | 0.40 |
| Purple | 1 | 2.38E+09 | 1.97 | 0.42 |
| Blue | 1 | 5.06E+08 | 3.30 | 1.97 |
| Sky Blue | 0.2 | 5.10E+08 | 1.93 | 1.96 |
| Aqua Green | 0.014 | 1.00E+07 | 3.00 | 100.00 |
| Cy Green | 0.014 | 1.00E+07 | 3.00 | 100.00 |

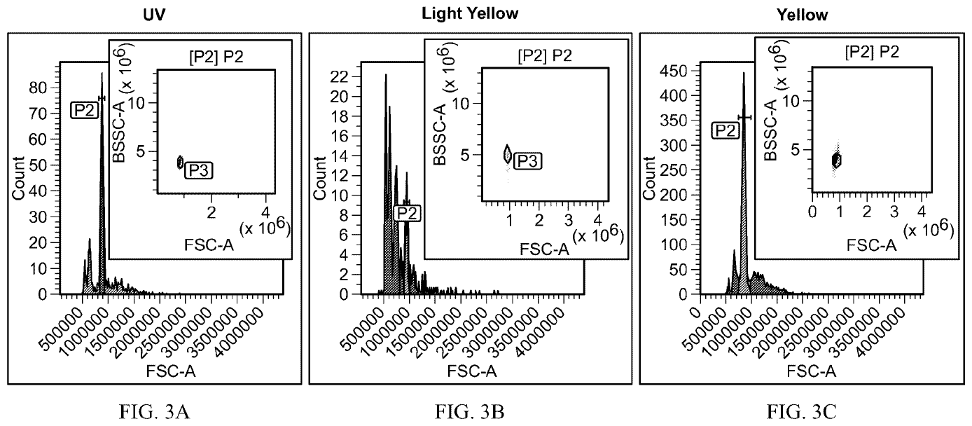

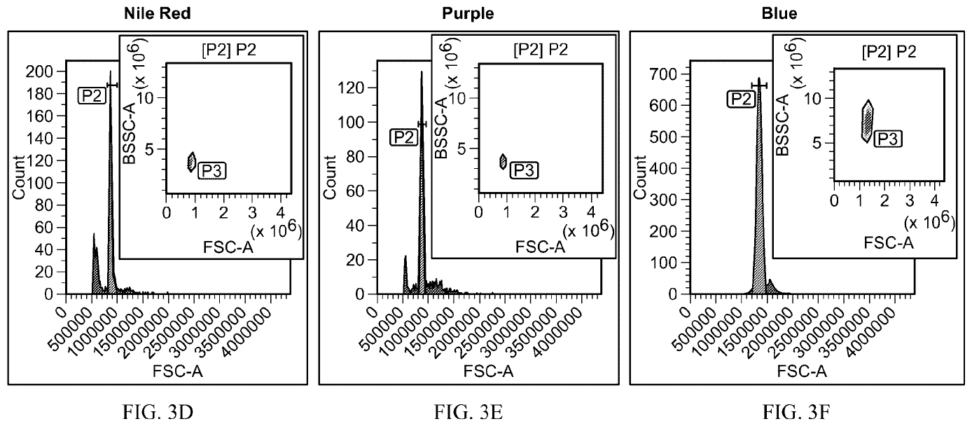

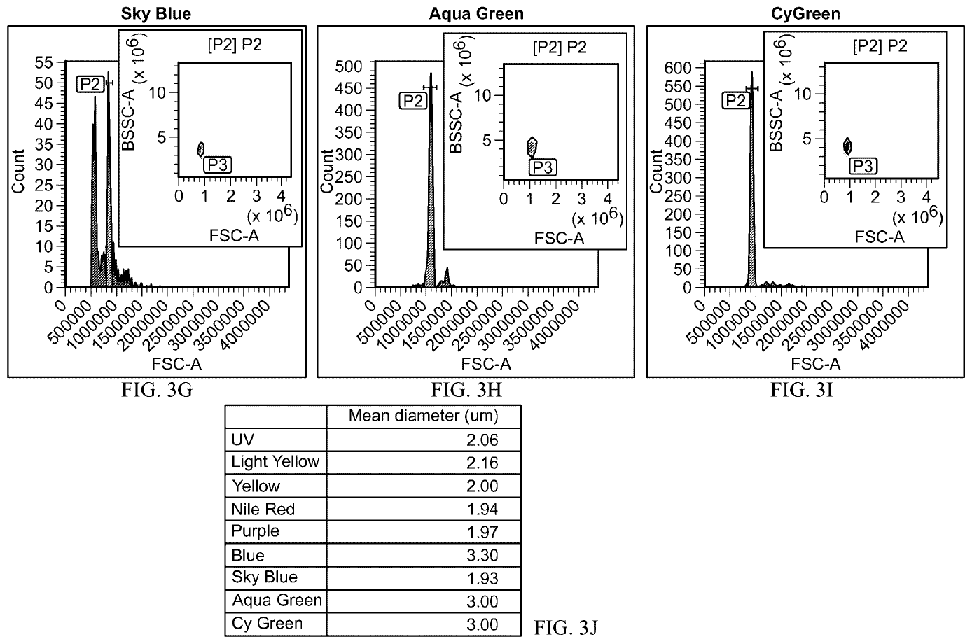

The gating strategy is disclosed in FIG. 3 for each of the single dye fluorosphere suspensions. The percentage of singlets at Day 0 and Day 3 is disclosed in Table 2 and Table 3, respectively. The Day 3 control, which represents samples freshly diluted on Day 3, is disclosed in Table 4,

TABLE 2
Percentage of Singlets for Single Dye Fluorospheres at Day 0.

| | | Beads | |
|---|---|---|---|
| Day 0 | Singlets | population | Singlets % |
| UV | 927 | 1956 | 47% |
| Light Yellow | 120 | 1000 | 12% |
| Yellow | 5940 | 12440 | 48% |
| Nile Red | 2513 | 4162 | 60% |
| Purple | 1465 | 2534 | 58% |
| Blue | 20482 | 22521 | 91% |
| Sky Blue | 637 | 2000 | 32% |
| Aqua Green | 8602 | 10253 | 84% |
| Cy Green | 9613 | 10960 | 88% |

TABLE 3
Percentage of Singlets for Single Dye Fluorospheres at Day 3.

| | | Beads | |
|---|---|---|---|
| Day 3 | Singlets | population | Singlets % |
| UV | 193 | 684 | 47% |
| Light Yellow | 136 | 474 | 29% |
| Yellow | 5159 | 10350 | 50% |
| Nile Red | 2824 | 5615 | 50% |
| Purple | 447 | 1346 | 33% |
| Blue | 4228 | 5715 | 74% |
| Sky Blue | 146 | 553 | 26% |
| Jade Green | 8978 | 10206 | 88% |
| Aqua Green | 3619 | 5722 | 63% |
| CyGreen | 8708 | 10184 | 86% |

TABLE 4
Percentage of Singlets for Single Dye Fluorospheres
that were Freshly Diluted on Day 3.

| | | Beads | |
|---|---|---|---|
| Day 3 Ctr | Singlets | population | Singlets % |
| UV | 1042 | 2212 | 47% |
| Light Yellow | 140 | 772 | 18% |
| Yellow | 3338 | 7233 | 46% |
| Nile Red | 2638 | 3928 | 67% |
| Purple | 1025 | 1578 | 65% |
| Blue | 24246 | 26581 | 91% |
| Sky Blue | 1356 | 4483 | 30% |
| Aqua Green | 9051 | 11016 | 82% |
| CyGreen | 9809 | 11009 | 89% |

An rCV analysis of each single dye fluorosphere suspension was conducted at Day 0 (Table 5), Day 3 (Table 6), Day 16 (Table 7), Day 22 (Table 8), and Day 24 (Table 9) at the following channels: U3-A, U4-A, V3-A, V4-A, B3-A, B4-A, Y3-A, Y4-A, R3-A, R4-A, IR1-A, IR2-A, and IR3-A. A CytoFlex LX flow cytometer form Beckman Coulter was used for all readings.

TABLE 5
rCV Analysis of Single Dye Fluorospheres at Day 0.

| Day 0 | U3-A | U4-A | V3-A | V4-A | B3-A | B4-A | Y3-A | Y4-A | R3-A | R4-A | IR1-A | IR2-A | IR3-A |
|---|---|---|---|---|---|---|---|---|---|---|---|---|---|
| UV | 4.7 | 4.55 | 3.41 | 3.38 | 27.77 | 32.2 | 279.18 | 227.41 | 294.19 | 538.03 | 18.78 | 65.52 | −222.45 |
| Light | 4.89 | 5.38 | 1.99 | 2.09 | 8.05 | 8.49 | 157.27 | 102.13 | 181.02 | 563.72 | 18.54 | 61.48 | −153.77 |
| Yellow | | | | | | | | | | | | | |
| Yellow | 95.89 | 28.67 | 2.4 | 2.34 | 2.4 | 2.37 | 68.76 | 84.92 | 575.58 | 12733.89 | 24.43 | 80.28 | −262.99 |
| Nile | 31.74 | 27.57 | 14.89 | 10.13 | 2.86 | 2.92 | 3.06 | 4.35 | 9.84 | 12.29 | 20.13 | 67.46 | −238.57 |
| Red | | | | | | | | | | | | | |
| Purple | 192.11 | 129.14 | 60.27 | 63.65 | 18.04 | 2.51 | 3.68 | 3.94 | 4.45 | 4.51 | 21.08 | 73.96 | −242.17 |
| Blue | 32.87 | 22.19 | 11.79 | 12.27 | 8.02 | 7.55 | 11.93 | 6.09 | 5.98 | 5.85 | 21.04 | 46.72 | −263.82 |
| Sky | 62.27 | 46.66 | 26.99 | 30.82 | 13.75 | 21.3 | 19.08 | 4.42 | 3.5 | 2.72 | 14.57 | 16.06 | 48.19 |
| Blue | | | | | | | | | | | | | |
| Aqua | 17.33 | 12.57 | 4.95 | 4.61 | 3.97 | 3.97 | 6.78 | 5.97 | 5.49 | 6.55 | 9.87 | 9.64 | 9.81 |
| Green | | | | | | | | | | | | | |
| Cy | 49.88 | 34.42 | 13.54 | 13.66 | 7.36 | 6.28 | 9.42 | 5.16 | 2.84 | 2.42 | 2.9 | 2.84 | 3.73 |
| Green | | | | | | | | | | | | | |

TABLE 6
rCV Analysis of Single Dye Fluorospheres at Day 3.

| Day 3 | U3-A | U4-A | V3-A | V4-A | B3-A | B4-A | Y3-A | Y4-A | R3-A | R4-A | IR1-A | IR2-A | IR3-A |
|---|---|---|---|---|---|---|---|---|---|---|---|---|---|
| UV | 4.89 | 4.74 | 3.96 | 4.77 | 27.07 | 35 | 422.25 | 192.36 | 695.08 | 559.5 | 19.98 | 71.33 | −248.26 |
| Light | 3.45 | 3.56 | 1.71 | 1.64 | 7.34 | 8.63 | 129.93 | 120.02 | 321.47 | 658.64 | 15.57 | 45.1 | −196.06 |
| Yellow | | | | | | | | | | | | | |
| Yellow | 94.05 | 28.59 | 2.38 | 2.25 | 2.44 | 2.42 | 69.98 | 81.43 | 803.24 | 33457.34 | 17.98 | 57.52 | −245.7 |
| Nile Red | 27.51 | 22.64 | 11.37 | 7.58 | 2.11 | 2.15 | 2.78 | 3.21 | 7.25 | 9.9 | 18.64 | 62.11 | −291.7 |
| Purple | 116.57 | 92.67 | 53.53 | 69.18 | 18.58 | 2.36 | 3.55 | 3.8 | 4.6 | 4.69 | 16.35 | 53.04 | −247.65 |
| Blue | 30.95 | 21.43 | 11.64 | 11.87 | 7.79 | 7.57 | 11.26 | 6.02 | 6.22 | 6.06 | 19.92 | 44.41 | −271.55 |
| Sky Blue | 62.06 | 50.67 | 26.79 | 26.67 | 14.22 | 22 | 21.45 | 4.97 | 5.46 | 4.44 | 13.5 | 13.75 | 58.56 |
| *Jade | 33.21 | 19.31 | 10.58 | 10.23 | 6.73 | 5.42 | 5.85 | 7.33 | 9.79 | 8.07 | 2.76 | 2.79 | 3.03 |
| Green | | | | | | | | | | | | | |
| Aqua | 17.26 | 12.75 | 4.96 | 4.76 | 4.01 | 4.02 | 6.85 | 5.8 | 5.52 | 6.52 | 9.64 | 9.42 | 9.62 |
| Green | | | | | | | | | | | | | |
| CyGreen | 51.36 | 33.62 | 13.44 | 14.24 | 7.09 | 6.24 | 9.36 | 5.01 | 3.02 | 2.5 | 2.52 | 2.57 | 3.25 |

TABLE 7
rCV Analysis of Single Dye Fluorospheres at Day 16.

| Day 16 | U3-A | U4-A | V3-A | V4-A | B3-A | B4-A | Y3-A | Y4-A | R3-A | R4-A | IR1-A | IR2-A | IR3-A |
|---|---|---|---|---|---|---|---|---|---|---|---|---|---|
| UV | 5.03 | 5.13 | 4.09 | 4.87 | 29.87 | 37.45 | 426.37 | 170.69 | 788.87 | 512.91 | 18.76 | 51.88 | −273.13 |
| Light | 4.08 | 4 | 1.67 | 1.77 | 7.04 | 8.45 | 127.58 | 115.78 | 361.59 | −2937.46 | 15.96 | 50.53 | −488.13 |
| Yellow | | | | | | | | | | | | | |
| Yellow | 86.75 | 27.24 | 2.15 | 2.05 | 2.7 | 2.6 | 68.35 | 81.03 | 636.36 | −4155.91 | 15.61 | 47.55 | −505.59 |
| Nile Red | 25 | 20.61 | 11.11 | 7.63 | 2.94 | 2.88 | 2.31 | 2.59 | 6.58 | 8.59 | 18.07 | 52.43 | −403.93 |
| Purple | 102.14 | 79.57 | 58.73 | 57.12 | 19.42 | 3.43 | 3.34 | 3.36 | 5.65 | 5.61 | 17.03 | 53.68 | −514.54 |
| Blue | 29.04 | 23 | 12.28 | 12.27 | 18.51 | 7.73 | 11.19 | 6.14 | 6.28 | 6.16 | 19.37 | 37.92 | −307.15 |
| Sky Blue | 40.31 | 50.06 | 27.41 | 31.12 | 19.14 | 17.87 | 24.07 | 4.73 | 5.2 | 2.58 | 14.83 | 17.1 | 58.17 |
| *Jade | 29.79 | 18.23 | 10.63 | 10.31 | 6.72 | 6 | 6.1 | 7.42 | 10.08 | 8.37 | 2.65 | 2.67 | 3 |
| Green | | | | | | | | | | | | | |
| Aqua | 16.32 | 12.28 | 4.94 | 4.96 | 4.18 | 4.19 | 5.85 | 5.5 | 5.57 | 6.59 | 9.16 | 8.97 | 9.05 |
| Green | | | | | | | | | | | | | |
| CyGreen | 47.73 | 32.79 | 13.57 | 13.59 | 7.12 | 6.16 | 9.07 | 4.66 | 2.94 | 2.44 | 1.84 | 1.85 | 2.73 |

TABLE 8
rCV Analysis of Single Dye Fluorospheres at Day 22.

| Day 22 | U3-A | U4-A | V3-A | V4-A | B3-A | B4-A | Y3-A | Y4-A | R3-A | R4-A | IR1-A | IR2-A | IR3-A |
|---|---|---|---|---|---|---|---|---|---|---|---|---|---|
| UV | 2.52 | 2.79 | 3.78 | 3.82 | 38.91 | 61.48 | −1222.19 | 199.59 | 374.25 | −458.28 | 27.1 | 103.27 | −1245.38 |
| Light | 2.56 | 3.31 | 3.18 | 2.61 | 33.35 | 62.22 | 479.33 | −2032.42 | 451.64 | 462.89 | 21.14 | 73.97 | −262.08 |
| Yellow | | | | | | | | | | | | | |
| Yellow | 142.86 | 52.19 | 2.48 | 2.28 | 2.55 | 2.38 | 122.36 | 154.59 | 1439.31 | 2724.81 | 22.14 | 97.78 | −447.71 |
| Nile Red | 26.42 | 23.66 | 22.65 | 7.85 | 1.67 | 1.58 | 2.36 | 1.95 | 8.11 | 8.72 | 26.71 | 119.23 | 856.36 |
| Purple | 202.26 | 147.84 | 69 | 108.89 | 35.75 | 9.75 | 20.8 | 18.74 | 18.08 | 20.64 | 37.56 | 57.2 | −134.27 |
| Blue | 35.35 | 21.71 | 12.3 | 12.78 | 7.79 | 7.22 | 11.12 | 5.44 | 5.51 | 5.39 | 21.39 | 43.21 | −452.23 |
| Sky Blue | 239.32 | 179.59 | 66.52 | 75.06 | 48.15 | 4.42 | 5.62 | 6.42 | 5.7 | 6.65 | 33.21 | 135.41 | −1934348 |
| *Jade | 31.38 | 18.8 | 10.21 | 9.95 | 6.76 | 5.94 | 6.65 | 7.73 | 9.51 | 7.94 | 3.91 | 3.99 | 4.08 |
| Green | | | | | | | | | | | | | |
| Aqua | 17.92 | 12.9 | 5.27 | 4.5 | 3.61 | 3.54 | 5.67 | 5.26 | 5.5 | 6.37 | 10.59 | 10.46 | 10.43 |
| Green | | | | | | | | | | | | | |
| CyGreen | 50.96 | 33.89 | 14.07 | 13.97 | 7.17 | 6.02 | 9.01 | 4.54 | 2.98 | 2.67 | 5.41 | 5.58 | 5.76 |

TABLE 9
rCV Analysis of Single Dye Fluorospheres at Day 24.

| Day 24 | U3-A | U4-A | V3-A | V4-A | B3-A | B4-A | Y3-A | Y4-A | R3-A | R4-A | IR1-A | IR2-A | IR3-A |
|---|---|---|---|---|---|---|---|---|---|---|---|---|---|
| UV | 3.65 | 3.94 | 5.14 | 5.56 | 45.91 | 56.67 | 8187.25 | 213.76 | −353.06 | 687.06 | 25.58 | 115.66 | −172.94 |
| Light | 48.42 | 48.57 | 86.46 | 86.96 | 72.22 | 73.83 | 475.67 | 557.11 | −732.14 | 367240 | 66.18 | 279.48 | −913.27 |
| Yellow | | | | | | | | | | | | | |
| Yellow | 139.6 | 51.42 | 6.07 | 5.87 | 2.65 | 2.54 | 119.15 | 141.39 | 919.44 | 5460.23 | 59.68 | 365.51 | −319.87 |
| Nile Red | 44.25 | 38.9 | 20.28 | 12.81 | 2.61 | 2.5 | 2.3 | 2.51 | 8.83 | 10.77 | 54.14 | 301.35 | −343.75 |
| Purple | 168.26 | 129.94 | 109.68 | 115.65 | 43.48 | 5.15 | 3.27 | 4.83 | 7.7 | 7.87 | 75.76 | 503.55 | −343.12 |
| Blue | 8497.15 | −43855.3 | 3270.85 | 420.3 | 19.81 | 18.32 | 64.03 | 54.83 | 133.17 | 133.31 | −509.98 | −435.49 | −507.85 |
| Sky Blue | 152.24 | 128.59 | 77.48 | 85.09 | 43.8 | 6.26 | 7.43 | 7.58 | 9.65 | 9.99 | 80.29 | 224.65 | 1442.38 |
| *Jade | 32.92 | 19.07 | 11.45 | 11.03 | 6.47 | 5.86 | 6.28 | 7.46 | 9.44 | 7.81 | 31.34 | 30.62 | 31.12 |
| Green | | | | | | | | | | | | | |
| Aqua | 39 | 32.47 | 28.82 | 28.16 | 4.12 | 3.99 | 6.18 | 5.39 | 5.98 | 7.39 | 57.39 | 56.18 | 58.01 |
| Green | | | | | | | | | | | | | |
| CyGreen | 77.9 | 63.67 | 38.99 | 38.87 | 6.82 | 5.87 | 8.82 | 4.41 | 3.56 | 3.26 | 54.01 | 53.38 | 54.43 |

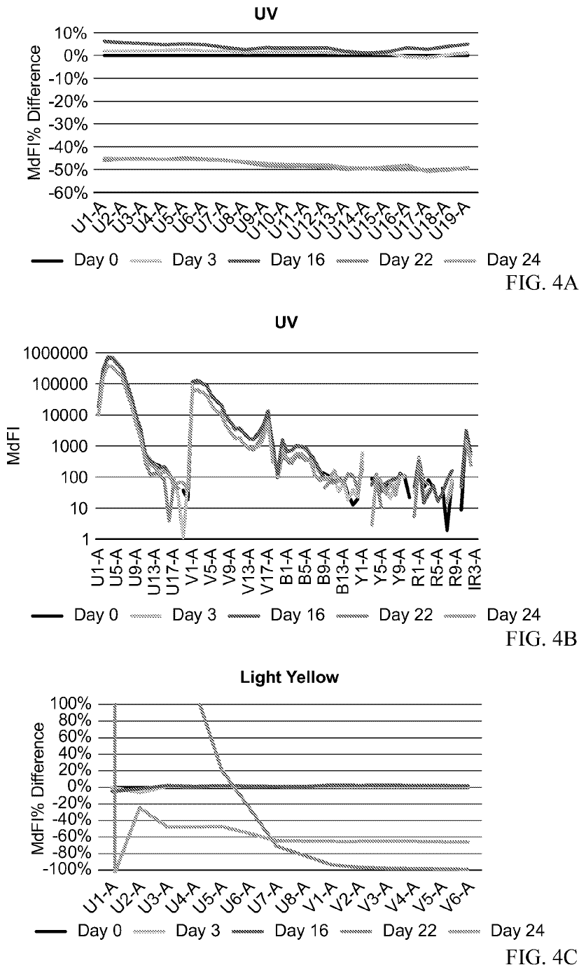

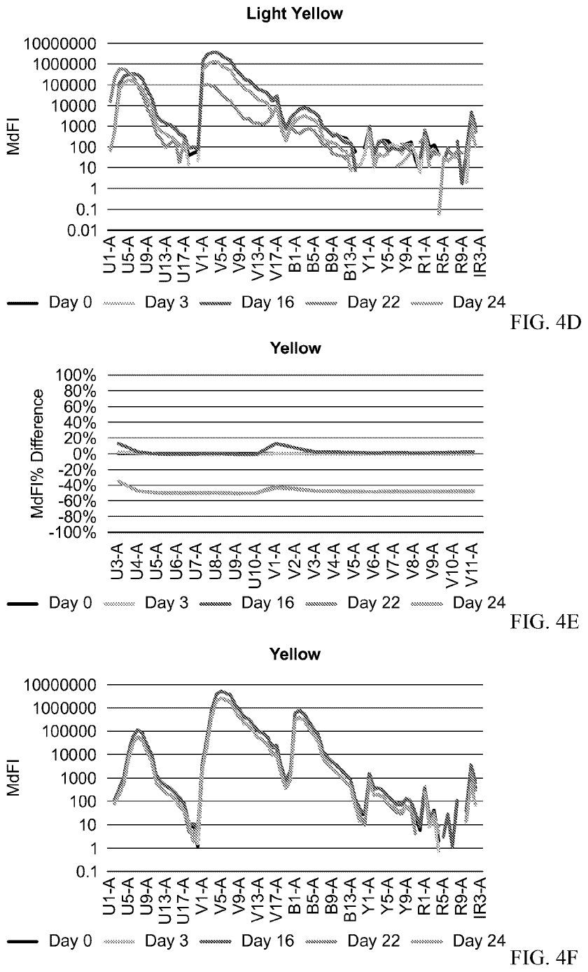

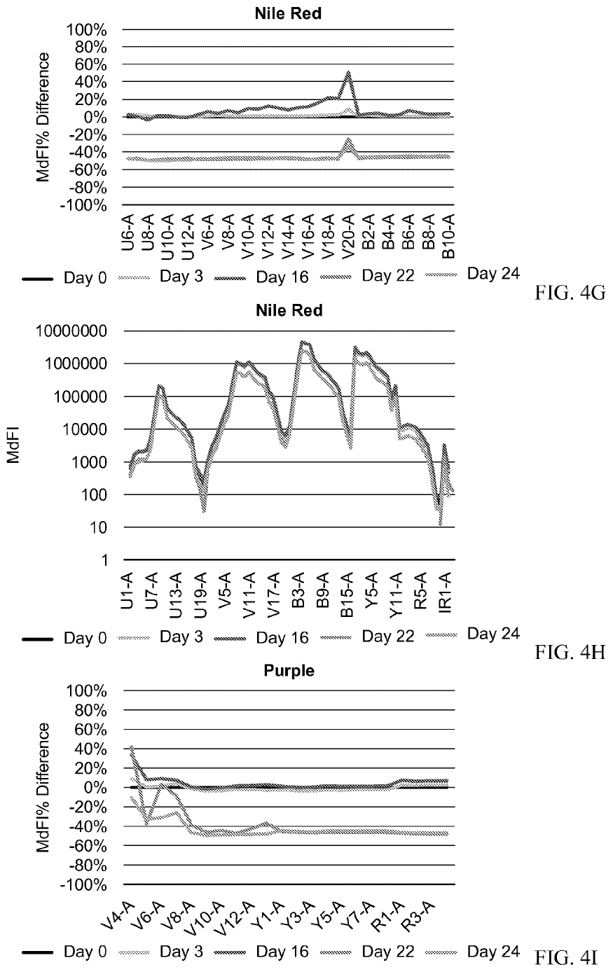

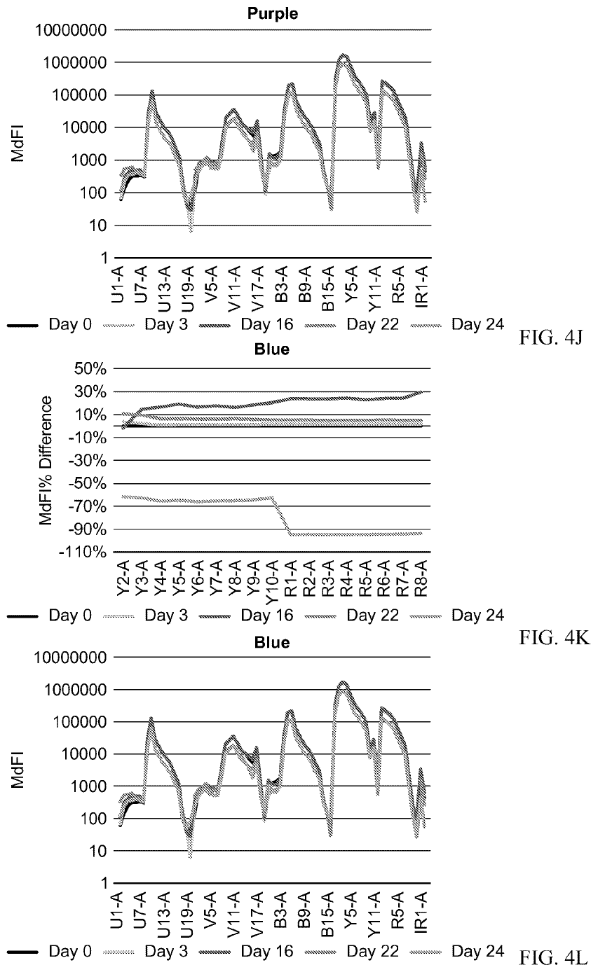

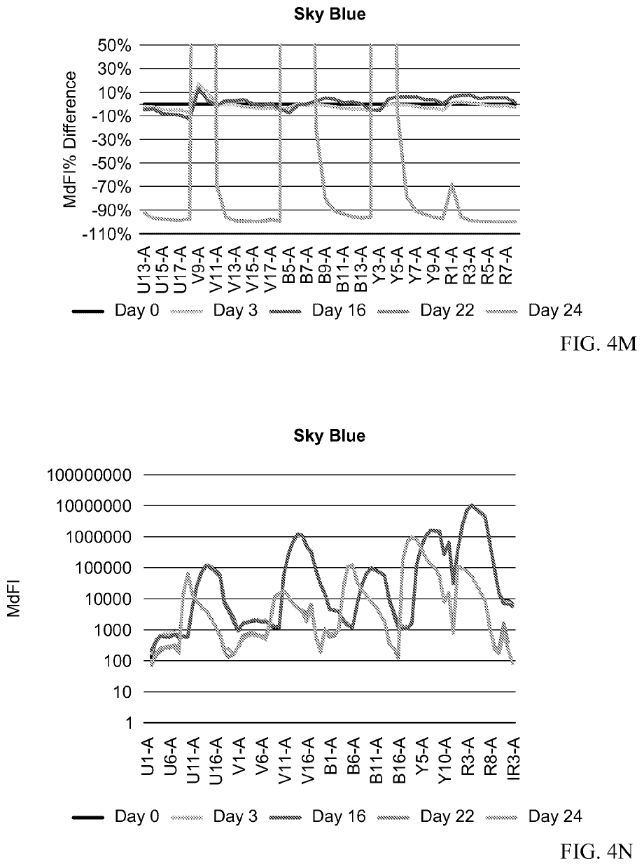

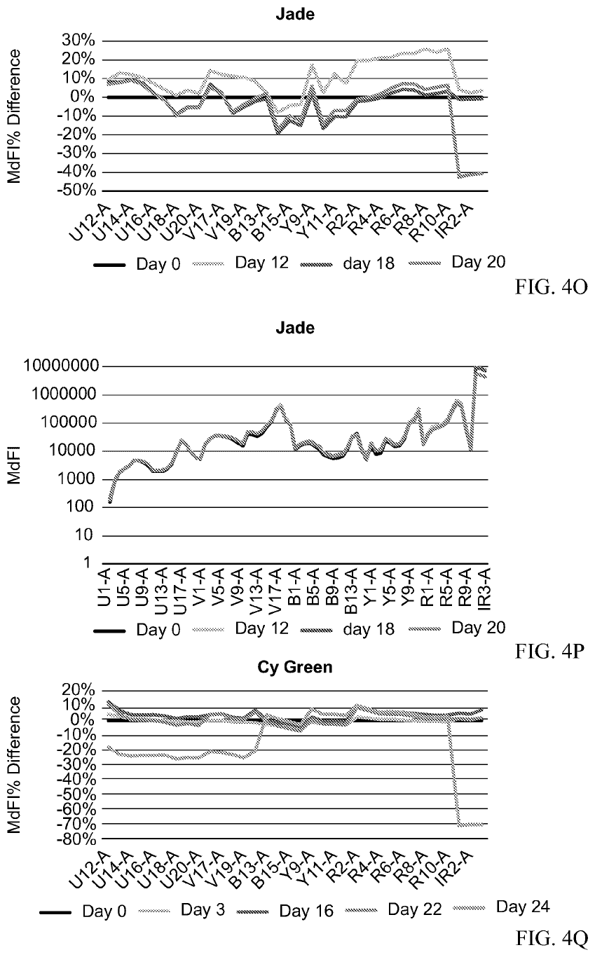

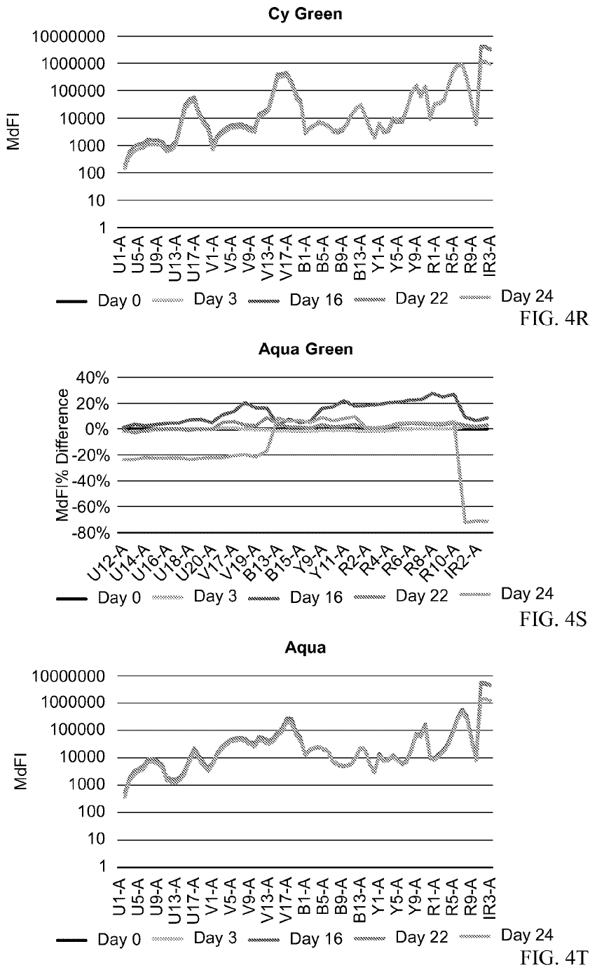

rCVs failed for fluorospheres with Aqua Green at Day 0. rCVs for fluorospheres with Cy Green failed at Day 24. rCVs for fluorospheres with Jade Green failed at Day 20. The MdFl calculation and MdFl % difference was also evaluated and disclosed in FIG. 4. More specifically, FIG. 4A shows the MdFl % difference for fluorospheres with UV on emitted channels and FIG. 4B shows the MdFl for the same fluorospheres across the spectrum at Day 0, Day 3, Day 16, Day 22, and Day 24.

FIG. 4C shows the MdFl % difference for fluorospheres with Light Yellow dye on emitted channels and FIG. 4D shows the MdFl for the same fluorospheres across the spectrum at Day 0, Day 3, Day 16, Day 22, and Day 24.

FIG. 4E shows the MdFl % difference for fluorospheres with Yellow dye on emitted channels and FIG. 4F shows the MdFl for the same fluorospheres across the spectrum at Day 0, Day 3, Day 16, Day 22, and Day 24.

FIG. 4G shows the MdFl % difference for fluorospheres with Nile Red dye on emitted channels and FIG. 4H shows the MdFl for the same fluorospheres across the spectrum at Day 0, Day 3, Day 16, Day 22, and Day 24.

FIG. 4I shows the MdFl % difference for fluorospheres with Purple dye on emitted channels and FIG. 4J shows the MdFl for the same fluorospheres across the spectrum at Day 0, Day 3, Day 16, Day 22, and Day 24.

FIG. 4K shows the MdFl % difference for fluorospheres with Blue dye on emitted channels and FIG. 4L shows the MdFl for the same fluorospheres across the spectrum at Day 0, Day 3, Day 16, Day 22, and Day 24.

FIG. 4M shows the MdFl % difference for fluorospheres with Sky Blue dye on emitted channels and FIG. 4N shows the MdFl for the same fluorospheres across the spectrum at Day 0, Day 3, Day 16, Day 22, and Day 24.

FIG. 4O shows the MdFl % difference for fluorospheres with Jade Green dye (IR excited) on emitted channels and FIG. 4P shows the MdFl for the same fluorospheres across the spectrum at Day 0, Day 3, Day 16, Day 22, and Day 24.

FIG. 4Q shows the MdFl % difference for fluorospheres with CyGreen dye (IR excited) on emitted channels and FIG. 4R shows the MdFl for the same fluorospheres across the spectrum at Day 0, Day 3, Day 16, Day 22, and Day 24.

FIG. 4S shows the MdFl % difference for fluorospheres with Aqua Green dye (IR excited) on emitted channels and FIG. 4T shows the MdFl for the same fluorospheres across the spectrum at Day 0, Day 3, Day 16, Day 22, and Day 24.

The dyes became dimmer after Day 22. Cy Green was dimmer in the IR laser, followed by Cy Green. Jade Greed provided the brightest MdFl. There was dye leak over time for Jade Green fluorospheres.

### Example 4

The stability of fluorospheres of the present invention were evaluated following dilution to different volumes using different buffers. Fluorospheres of the present invention (Set 7.2) having 8 dyes were prepared for evaluation. The fluorospheres included UV dye, Light Yellow dye, Yellow dye, Nile Red dye, Purple dye, Blue dye, Sky Blue dye, and Jade Green. The Jade Green was added to the fluorospheres after the other dyes were added. The fluorospheres were washed with 0.01% NP-40 and suspended in a buffer of 0.01% NP-40.

Fluorospheres were diluted to a concentration of 1×10⁶ fluorospheres/sample to a total volume of either 0.5 ml, 1.0 ml, or 2.5 ml using either Ecosurf EH-9 (CAS: 64366-70-7) and Ecosurf SA-9 (CAS: 68937-66-6). Samples were freshly diluted with 0.05% Ecosurf EH-9 to 1.0 ml for use as a control. Samples were vortexed for 5 seconds and then acquired for 60 seconds. Each fluorosphere suspension was acquired and assessed for rCV, singlet percentage, and MdFl difference in comparison to Day 0. An rCV of less than 5% was considered passing. Singlet events divided by total fluorosphere events (% singlets) of greater than 85% was considered passing. MdFl minus MdFl at Day 0 divided by MdFl at Day 0 equals the % MdFl difference. A CytoFlex LX flow cytometer form Beckman Coulter was used for all readings.

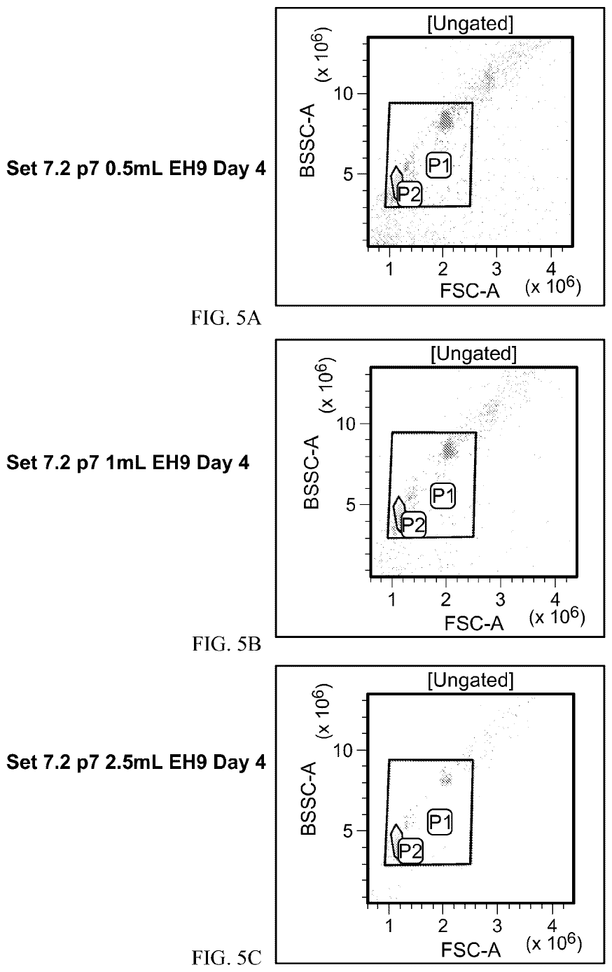

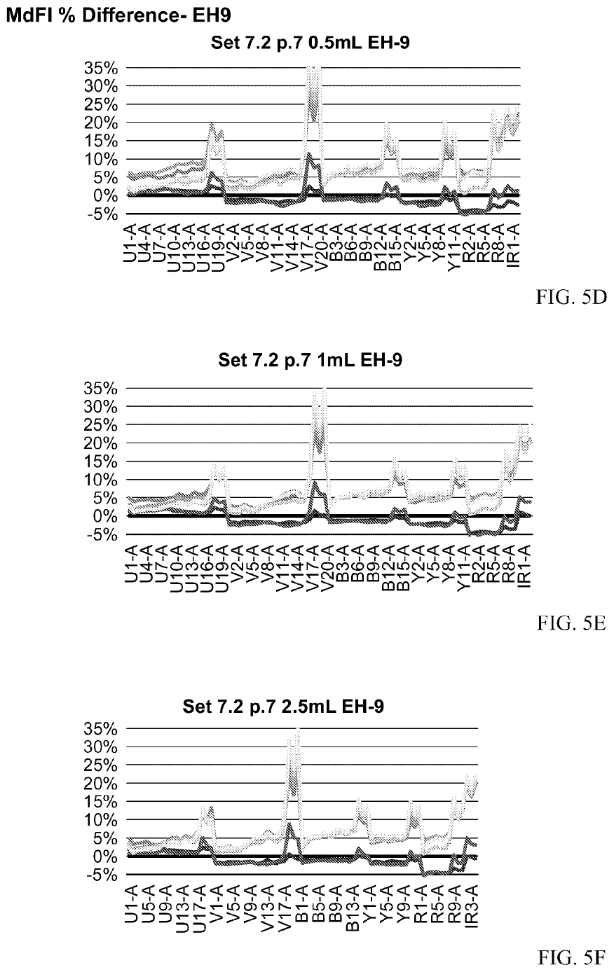

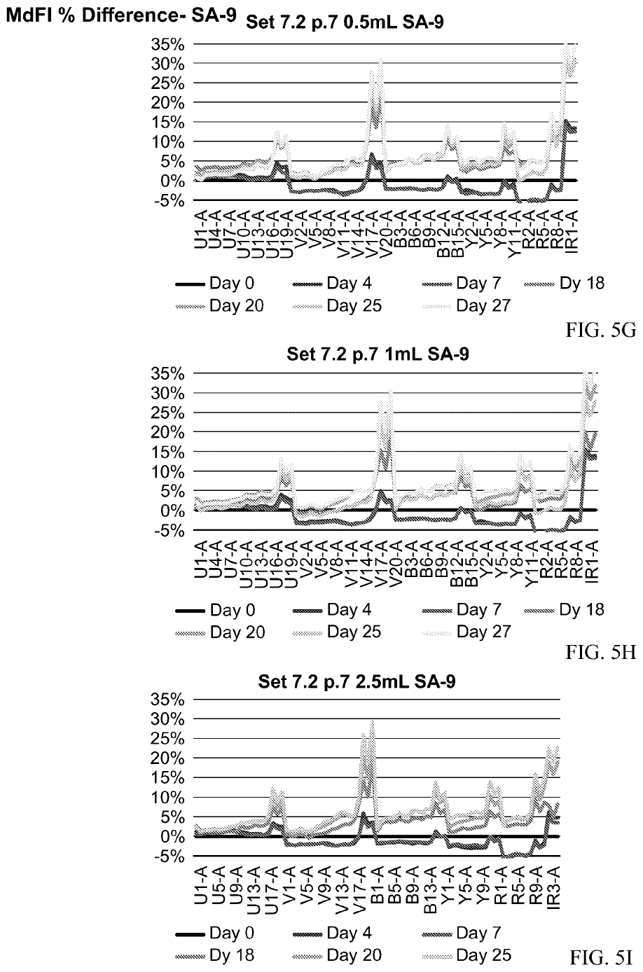

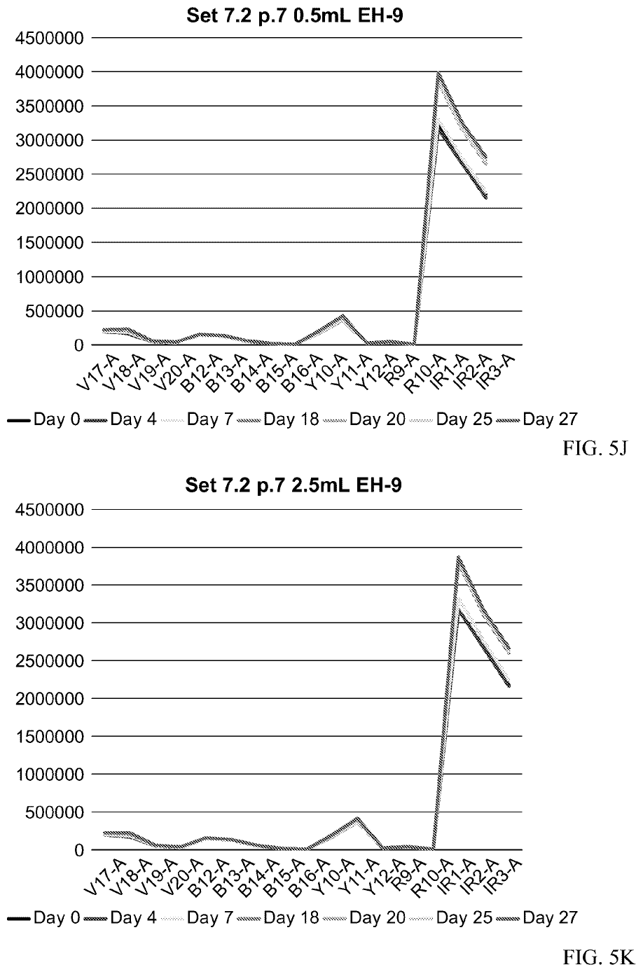

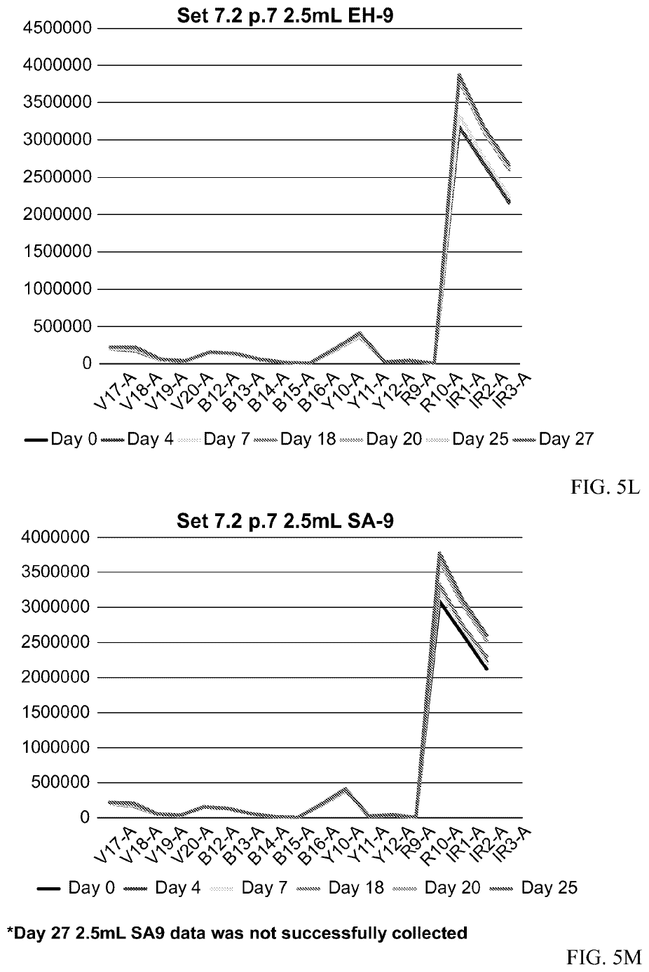

Fluorospheres (Set 7.2) were diluted to 0.5 ml, 1.0 ml, and 2.5 ml final volume with Ecosurf EH-9 at Day 0. Fluorospheres (Set 7.2) were also diluted 0.5 ml, 1.0 ml, and 2.5 ml final volume with Ecosurf SA-9 at Day 0. The analysis of percent singlets was performed at Day 0, Day 4, Day 7, Day 18, Day 20, Day 25, and Day 27 as disclosed in Table 10 and Table 11. Gate analysis of the Day 4 samples diluted with Ecosurf EH-9 is shown in FIG. 5.

TABLE 10
Percent Singlet Analysis for Each of the
Six Samples at Day 0, Day 4, and Day 7.

| | Beads | Singlet | |
|---|---|---|---|
| | Events | Events | Singlets |
| Set 7.2 p. 7 0.5 | 16315 | 14262 | 87% |
| mL EH-9 | | | |
| Set 7.2 p. 7 1 | 8077 | 7293 | 90% |
| mL EH-9 | | | |
| Set 7.2 p. 7 2.5 | 3157 | 2953 | 94% |
| mL EH-9 | | | |
| Set 7.2 p. 7 0.5 | 15088 | 14127 | 94% |
| mL SA-9 | | | |
| Set 7.2 p. 7 1 | 7632 | 7034 | 92% |
| mL SA-9 | | | |
| Set 7.2 p. 7 2.5 | 14898 | 13941 | 94% |
| mL SA-9 | | | |
| Set 7.2 p7 0.5 mL | 15058 | 13669 | 91% |
| SA-9 Day 4 | | | |
| Set 7.2 p7 1 mL | 6809 | 6238 | 92% |
| SA-9 Day 4 | | | |
| Set 7.2 p7 2.5 mL | 2953 | 2762 | 94% |
| SA-9 Day 4 | | | |
| Set 7.2 p7 0.5 mL | 3188 | 2014 | 63% |
| EH9 Day 4 | | | |
| Set 7.2 p7 1 mL | 1670 | 1051 | 63% |
| EH9 Day 4 | | | |
| Set 7.2 p7 2.5 mL | 616 | 456 | 74% |
| EH9 Day 4 | | | |
| Set 7.2 p. 7 0.5 mL | 2180 | 1380 | 63% |
| EH-9 Day 7 | | | |
| Set 7.2 p. 7 1 mL | 1245 | 723 | 58% |
| EH-9 Day 7 | | | |
| Set 7.2 p. 7 2.5 mL | 278 | 194 | 70% |
| EH-9 Day 7 | | | |
| Set 7.2 p. 7 0.5 mL | 14515 | 13294 | 92% |
| SA-9 Day 7 | | | |
| Set 7.2 p. 7 1 mL | 7067 | 6588 | 93% |
| SA-9 Day 7 | | | |
| Set 7.2 p. 7 2.5 mL | 3429 | 3040 | 89% |
| SA-9 Day 7 | | | |

TABLE 11
Percent Singlet Analysis for Each of the Six Samples
at Day 18, Day 20, Day 25, and Day 27.

| | Beads | Singlet | |
|---|---|---|---|
| | Events | Events | Singlets |
| 0.5 mL EH9 Day 18 | 1830 | 1170 | 64% |
| 1 mL EH9 Day 18 | 586 | 358 | 61% |
| 2.5 mL EH9 Day 18 | 232 | 180 | 78% |
| 0.5 mL SA9 Day 18 | 14739 | 13714 | 93% |
| 1 mL SA9 Day 18 | 7188 | 6404 | 89% |
| 2.5 mL SA9 Day 18 | 3277 | 2878 | 88% |
| 0.5 mL EH9 Day 20 | 770 | 481 | 62% |
| 1 mL EH9 Day 20 | 166 | 125 | 75% |
| 2.5 mL EH9 Day 20 | 175 | 122 | 70% |
| 0.5 mL SA9 Day 20 | 9836 | 9136 | 93% |
| 1 mL SA9 Day 20 | 5961 | 5568 | 93% |
| 2.5 mL SA9 Day 20 | 3446 | 3209 | 93% |
| 0.5 mL EH9 Day 25 | 1206 | 773 | 64% |
| 1 mL EH9 Day 25 | 353 | 236 | 67% |
| 2.5 mL EH9 Day 25 | 158 | 118 | 75% |
| 0.5 mL SA9 Day 25 | 7267 | 6755 | 93% |
| 1 mL SA9 Day 25 | 6558 | 6117 | 93% |
| 2.5 mL SA9 Day 25 | 3662 | 3437 | 94% |
| 0.5 mL EH9 Day 27 | 1363 | 963 | 71% |
| 1 mL EH9 Day 27 | 517 | 340 | 66% |
| 2.5 mL EH9 Day 27 | 77 | 55 | 71% |
| 0.5 mL SA9 Day 27 | 9896 | 9167 | 93% |
| 1 mL SA9 Day 27 | 4636 | 4291 | 93% |

Fluorospheres (Set 7.2) were diluted to 0.5 ml, 1.0 ml, and 2.5 ml final volume with Ecosurf EH-9 at Day 0. Fluorospheres (Set 7.2) were also diluted 0.5 ml, 1.0 ml, and 2.5 ml final volume with Ecosurf SA-9 at Day 0. An analysis of rCVs was performed on each sample at Day 0, Day 4, Day 7, Day 18, Day 20, Day 25, and Day 27 for each of the following channels: U3-A, U4-A, V3-A, V4-A, B3-A, B4-A, Y3-A, Y4-A, R3-A, R4-A, IR1-A, IR2-A, and IR3-A.

TABLE 12
rCV Analysis for Each of the Six Samples at Day 0, Day 4, and Day 7.

| | U3-A | U4-A | V3-A | V4-A | B3-A | B4-A | Y3-A | Y4-A | R3-A | R4-A | IR1-A | IR2-A | IR3-A |
|---|---|---|---|---|---|---|---|---|---|---|---|---|---|
| 0.5 mL EH-9 | 3.98 | 4 | 1.83 | 1.82 | 1.46 | 1.58 | 2.47 | 2.48 | 3.39 | 3.34 | 2.63 | 2.56 | 3.71 |
| 1 mL EH-9 | 3.98 | 3.96 | 1.87 | 1.84 | 1.51 | 1.6 | 2.42 | 2.44 | 3.45 | 3.44 | 4.61 | 4.39 | 5.33 |
| 2.5 mL EH-9 | 3.92 | 3.87 | 1.84 | 1.88 | 1.55 | 1.65 | 2.36 | 2.34 | 3.19 | 3.22 | 4.19 | 4 | 4.85 |
| 0.5 mL SA-9 | 4.1 | 4.16 | 1.82 | 1.8 | 1.55 | 1.65 | 2.31 | 2.31 | 3.17 | 3.16 | 9.62 | 9.26 | 9.74 |
| 1 mL SA-9 | 4.28 | 4.34 | 1.88 | 1.84 | 1.6 | 1.2 | 2.42 | 2.4 | 3.28 | 3.31 | 10.33 | 9.75 | 10.62 |
| 2.5 mL SA-9 | 3.93 | 3.95 | 1.84 | 1.81 | 1.55 | 1.63 | 2.28 | 2.31 | 3.19 | 3.18 | 5.57 | 5.23 | 6.16 |
| 0.5 mL SA-9 Day 4 | 4.16 | 4.22 | 1.96 | 1.94 | 1.51 | 1.6 | 2.77 | 2.77 | 2.88 | 2.88 | 2.53 | 2.48 | 3.69 |
| 1 mL SA-9 Day 4 | 4.14 | 4.21 | 1.91 | 1.9 | 1.46 | 1.57 | 2.74 | 2.73 | 2.81 | 2.81 | 2.75 | 2.57 | 3.74 |
| 2.5 mL SA-9 Day 4 | 4 | 3.98 | 1.88 | 1.88 | 1.42 | 1.5 | 2.72 | 2.74 | 2.76 | 2.82 | 2.69 | 2.56 | 3.83 |
| 0.5 mL EH9 Day 4 | 3.89 | 3.83 | 2.01 | 2.02 | 1.42 | 1.49 | 2.63 | 2.62 | 2.69 | 2.63 | 2.36 | 2.27 | 3.45 |
| 1 mL EH9 Day 4 | 3.53 | 3.58 | 1.95 | 1.95 | 1.49 | 1.59 | 2.63 | 2.64 | 2.69 | 2.71 | 2.17 | 2.24 | 3.5 |
| 2.5 mL EH9 Day 4 | 4.01 | 4.02 | 2.12 | 2.09 | 1.27 | 1.42 | 2.82 | 2.72 | 2.73 | 2.73 | 2.38 | 2.08 | 3.28 |
| 0.5 mL EH-9 Day 7 | 3.79 | 3.75 | 2.06 | 1.99 | 1.43 | 1.55 | 2.62 | 2.75 | 2.79 | 2.87 | 3.46 | 3.69 | 4.45 |
| 1 mL EH-9 Day 7 | 3.97 | 4.03 | 2.05 | 1.99 | 1.59 | 1.69 | 2.59 | 2.67 | 2.69 | 2.68 | 2.82 | 2.5 | 3.61 |
| 2.5 mL EH-9 Day 7 | 3.91 | 4.04 | 2.12 | 1.94 | 1.72 | 1.63 | 2.49 | 2.47 | 2.78 | 2.68 | 2.62 | 2.98 | 4.38 |
| 0.5 mL SA-9 Day 7 | 4.15 | 4.2 | 1.94 | 1.94 | 1.46 | 1.55 | 2.79 | 2.82 | 2.91 | 2.89 | 2.55 | 2.56 | 3.55 |
| 1 mL SA-9 Day 7 | 4.08 | 4.12 | 1.94 | 1.95 | 1.41 | 1.52 | 2.74 | 2.7 | 2.84 | 2.82 | 2.74 | 2.73 | 3.65 |
| 2.5 mL SA-9 Day 7 | 4.37 | 4.52 | 1.96 | 1.91 | 1.54 | 1.63 | 2.73 | 2.77 | 2.9 | 2.91 | 2.33 | 2.41 | 3.43 |

TABLE 13
rCV Analysis for Each of the Six Samples at Day 18, Day 20, Day 25, and Day 27.

| | U3-A | U4-A | V3-A | V4-A | B3-A | B4-A | Y3-A | Y4-A | R3-A | R4-A | IR1-A | IR2-A | IR3-A |
|---|---|---|---|---|---|---|---|---|---|---|---|---|---|
| 0.5 mL EH9 Day 18 | 3.74 | 3.78 | 2.09 | 2.16 | 2 | 2.07 | 2.18 | 2.29 | 3.34 | 3.42 | 2.31 | 2.27 | 3.09 |
| 1 mL EH9 Day 18 | 3.73 | 3.82 | 1.98 | 1.89 | 2.17 | 2.23 | 2.09 | 2.15 | 3.33 | 3.31 | 2.66 | 2.66 | 3.4 |
| 2.5 mL EH9 Day 18 | 3.85 | 3.96 | 2.19 | 2.32 | 1.99 | 1.98 | 2.47 | 2.3 | 3.29 | 3.23 | 3.26 | 3.02 | 3.55 |
| 0.5 mL SA9 Day 18 | 3.94 | 3.97 | 1.82 | 1.78 | 1.91 | 1.95 | 2.17 | 2.21 | 3.16 | 3.18 | 2.23 | 2.18 | 3.19 |
| 1 mL SA9 Day 18 | 4.09 | 4.13 | 1.96 | 1.89 | 1.98 | 2 | 2.36 | 2.39 | 3.35 | 3.36 | 5.37 | 5.59 | 5.84 |
| 2.5 mL SA9 Day 18 | 4.17 | 4.15 | 1.96 | 1.91 | 1.97 | 1.97 | 2.33 | 2.35 | 3.34 | 3.36 | 5.53 | 5.65 | 5.97 |
| 0.5 mL EH9 Day 20 | 4.01 | 4.04 | 2.38 | 2.31 | 2.17 | 2.23 | 2.3 | 2.26 | 3.04 | 3.12 | 3.6 | 3.44 | 4.48 |
| 1 mL EH9 Day 20 | 3.74 | 4.13 | 2.41 | 2.06 | 2.59 | 2.63 | 2.57 | 2.49 | 3.09 | 2.95 | 5.45 | 4.48 | 6.07 |
| 2.5 mL EH9 Day 20 | 3.39 | 3.37 | 1.89 | 1.84 | 2.14 | 2.27 | 2.27 | 2.18 | 2.67 | 2.8 | 3.33 | 3.17 | 4.08 |
| 0.5 mL SA9 Day 20 | 4.07 | 4.11 | 2.18 | 2.14 | 2.08 | 2.14 | 2.56 | 2.6 | 3.36 | 3.35 | 3.83 | 3.63 | 4.48 |
| 1 mL SA9 Day 20 | 4.01 | 4.03 | 2.22 | 2.13 | 2.2 | 2.24 | 2.62 | 2.61 | 3.47 | 3.44 | 3.84 | 3.71 | 4.6 |
| 2.5 mL SA9 Day 20 | 4.14 | 4.28 | 2.16 | 2.11 | 2.15 | 2.19 | 2.59 | 2.66 | 3.39 | 3.39 | 3.78 | 3.46 | 4.45 |
| 0.5 mL EH9 Day 25 | 3.77 | 3.95 | 2.11 | 2.11 | 2 | 2.1 | 2.42 | 2.34 | 2.96 | 2.97 | 2.78 | 2.8 | 3.51 |
| 1 mL EH9 Day 25 | 3.27 | 3.33 | 2.15 | 2.08 | 1.72 | 1.78 | 2.33 | 2.41 | 2.71 | 2.76 | 2.6 | 2.78 | 3.41 |
| 2.5 mL EH9 Day 25 | 4.32 | 4.64 | 2.08 | 2.11 | 1.98 | 2.15 | 2.21 | 2.55 | 2.78 | 2.84 | 2.62 | 2.75 | 3.46 |
| 0.5 mL SA9 Day 25 | 3.85 | 3.94 | 2.03 | 1.98 | 1.87 | 1.91 | 2.32 | 2.3 | 2.98 | 2.95 | 2.51 | 2.38 | 3.35 |
| 1 mL SA9 Day 25 | 3.9 | 3.99 | 2.07 | 2.06 | 1.8 | 1.81 | 2.26 | 2.33 | 2.96 | 2.96 | 5.21 | 5.43 | 5.68 |
| 2.5 mL SA9 Day 25 | 3.87 | 3.96 | 2.06 | 2 | 1.98 | 2.01 | 2.2 | 2.2 | 3.1 | 3.13 | 2.63 | 2.52 | 3.58 |
| 0.5 mL EH9 Day 27 | 3.9 | 3.95 | 2 | 1.94 | 1.91 | 2 | 2.06 | 2.18 | 3.07 | 3.03 | 3.53 | 3.29 | 4.23 |
| 1 mL EH9 Day 27 | 3.39 | 3.47 | 2.02 | 2.01 | 1.79 | 1.94 | 2.25 | 2.25 | 3.68 | 3.38 | 2.99 | 2.92 | 3.83 |
| 2.5 mL EH9 Day 27 | 3.72 | 4.03 | 1.88 | 1.73 | 2.39 | 2.19 | 2.2 | 2.21 | 3.28 | 3.2 | 3.14 | 2.94 | 3.32 |
| 0.5 mL SA9 Day 27 | 3.87 | 3.9 | 1.94 | 1.94 | 1.97 | 1.99 | 2.26 | 2.26 | 3.29 | 3.33 | 2.75 | 2.5 | 3.59 |
| 1 mL SA9 Day 27 | 3.75 | 3.89 | 1.96 | 1.93 | 2.05 | 2.07 | 2.16 | 2.15 | 3.15 | 3.21 | 2.98 | 2.76 | 3.67 |

The MdFl calculation and MdFl % difference was also evaluated and disclosed in FIGS. 5D-5M. More specifically, FIGS. 5D-5F show the MdFl % difference for fluorospheres of the present invention diluted to 0.5 ml with Ecosurf EH-9 (FIG. 5D), diluted to 1.0 ml with Ecosurf EH-9 (FIG. 5E), and diluted to 2.5 ml with Ecosurf EH-9 (FIG. 5F). FIGS. 5G-5I show the MdFl % difference for fluorospheres of the present invention diluted to 0.5 ml with Ecosurf SA-9 (FIG. 5G), diluted to 1.0 ml with Ecosurf SA-9 (FIG. 5H), and diluted to 2.5 ml with Ecosurf SA-9 (FIG. 5I). FIGS. 5J-5K shows MdFl over time (Day 0, Day 4, Day 7, Day 18, Day 20, Day 25, Day 27) for fluorospheres of the present invention diluted to 0.5 ml in Ecosurf EH-9 (FIG. 5J) and diluted to 2.5 ml in Ecosurf EH-9 (FIG. 5K). FIGS. 5L-5M show MdFl over time (Day 0, Day 4, Day 7, Day 18, Day 20, Day 25, Day 27 (only for Ecosurf EH-9)) for fluorospheres of the present invention diluted to 2.5 ml in Ecosurf EH-9 (FIG. 5L) and diluted to 2.5 ml in Ecosurf SA-9 (FIG. 5M)

### Example 5

The stability of fluorospheres of the present invention were evaluated following exposure to light. Fluorospheres of the present invention (Set 10) having 8 dyes were prepared for evaluation. The fluorospheres included UV dye, Light Yellow dye, Yellow dye, Nile Red dye, Purple dye, Blue dye, Sky Blue dye, and Jade Green. Jade Green was added to the fluorospheres at the same time as the other dyes. The fluorospheres were washed with 0.01% NP-40. One set of fluorospheres of the present invention (Set 10.1) were diluted to 1×10⁶ fluorospheres/mL in SDS (Set 10.1 SDS Diluted) following the wash with 0.01% NP-40. A second set of fluorospheres (Set 10.1) were resuspended in 0.05% Ecosurf EH-9 and 0.02% sodium azide following a wash with the same buffer (Set 10.1 Wash+Resuspended in Ecosurf+SA). A third set of fluorospheres (Set 10.2) were diluted and then resuspended in a buffer of 0.05% Ecosurf EH-9 and 0.02% sodium azide (Set 10.2 SDS Diluted Ecosurf+SA). A fourth set of fluorospheres (Set 10.2) were diluted and resuspended in a buffer of 0.1% ethanolamine, 0.05% Ecosurf EH-9 and 0.02% sodium azide (Set 10.2 SDS Diluted ETA+Ecosurf+SA). All fluorosphere suspensions were diluted or resuspended to a working concentration of 1×10⁶ fluorospheres/mL.

All samples were vortexed for 5 seconds prior to acquisition. Sample were exposed to 1500 lux for different time periods: 0 minutes (control), 15 minutes, 30 minutes, 1 hours, 2 hours, 4 hours, and 6 hours. Regular light exposure in a lab is presumed to be 400-800 lux. Threshold of the FSC height was 100,000. The fluorospheres were acquired and assessed for rCV, singlet percentage, and MdFl difference in comparison to Day 0.

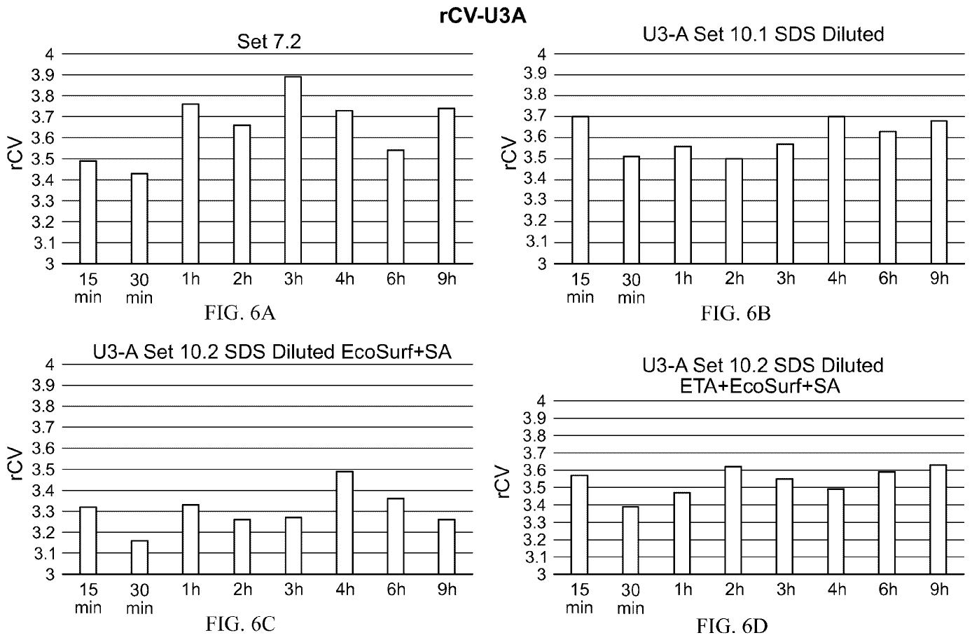

FIGS. 6-14 show the rCV analysis of each sample.

FIG. 6 shows the analysis of light exposure (1500 lux at different time points) to fluorospheres of the present invention based upon an analysis of rCV in comparison to Day 0. FIGS. 6A-6D show rCV analysis of fluorospheres of the present invention (Set 7.2 compared to Set 10.1 and Set 10.2) at channel U3A at 15 minutes, 30 minutes, 1 hour, 2 hours, 3 hours, 4 hours, 6 hours, and 9 hours. Specifically, FIG. 6A shows the rCV analysis of Set 7.2. FIG. 6B shows the rCV analysis of set 10.1 diluted in sodium dodecyl sulfate (“SDS”) to 1×10⁶ fluorospheres per ml. FIG. 6C shows the rCV analysis of Set 10.2 diluted and resuspended in SDS with 0.05% Ecosurf EH-9 and 0.02% sodium azide. FIG. 6D shows the rCV analysis of Set 10.2 diluted and resuspended in SDS with 0.1% ethanolamine, 0.05% Ecosurf EH-9, and 0.02% sodium azide.

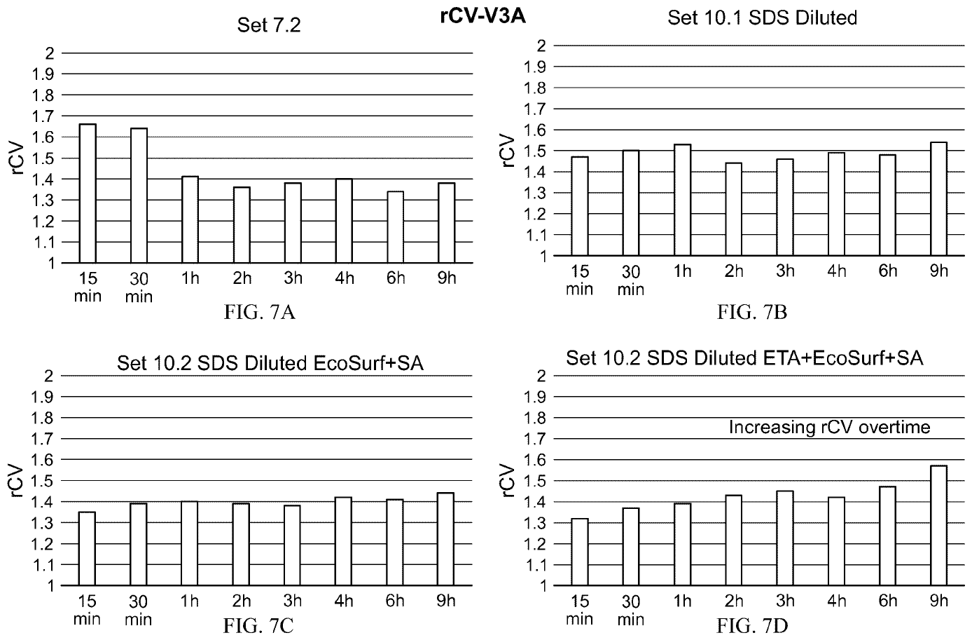

FIG. 7 shows the analysis of light exposure (1500 lux at different time points) to fluorospheres of the present invention based upon an analysis of rCV in comparison to Day 0. FIGS. 7A-7D show rCV analysis of fluorospheres of the present invention (Set 7.2 compared to Set 10.1 and Set 10.2) at channel U3A at 15 minutes, 30 minutes, 1 hour, 2 hours, 3 hours, 4 hours, 6 hours, and 9 hours. Specifically, FIG. 7A shows the rCV analysis of Set 7.2. FIG. 7B shows the rCV analysis of set 10.1 diluted in SDS to 1×10⁶ fluorospheres per ml. FIG. 7C shows the rCV analysis of Set 10.2 diluted and resuspended in SDS with 0.05% Ecosurf EH-9 and 0.02% sodium azide. FIG. 7D shows the rCV analysis of Set 10.2 diluted and resuspended in SDS with 0.1% ethanolamine, 0.05% Ecosurf EH-9, and 0.02% sodium azide.

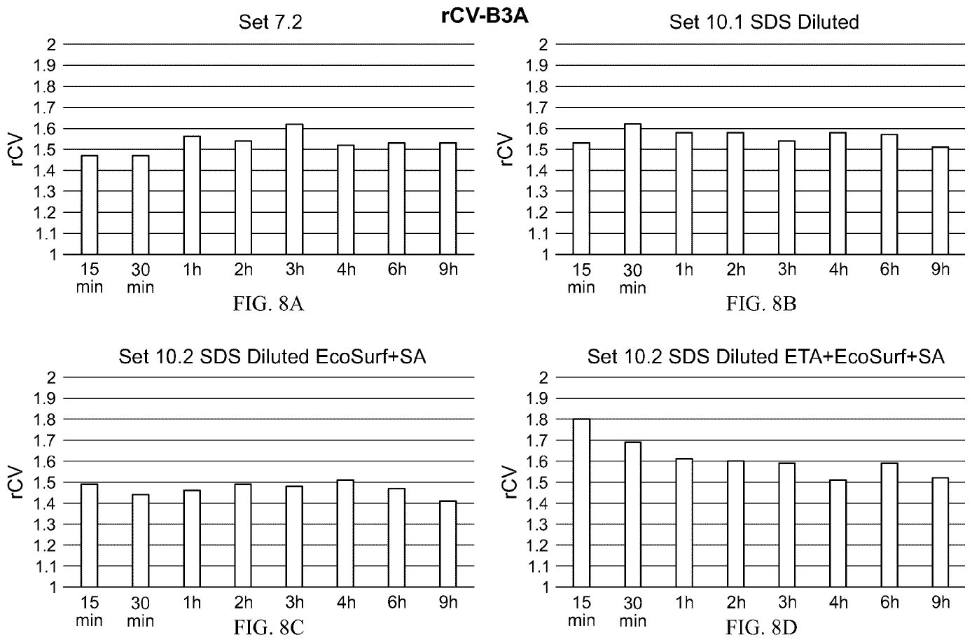

FIG. 8 shows the analysis of light exposure (1500 lux at different time points) to fluorospheres of the present invention based upon an analysis of rCV in comparison to Day 0. FIGS. 8A-8D show rCV analysis of fluorospheres of the present invention (Set 7.2 compared to Set 10.1 and Set 10.2) at channel B3A at 15 minutes, 30 minutes, 1 hour, 2 hours, 3 hours, 4 hours, 6 hours, and 9 hours. Specifically, FIG. 8A shows the rCV analysis of Set 7.2. FIG. 8B shows the rCV analysis of Set 10.1 diluted in SDS to 1×10⁶ fluorospheres per ml. FIG. 8C shows the rCV analysis of Set 10.2 diluted and resuspended in SDS with 0.05% Ecosurf EH-9 and 0.02% sodium azide. FIG. 8D shows the rCV analysis of Set 10.2 diluted and resuspended in SDS with 0.1% ethanolamine, 0.05% Ecosurf EH-9, and 0.02% sodium azide.

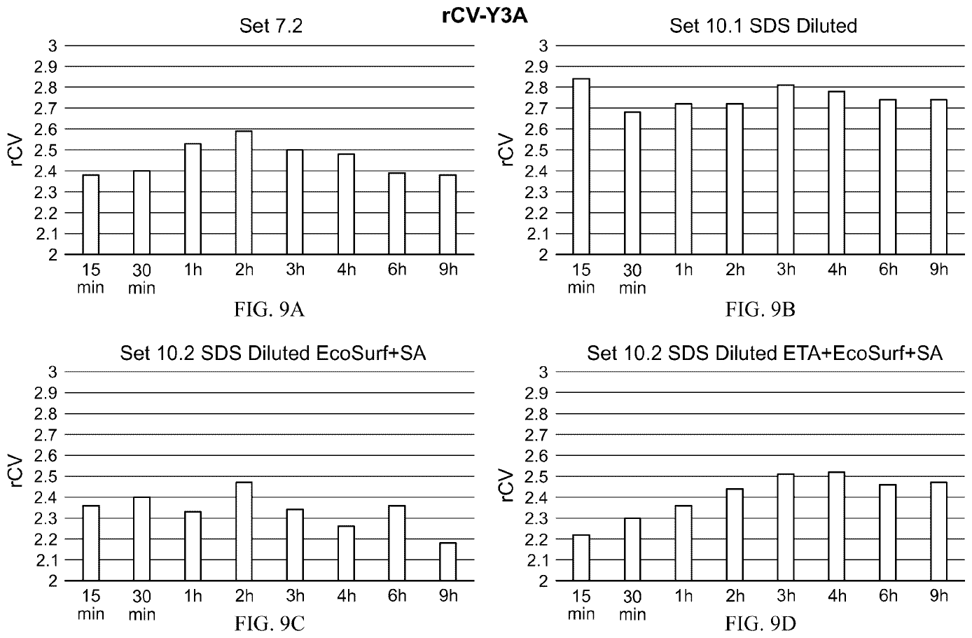

FIG. 9 shows the analysis of light exposure (1500 lux at different time points) to fluorospheres of the present invention based upon an analysis of rCV in comparison to Day 0. FIGS. 9A-9D show rCV analysis of fluorospheres of the present invention (Set 7.2 compared to Set 10.1 and Set 10.2) at channel Y3A at 15 minutes, 30 minutes, 1 hour, 2 hours, 3 hours, 4 hours, 6 hours, and 9 hours. Specifically, FIG. 9A shows the rCV analysis of Set 7.2. FIG. 9B shows the rCV analysis of Set 10.1 diluted in SDS to 1×10⁶ fluorospheres per ml. FIG. 9C shows the rCV analysis of Set 10.2 diluted and resuspended in SDS with 0.05% Ecosurf EH-9 and 0.02% sodium azide. FIG. 9D shows the rCV analysis of Set 10.2 diluted and resuspended in SDS with 0.1% ethanolamine, 0.05% Ecosurf EH-9, and 0.02% sodium azide.

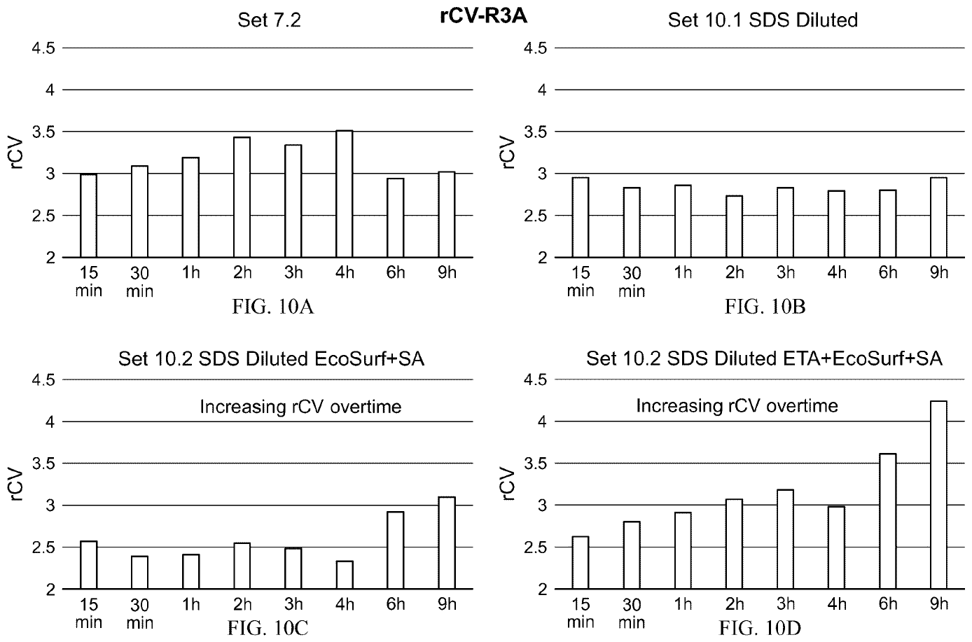

FIG. 10 shows the analysis of light exposure (1500 lux at different time points) to fluorospheres of the present invention based upon an analysis of rCV in comparison to Day 0. FIGS. 10A-10D show rCV analysis of fluorospheres of the present invention (Set 7.2 compared to Set 10.1 and Set 10.2) at channel R3A at 15 minutes, 30 minutes, 1 hour, 2 hours, 3 hours, 4 hours, 6 hours, and 9 hours. Specifically, FIG. 10A shows the rCV analysis of Set 7.2. FIG. 10B shows the rCV analysis of Set 10.1 diluted in SDS to 1×10⁶ fluorospheres per ml. FIG. 10C shows the rCV analysis of Set 10.2 diluted and resuspended in SDS with 0.05% Ecosurf EH-9 and 0.02% sodium azide. FIG. 10D shows the rCV analysis of Set 10.2 diluted and resuspended in SDS with 0.1% ethanolamine, 0.05% Ecosurf EH-9, and 0.02% sodium azide.

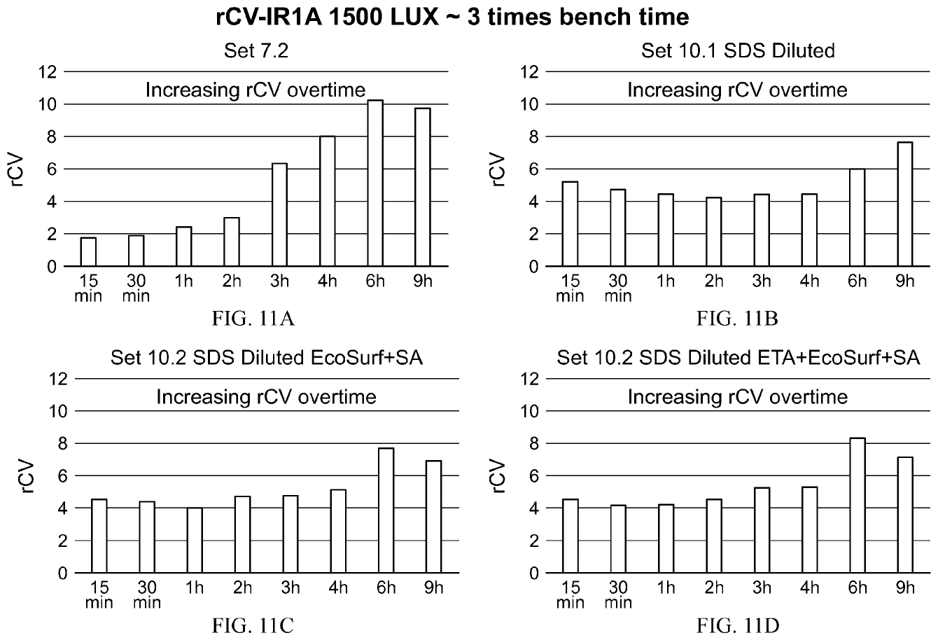

FIG. 11 shows the analysis of light exposure (1500 lux at different time points) to fluorospheres of the present invention based upon an analysis of rCV in comparison to Day 0. FIGS. 11A-11D show rCV analysis of fluorospheres of the present invention (Set 7.2 compared to Set 10.1 and Set 10.2) at channel IRIA at 15 minutes, 30 minutes, 1 hour, 2 hours, 3 hours, 4 hours, 6 hours, and 9 hours. Specifically, FIG. 11A shows the rCV analysis of Set 7.2. FIG. 11B shows the rCV analysis of Set 10.1 diluted in SDS to 1×10⁶ fluorospheres per ml. FIG. 11C shows the rCV analysis of Set 10.2 diluted and resuspended in SDS with 0.05% Ecosurf EH-9 and 0.02% sodium azide. FIG. 11D shows the rCV analysis of Set 10.2 diluted and resuspended in SDS with 0.1% ethanolamine, 0.05% Ecosurf EH-9, and 0.02% sodium azide.

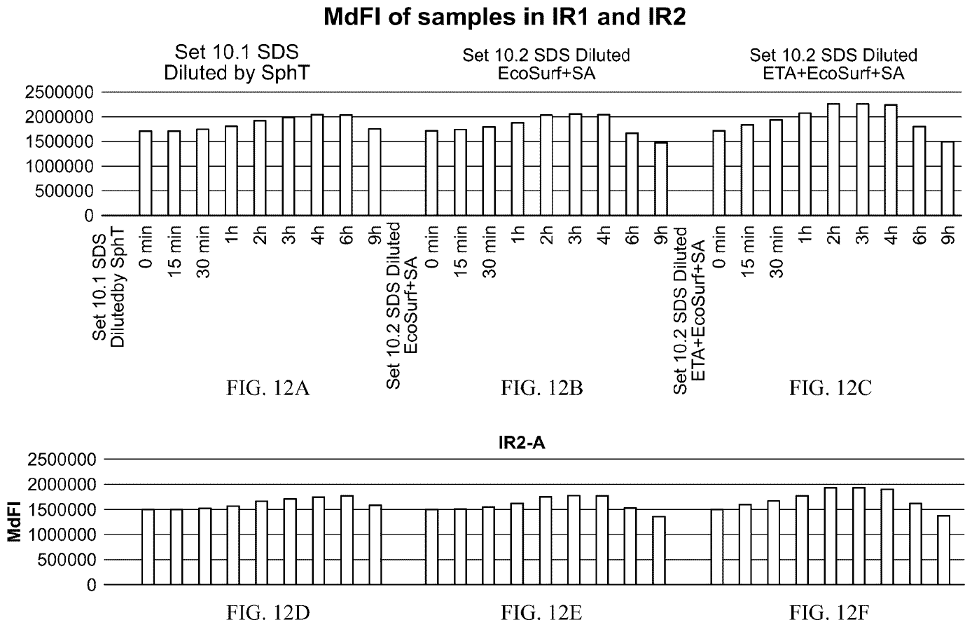

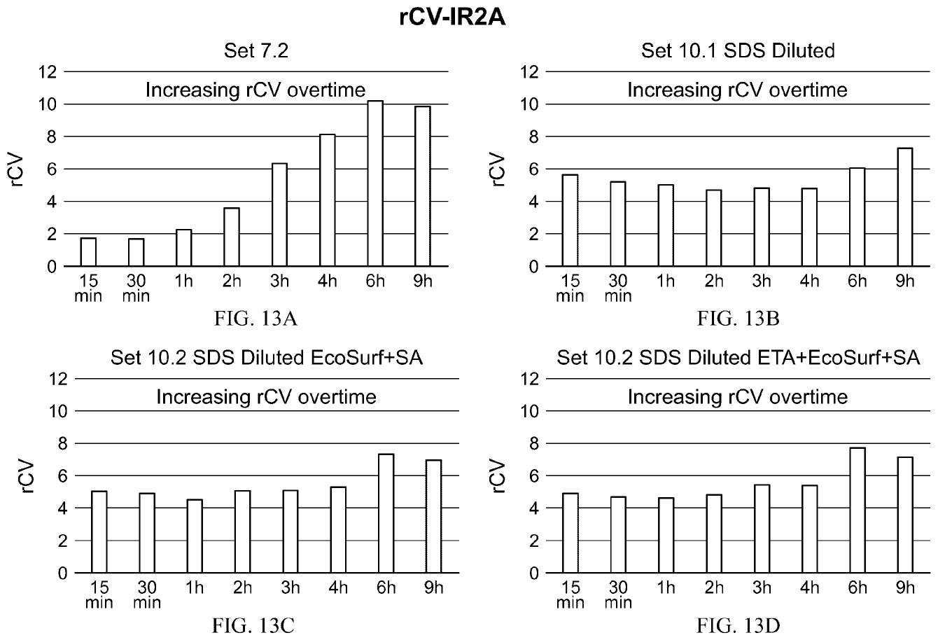

FIG. 12 shows a comparison of the MdFl for channels IRIA (FIGS. 12A-12C) and IR2A (FIGS. 12D-12F) for the same samples evaluated in FIG. 11 and FIG. 13. Specifically, FIG. 12A shows the MdFl analysis of Set 10.1 diluted in SDS to 1×10⁶ fluorospheres per ml. FIG. 12B shows the MdFl analysis of Set 10.2 diluted and resuspended in SDS with 0.05% Ecosurf EH-9 and 0.02% sodium azide. FIG. 12C shows the MdFl analysis of Set 10.2 diluted and resuspended in SDS with 0.1% ethanolamine, 0.05% Ecosurf EH-9, and 0.02% sodium azide. FIG. 12D shows the MdFl analysis of Set 10.1 diluted in SDS to 1×10⁶ fluorospheres per ml. FIG. 12E shows the MdFl analysis of Set 10.2 diluted and resuspended in SDS with 0.05% Ecosurf EH-9 and 0.02% sodium azide. FIG. 12F shows the MdFl analysis of Set 10.2 diluted and resuspended in SDS with 0.1% ethanolamine, 0.05% Ecosurf EH-9, and 0.02% sodium azide.

FIG. 13 shows the analysis of light exposure (1500 lux at different time points) to fluorospheres of the present invention based upon an analysis of rCV in comparison to Day 0. FIGS. 13A-13D show rCV analysis of fluorospheres of the present invention (Set 7.2 compared to Set 10.1 and Set 10.2) at channel IR2A at 15 minutes, 30 minutes, 1 hour, 2 hours, 3 hours, 4 hours, 6 hours, and 9 hours. Specifically, FIG. 13A shows the rCV analysis of Set 7.2. FIG. 13B shows the rCV analysis of Set 10.1 diluted in SDS to 1×10⁶ fluorospheres per ml. FIG. 13C shows the rCV analysis of Set 10.2 diluted and resuspended in SDS with 0.05% Ecosurf EH-9 and 0.02% sodium azide. FIG. 13D shows the rCV analysis of Set 10.2 diluted and resuspended in SDS with 0.1% ethanolamine, 0.05% Ecosurf EH-9, and 0.02% sodium azide.

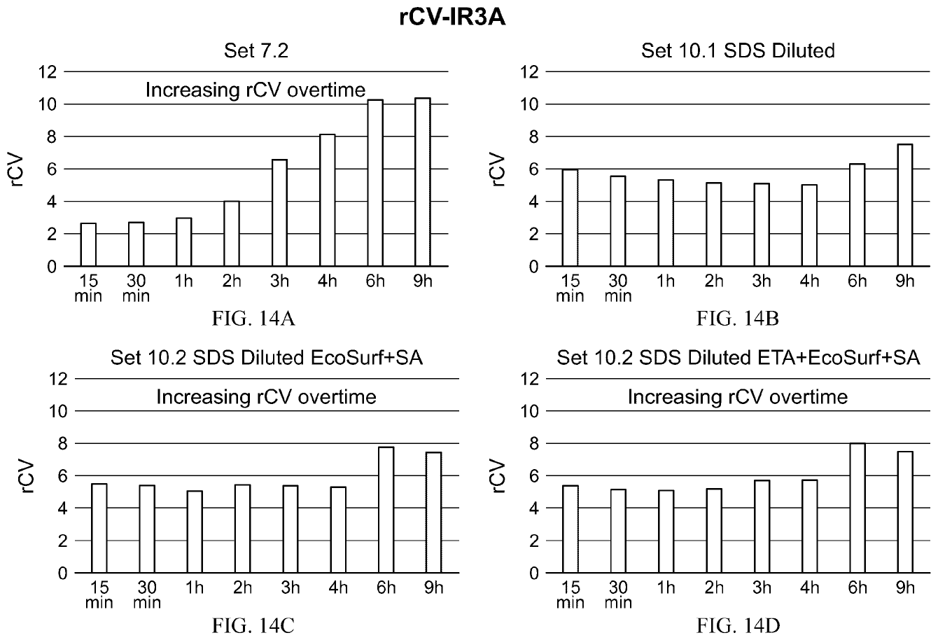

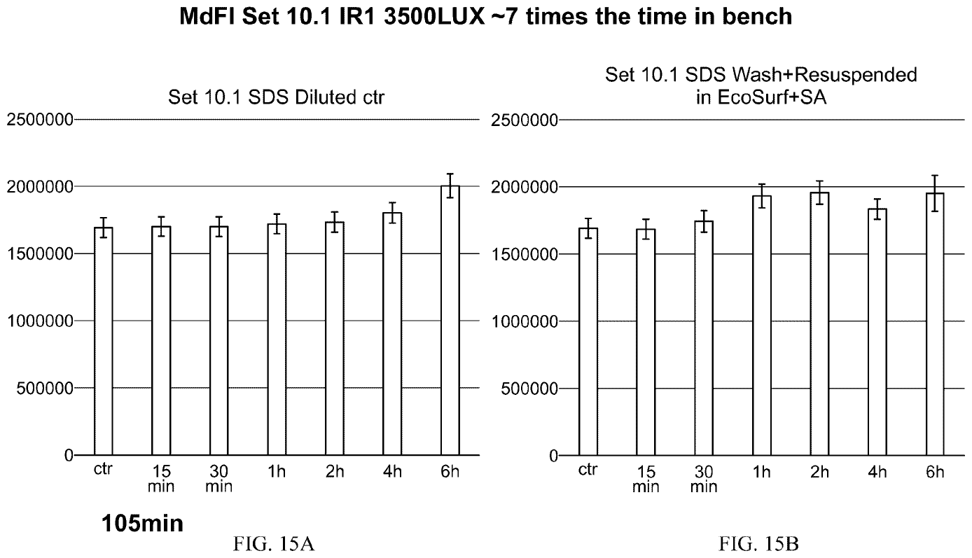

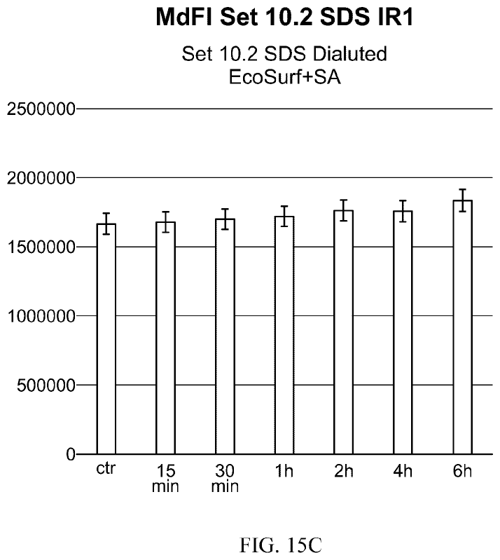

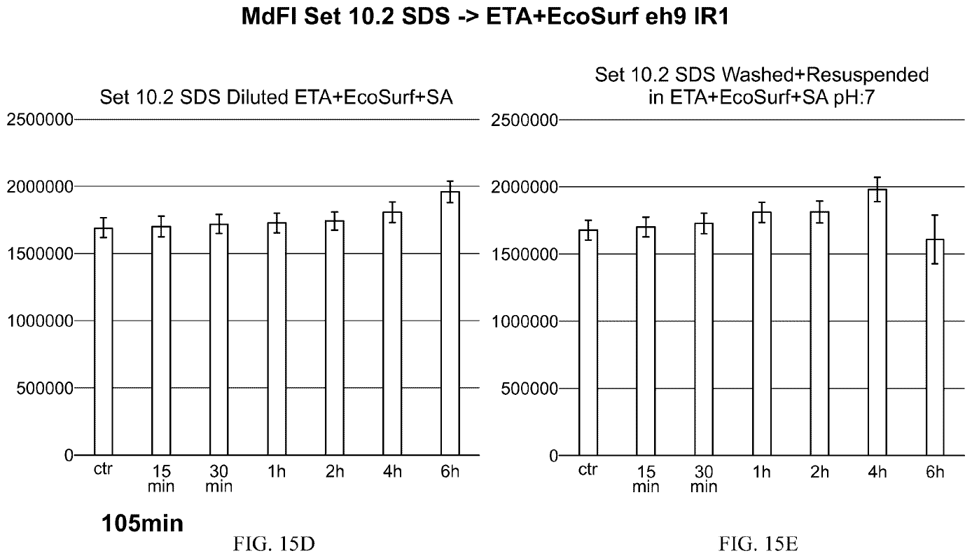

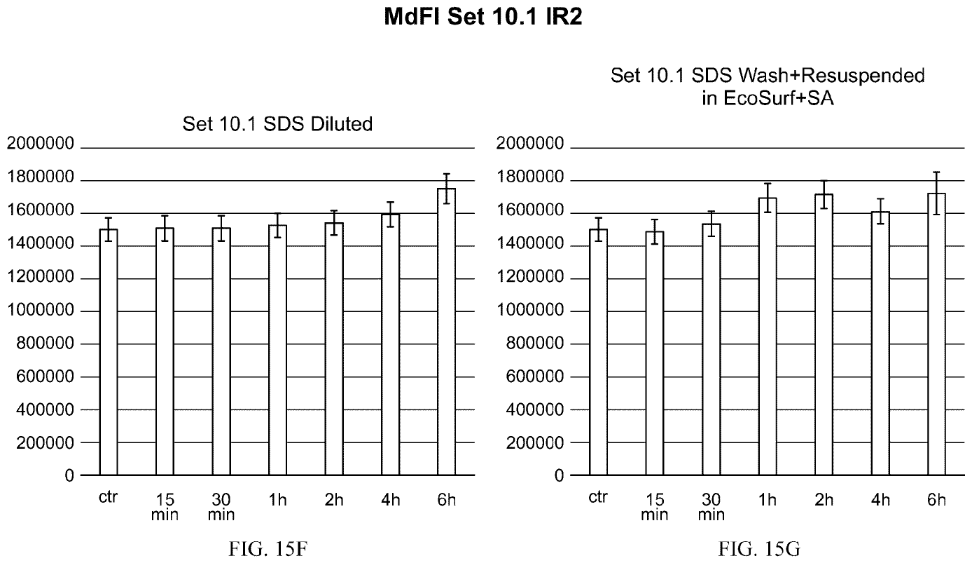

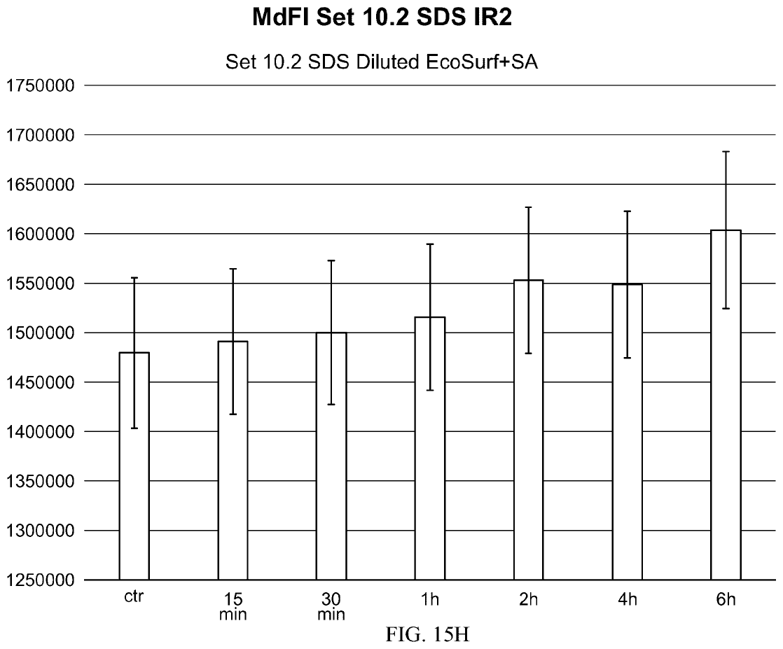

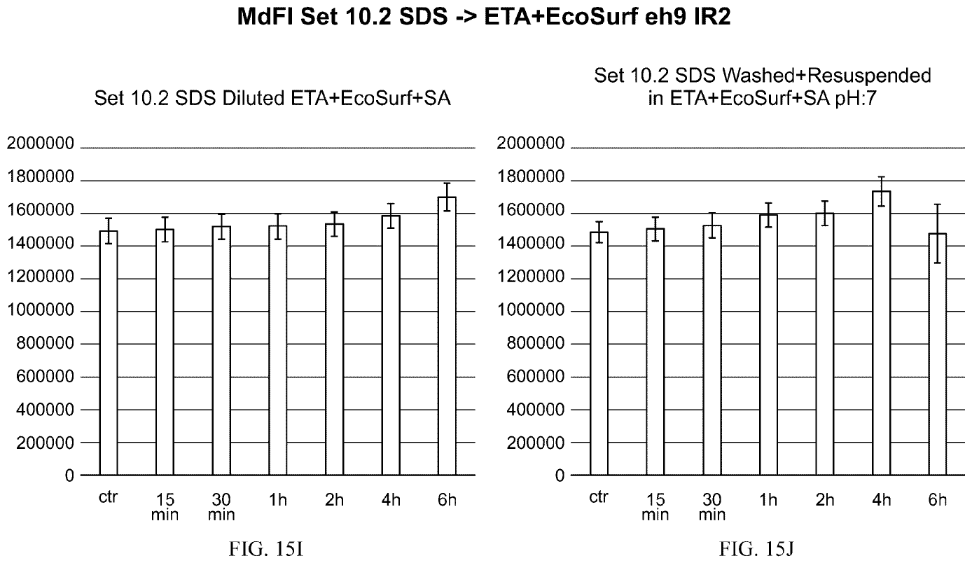

FIG. 14 shows the analysis of light exposure (1500 lux at different time points) to fluorospheres of the present invention based upon an analysis of rCV in comparison to Day 0. FIGS. 14A-14D show rCV analysis of fluorospheres of the present invention (Set 7.2 compared to Set 10.1 and Set 10.2) at channel IR3A at 15 minutes, 30 minutes, 1 hour, 2 hours, 3 hours, 4 hours, 6 hours, and 9 hours. Specifically, FIG. 14A shows the rCV analysis of Set 7.2. FIG. 14B shows the rCV analysis of Set 10.1 diluted in SDS to 1×10⁶ fluorospheres per ml. FIG. 14C shows the rCV analysis of Set 10.2 diluted and resuspended in SDS with 0.05% Ecosurf EH-9 and 0.02% sodium azide. FIG. 14D shows the rCV analysis of Set 10.2 diluted and resuspended in SDS with 0.1% ethanolamine, 0.05% Ecosurf EH-9, and 0.02% sodium azide.

Table 14 shows the rCV analysis of each sample over time after exposure to 3500 lux. The rCV analysis was conducted at the following channels: U3-A, V3-A, B3-A, Y3-A, IR1-A, and IR2-A.

TABLE 14
rCV analysis of Fluorosphere Samples Over Time Following Exposure to 3500 Lux.

| TubeName | U3-A | V3-A | B3-A | Y3-A | R3-A | IR1-A | IR2-A |
|---|---|---|---|---|---|---|---|
| Set 10.1 SDS Diluted by SphT ctr | 3.55 | 1.48 | 1.49 | 2.62 | 3.02 | 4.33 | 4.94 |
| Set 10.1 SDS Diluted by SphT 15 min | 3.37 | 1.43 | 1.48 | 2.58 | 2.94 | 4.32 | 4.88 |
| Set 10.1 SDS Diluted by SphT 30 min | 3.71 | 1.44 | 1.33 | 2.8 | 3.21 | 4.3 | 4.91 |
| Set 10.1 SDS Diluted by SphT 1 h | 3.56 | 1.46 | 1.39 | 2.65 | 3.03 | 4.23 | 4.78 |
| Set 10.1 SDS Diluted by SphT 2 h | 3.69 | 1.42 | 1.38 | 2.66 | 3.07 | 4.27 | 4.77 |
| Set 10.1 SDS Diluted by SphT 4 h | 3.56 | 1.57 | 1.52 | 2.72 | 3.02 | 4.18 | 4.68 |
| Set 10.1 SDS Diluted by SphT 6 h | 3.55 | 1.52 | 1.56 | 2.67 | 2.93 | 4.52 | 4.96 |
| Set 10.1 SDS Wash + Resuspended in | 3.5 | 1.41 | 1.59 | 2.61 | 2.89 | 4.36 | 4.93 |
| EcoSurf + SA r1 ctr | | | | | | | |
| Set 10.1 SDS Wash + Resuspended in | 3.65 | 1.48 | 1.51 | 2.53 | 2.94 | 4.3 | 4.9 |
| EcoSurf + SA r1 15 min | | | | | | | |
| Set 10.1 SDS Wash + Resuspended in | 3.45 | 1.45 | 1.54 | 2.57 | 2.88 | 4.38 | 4.93 |
| EcoSurf + SA r1 30 min | | | | | | | |
| Set 10.1 SDS Wash + Resuspended in | 3.67 | 1.42 | 1.55 | 2.71 | 3.07 | 4.5 | 5.02 |
| EcoSurf + SA r1 1 h | | | | | | | |
| Set 10.1 SDS Wash + Resuspended in | 3.73 | 1.46 | 1.52 | 2.72 | 2.99 | 4.38 | 4.92 |
| EcoSurf + SA r1 2 h | | | | | | | |
| Set 10.1 SDS Wash + Resuspended in | 3.63 | 1.42 | 1.48 | 2.6 | 2.86 | 4.22 | 4.81 |
| EcoSurf + SA r1 4 h | | | | | | | |
| Set 10.1 SDS Wash + Resuspended in | 3.46 | 1.48 | 1.59 | 2.67 | 3.15 | 6.75 | 6.54 |
| EcoSurf + SA r1 6 h | | | | | | | |
| Set 10.2 SDS Diluted EcoSurf + SA ctr | 3.55 | 1.41 | 1.5 | 2.51 | 2.87 | 4.49 | 5.08 |
| Set 10.2 SDS Diluted EcoSurf + SA 15 | 3.59 | 1.43 | 1.5 | 2.56 | 2.88 | 4.39 | 4.99 |
| min | | | | | | | |
| Set 10.2 SDS Diluted EcoSurf + SA 30 | 3.56 | 1.44 | 1.44 | 2.51 | 2.84 | 4.31 | 4.91 |
| min | | | | | | | |
| Set 10.2 SDS Diluted EcoSurf + SA 1 h | 3.52 | 1.42 | 1.48 | 2.52 | 2.78 | 4.3 | 4.89 |
| Set 10.2 SDS Diluted EcoSurf + SA 2 h | 3.44 | 1.39 | 1.52 | 2.46 | 2.69 | 4.15 | 4.71 |
| Set 10.2 SDS Diluted EcoSurf + SA 4 h | 3.42 | 1.41 | 1.51 | 2.5 | 2.73 | 4.26 | 4.84 |
| Set 10.2 SDS Diluted EcoSurf + SA 6 h | 3.45 | 1.39 | 1.5 | 2.51 | 2.67 | 4.32 | 4.76 |
| Set 10.2 SDS Diluted | 3.6 | 1.54 | 1.53 | 2.57 | 2.84 | 4.44 | 4.89 |
| ETA + EcoSurf + SA ctr | | | | | | | |
| Set 10.2 SDS Diluted | 3.47 | 1.45 | 1.49 | 2.46 | 2.74 | 4.41 | 4.92 |
| ETA + EcoSurf + SA 15 min | | | | | | | |
| Set 10.2 SDS Diluted | 3.52 | 1.44 | 1.51 | 2.45 | 2.75 | 4.12 | 4.7 |
| ETA + EcoSurf + SA 30 min | | | | | | | |
| Set 10.2 SDS Diluted | 3.54 | 1.42 | 1.45 | 2.53 | 2.74 | 4.15 | 4.69 |
| ETA + EcoSurf + SA 1 h | | | | | | | |
| Set 10.2 SDS Diluted | 3.4 | 1.47 | 1.48 | 2.48 | 2.72 | 4.08 | 4.64 |
| ETA + EcoSurf + SA 2 h | | | | | | | |
| Set 10.2 SDS Diluted | 3.55 | 1.42 | 1.49 | 2.55 | 2.61 | 4.1 | 4.61 |
| ETA + EcoSurf + SA 4 h | | | | | | | |
| Set 10.2 SDS Diluted | 3.58 | 1.43 | 1.48 | 2.54 | 2.71 | 4.08 | 4.59 |
| ETA + EcoSurf + SA 6 h | | | | | | | |
| Set 10.2 SDS Washed + Resuspended in | 3.37 | 1.43 | 1.47 | 2.46 | 2.61 | 3.87 | 4.37 |
| ETA + EcoSurf + SA pH: 7 r3 1ctr | | | | | | | |
| Set 10.2 SDS Washed + Resuspended in | 3.51 | 1.53 | 1.58 | 2.51 | 2.8 | 4.25 | 4.8 |
| ETA + EcoSurf + SA pH: 7 r3 15 min | | | | | | | |
| Set 10.2 SDS Washed + Resuspended in | 3.55 | 1.54 | 1.58 | 2.65 | 2.86 | 4.32 | 4.9 |
| ETA + EcoSurf + SA pH: 7 r3 30 min | | | | | | | |
| Set 10.2 SDS Washed + Resuspended in | 3.57 | 1.5 | 1.52 | 2.63 | 2.78 | 4.16 | 4.67 |
| ETA + EcoSurf + SA PH: 7 r3 1 h | | | | | | | |
| Set 10.2 SDS Washed + Resuspended in | 3.31 | 1.49 | 1.69 | 2.46 | 2.58 | 4.31 | 4.79 |
| ETA + EcoSurf + SA pH: 7 r3 2 h | | | | | | | |
| Set 10.2 SDS Washed + Resuspended in | 3.4 | 1.52 | 1.66 | 2.64 | 2.95 | 4.53 | 4.94 |
| ETA + EcoSurf + SA pH: 7 r3 4 h | | | | | | | |
| Set 10.2 SDS Washed + Resuspended in | 3.59 | 1.7 | 1.52 | 2.63 | 4.88 | 11.33 | 10.37 |
| ETA + EcoSurf + SA pH: 7 r3 6 h | | | | | | | |

Table 15 shows the % singlet analysis of each sample over time after exposure to 3500 lux.

TABLE 15
% Singlet Analysis of Fluorosphere Samples
Over Time Following Exposure to 3500Lux.

| | | Singles | |
|---|---|---|---|
| TubeName | Population | Events | Singlets % |
| Set 10.1 SDS Diluted | 4215 | 3775 | 90% |
| by SphT ctr | | | |
| Set 10.1 SDS Diluted | 9158 | 8245 | 90% |
| by SphT 15 min | | | |
| Set 10.1 SDS Diluted | 9459 | 8153 | 86% |
| by SphT 30 min | | | |
| Set 10.1 SDS Diluted | 9549 | 8310 | 87% |
| by SphT 1 h | | | |
| Set 10.1 SDS Diluted | 9482 | 8365 | 88% |
| by SphT 2 h | | | |
| Set 10.1 SDS Diluted | 9056 | 7894 | 87% |
| by SphT 4 h | | | |
| Set 10.1 SDS Diluted | 9678 | 8541 | 88% |
| by SphT 6 h | | | |
| Set 10.1 SDS Wash + | 1917 | 1687 | 88% |
| Resuspended in EcoSurf + | | | |
| SA r1 ctr | | | |
| Set 10.1 SDS Wash + | 6274 | 5534 | 88% |
| Resuspended in EcoSurf + | | | |
| SA r1 15 min | | | |
| Set 10.1 SDS Wash + | 4876 | 4269 | 88% |
| Resuspended in EcoSurf + | | | |
| SA r1 30 min | | | |
| Set 10.1 SDS Wash + | 5594 | 4833 | 86% |
| Resuspended in EcoSurf + | | | |
| SA r1 1 h | | | |
| Set 10.1 SDS Wash + | 4732 | 3955 | 84% |
| Resuspended in EcoSurf + | | | |
| SA r1 2 h | | | |
| Set 10.1 SDS Wash + | 4016 | 3484 | 87% |
| Resuspended in EcoSurf + | | | |
| SA r1 4 h | | | |
| Set 10.1 SDS Wash + | 6637 | 5663 | 85% |
| Resuspended in EcoSurf + | | | |
| SA r1 6 h | | | |
| Set 10.2 SDS Diluted | 6859 | 5818 | 85% |
| EcoSurf + SA ctr | | | |
| Set 10.2 SDS Diluted | 8900 | 7716 | 87% |
| EcoSurf + SA 15 min | | | |
| Set 10.2 SDS Diluted | 7042 | 6052 | 86% |
| EcoSurf + SA 30 min | | | |
| Set 10.2 SDS Diluted | 9685 | 8309 | 86% |
| EcoSurf + SA 1 h | | | |
| Set 10.2 SDS Diluted | 8169 | 7097 | 87% |
| EcoSurf + SA 2 h | | | |
| Set 10.2 SDS Diluted | 7779 | 6780 | 87% |
| EcoSurf + SA 4 h | | | |
| Set 10.2 SDS Diluted | 9390 | 8020 | 85% |
| EcoSurf + SA 6 h | | | |
| Set 10.2 SDS Diluted | 3657 | 3230 | 88% |
| ETA + EcoSurf + SA ctr | | | |
| Set 10.2 SDS Diluted | 9425 | 8414 | 89% |
| ETA + EcoSurf + | | | |
| SA 15 min | | | |
| Set 10.2 SDS Diluted | 8632 | 7609 | 88% |
| ETA + EcoSurf + | | | |
| SA 30 min | | | |
| Set 10.2 SDS Diluted | 6998 | 6232 | 89% |
| ETA + EcoSurf + SA 1 h | | | |
| Set 10.2 SDS Diluted | 6073 | 5418 | 89% |
| ETA + EcoSurf + SA 2 h | | | |
| Set 10.2 SDS Diluted | 5887 | 5217 | 89% |
| ETA + EcoSurf + SA 4 h | | | |
| Set 10.2 SDS Diluted | 9501 | 8353 | 88% |
| ETA + EcoSurf + SA 6 h | | | |
| Set 10.2 SDS Washed + | 941 | 803 | 85% |
| Resuspended in ETA + | | | |
| EcoSurf + SA pH: | | | |
| 7 r3 1ctr | | | |
| Set 10.2 SDS Washed + | 5032 | 4492 | 89% |
| Resuspended in ETA + | | | |
| EcoSurf + SA pH: | | | |
| 7 r3 15 min | | | |
| Set 10.2 SDS Washed + | 6743 | 6037 | 90% |
| Resuspended in ETA + | | | |
| EcoSurf + SA pH: | | | |
| 7 r3 30 min | | | |
| Set 10.2 SDS Washed + | 7482 | 6671 | 89% |
| Resuspended in ETA + | | | |
| EcoSurf + SA pH: | | | |
| 7 r3 1 h | | | |
| Set 10.2 SDS Washed + | 6720 | 5959 | 89% |
| Resuspended in ETA + | | | |
| EcoSurf + SA pH: | | | |
| 7 r3 2 h | | | |
| Set 10.2 SDS Washed + | 5496 | 4880 | 89% |
| Resuspended in ETA + | | | |
| EcoSurf + SA pH: | | | |
| 7 r3 4 h | | | |
| Set 10.2 SDS Washed + | 8115 | 7195 | 89% |
| Resuspended in ETA + | | | |
| EcoSurf + SA pH: | | | |
| 7 r3 6 h | | | |

### Example 6

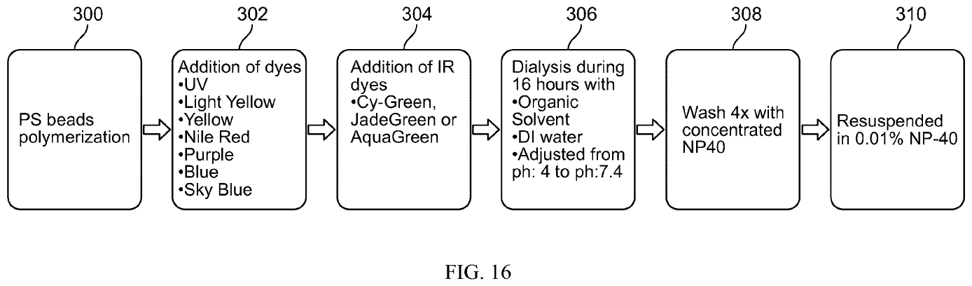

To investigate the best potential IR dye for use with fluorospheres of the present invention, fluorospheres of the present invention having either Jade Green, Aqua Green, or Cy Green were evaluated. Fluorospheres of the present invention (Set 11) having 8 dyes were prepared for evaluation. The fluorospheres included UV dye, Light Yellow dye, Yellow dye, Nile Red dye, Purple dye, Blue dye, Sky Blue dye, and either Aqua Green or Cy Green. In addition, fluorospheres of the present invention (Set 12) having 8 dyes were prepared for evaluation. The fluorospheres included UV dye, Light Yellow dye, Yellow dye, Nile Red dye, Purple dye, Blue dye, Sky Blue dye, and Jade Green. All three Sets (Set 11 with Aqua Green, Set 11 with Cy Green, and Set 12 with Jade Green) were prepared as shown in FIG. 16.

Fluorospheres with Cy Green (Set 11 with Cy Green) did not perform as well as fluorospheres with Aqua Green (Set 11 with Aqua Green) or Jade Green (Set 12 with Jade Green). Accordingly, only analysis for fluorospheres with Aqua Green or Jade Green are included.

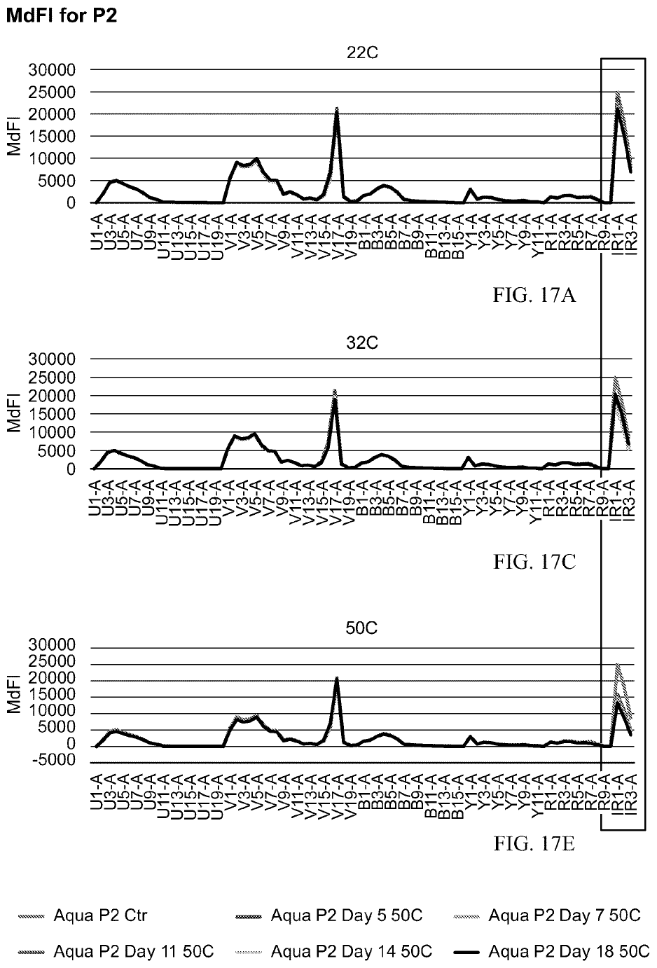

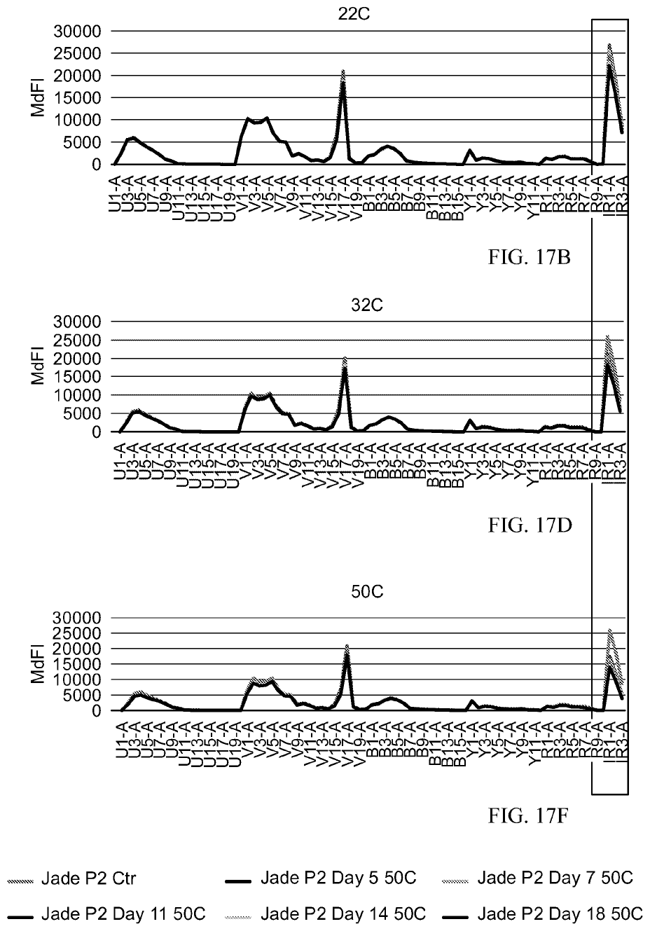

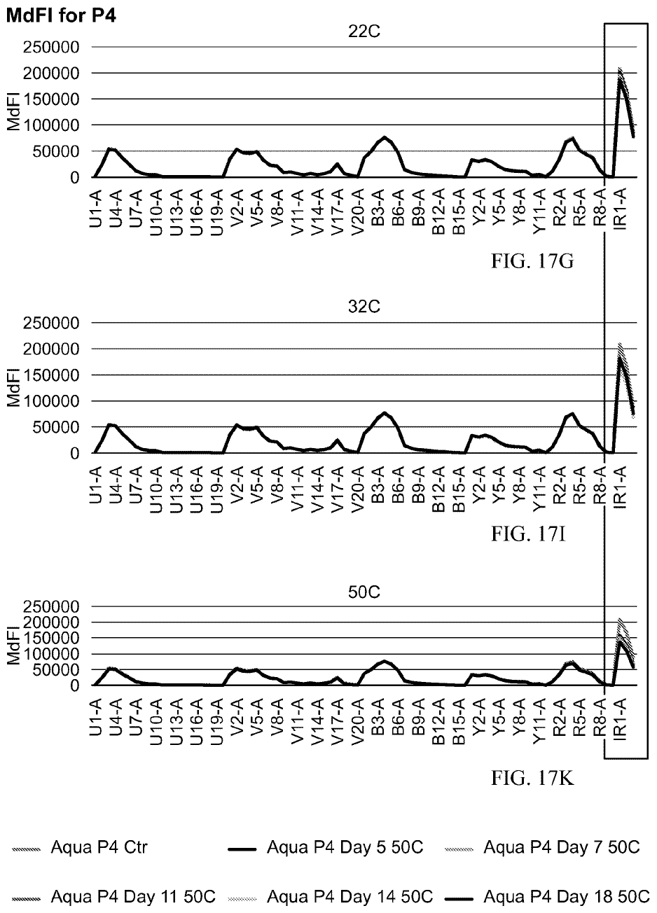

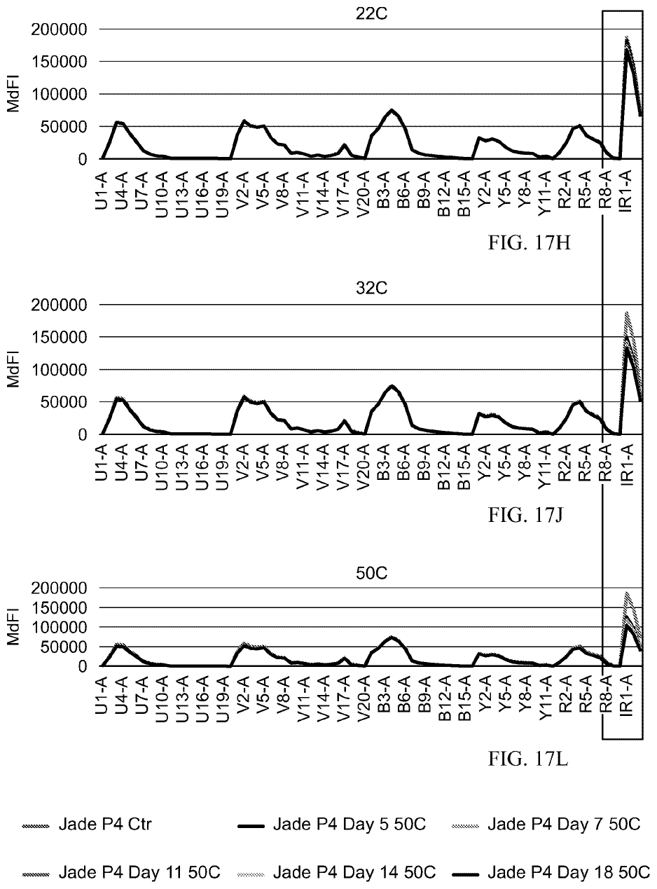

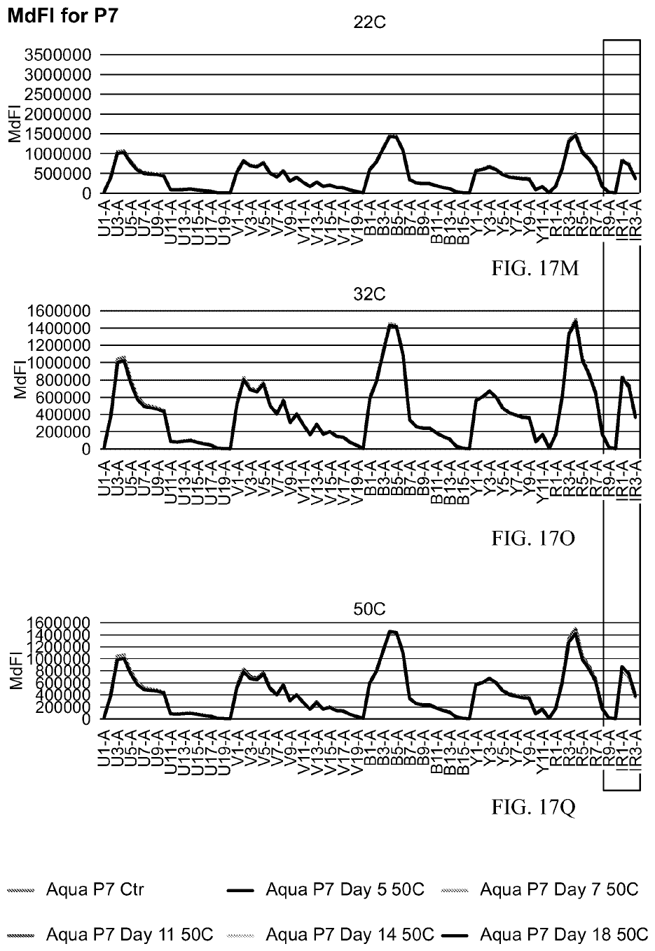

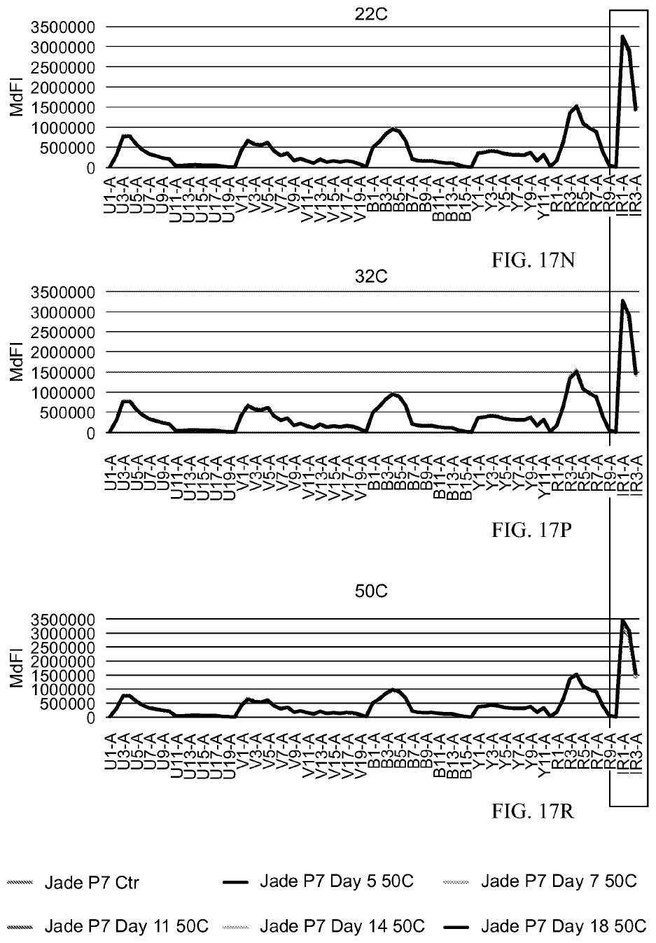

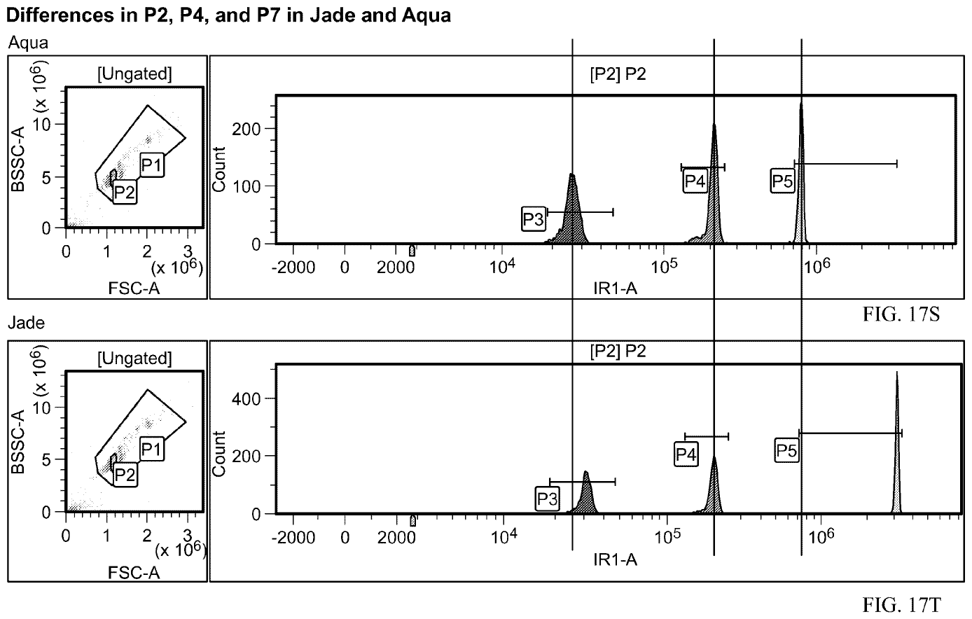

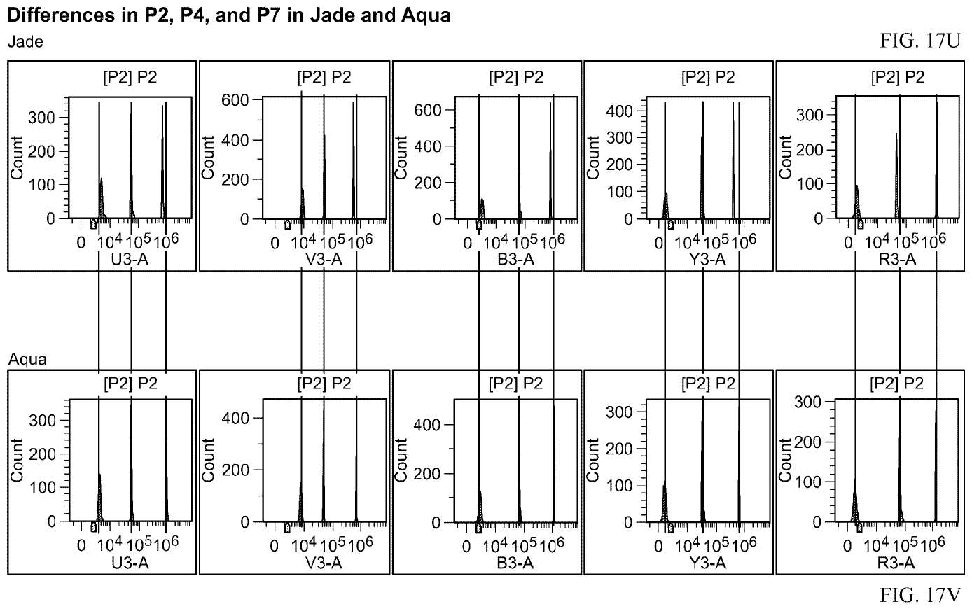

An MdFl analysis was performed on the samples. FIG. 17 shows the evaluation of fluorospheres of the present invention containing either Aqua Green dye or Jade Green dye as the IR excited dye. The MdFl analysis is for Peak 2 (FIGS. 17A-17F), Peak 4 (FIGS. 17G-17L), and Peak 7 (FIGS. 17M-17R).

FIG. 17A shows the MdFl analysis (Peak 2) of fluorospheres with Aqua Green dye that were incubated at 22° C. at Day 0, Day 5, Day 7, Day 11, Day 14, and Day 18.

FIG. 17B shows the MdFl analysis (Peak 2) of fluorospheres with Jade Green dye that were incubated at 22° C. at Day 0, Day 5, Day 7, Day 11, Day 14, and Day 18.

FIG. 17C shows the MdFl analysis (Peak 2) of fluorospheres with Aqua Green dye that were incubated at 32° C. at Day 0, Day 5, Day 7, Day 11, Day 14, and Day 18.

FIG. 17D shows the MdFl analysis (Peak 2) of fluorospheres with Jade Green dye that were incubated at 32° C. at Day 0, Day 5, Day 7, Day 11, Day 14, and Day 18.

FIG. 17E shows the MdFl analysis (Peak 2) of fluorospheres with Aqua Green dye that were incubated at 50° C. at Day 0, Day 5, Day 7, Day 11, Day 14, and Day 18.

FIG. 17F shows the MdFl analysis (Peak 2) of fluorospheres with Jade Green dye that were incubated at 50° C. at Day 0, Day 5, Day 7, Day 11, Day 14, and Day 18.

FIG. 17G shows the MdFl analysis (Peak 4) of fluorospheres with Aqua Green dye that were incubated at 22° C. at Day 0, Day 5, Day 7, Day 11, Day 14, and Day 18.

FIG. 17H shows the MdFl analysis (Peak 4) of fluorospheres with Jade Green dye that were incubated at 22° C. at Day 0, Day 5, Day 7, Day 11, Day 14, and Day 18.

FIG. 17I shows the MdFl analysis (Peak 4) of fluorospheres with Aqua Green dye that were incubated at 32° C. at Day 0, Day 5, Day 7, Day 11, Day 14, and Day 18.

FIG. 17J shows the MdFl analysis (Peak 4) of fluorospheres with Jade Green dye that were incubated at 32° C. at Day 0, Day 5, Day 7, Day 11, Day 14, and Day 18. FIG. 17K shows the MdFl analysis (Peak 4) of fluorospheres with Aqua Green dye that were incubated at 50° C. at Day 0, Day 5, Day 7, Day 11, Day 14, and Day 18. FIG. 17L shows the MdFl analysis (Peak 4) of fluorospheres with Jade Green dye that were incubated at 50° C. at Day 0, Day 5, Day 7, Day 11, Day 14, and Day 18.

FIG. 17M shows the MdFl analysis (Peak 7) of fluorospheres with Aqua Green dye that were incubated at 22° C. at Day 0, Day 5, Day 7, Day 11, Day 14, and Day 18.

FIG. 17N shows the MdFl analysis (Peak 7) of fluorospheres with Jade Green dye that were incubated at 22° C. at Day 0, Day 5, Day 7, Day 11, Day 14, and Day 18.

FIG. 17O shows the MdFl analysis (Peak 7) of fluorospheres with Aqua Green dye that were incubated at 32° C. at Day 0, Day 5, Day 7, Day 11, Day 14, and Day 18.

FIG. 17P shows the MdFl analysis (Peak 7) of fluorospheres with Jade Green dye that were incubated at 32° C. at Day 0, Day 5, Day 7, Day 11, Day 14, and Day 18. FIG. 17Q shows the MdFl analysis (Peak 7) of fluorospheres with Aqua Green dye that were incubated at 50° C. at Day 0, Day 5, Day 7, Day 11, Day 14, and Day 18. FIG. 17R shows the MdFl analysis (Peak 7) of fluorospheres with Jade Green dye that were incubated at 50° C. at Day 0, Day 5, Day 7, Day 11, Day 14, and Day 18.

FIG. 17S and FIG. 17T shows the differences at Peak 2, Peak 4, and Peak 7 between fluorospheres with Aqua Green dye (FIG. 17S) and fluorospheres with Jade Green dye (FIG. 17T) at channel IRIA. FIG. 17U and FIG. 17V show the differences at Peak 2, Peak 4, and Peak 7 between fluorospheres with Aqua Green dye (FIG. 17S) and fluorospheres with Jade Green dye (FIG. 17T) at channels U3A, V3A, B3A, Y3A, and R3A.

An evaluation of the MdFl % difference for each sample as function of time (Day 0, Day 5, Day 7, Day 11, Day 14, and Day 22) combined with temperature (22° C., 32° C., and 50° C.) was also conducted and is presented in Tables 16-18 below.

TABLE 16A
MdFl % Difference for Fluorospheres having either Aqua
Green or Jade Green as a Function of Time (Day 0,
Day 5, Day 7, Day 11, Day 14, Day 18) and Temperature
(22° C.), across Several Channels for Peak 2.

| | U3- | V3- | B3- | Y3- | R3- | IR1- | IR2- |
|---|---|---|---|---|---|---|---|
| TubeName | A | A | A | A | A | A | A |
| Jade P2 Ctr | 0% | 0% | 0% | 0% | 0% | 0% | 0% |
| Jade P2 Day 5 22 C. | 2% | 0% | 0% | 1% | −3% | 4% | 3% |
| Jade P2 Day 7 22 C. | 2% | 0% | 1% | 0% | −4% | −2% | −2% |
| Jade P2 Day 11 22 C. | 2% | 0% | 2% | −1% | −4% | −7% | −7% |
| Jade P2 Day 14 22 C. | 1% | 0% | 2% | 0% | −5% | −12% | −12% |
| Jade P2 Day 18 22 C. | 1% | −1% | 2% | 0% | −4% | −15% | −15% |
| Aqua P2 Ctr | 0% | 0% | 0% | 0% | 0% | 0% | 0% |
| Aqua P2 Day 5 22 C. | −1% | 0% | 0% | 0% | 0% | −5% | −7% |
| Aqua P2 Day 7 22 C. | 0% | 1% | 1% | 19% | 1% | −10% | −10% |
| Aqua P2 Day 11 22 C. | 0% | 0% | 0% | −1% | −1% | −12% | −13% |
| Aqua P2 Day 14 22 C. | −1% | 0% | 1% | 0% | 0% | −14% | −15% |
| Aqua P2 Day 18 22 C. | −1% | 3% | 3% | 0% | −2% | −15% | −17% |
| Jade P2 Ctr | 0% | 0% | 0% | 0% | 0% | 0% | 0% |
| Jade MIX Day 5 22 C. | 1% | −1% | 1% | 0% | 0% | −2% | −1% |
| Jade MIX Day 7 22 C. | 0% | −1% | 1% | −1% | −2% | −5% | −5% |
| Jade MIX Day 11 22 | −1% | −1% | 1% | −1% | −3% | −7% | −7% |
| C. | | | | | | | |
| Jade MIX Day 14 22 | 0% | −1% | 2% | −3% | −3% | −9% | −9% |
| C. | | | | | | | |
| Jade MIX Day 18 22 | 0% | 2% | 4% | −4% | −6% | −9% | −10% |
| C. | | | | | | | |
| Aqua P2 Ctr | 0% | 0% | 0% | 0% | 0% | 0% | 0% |
| Aqua P2 Day 5 22 C. | −1% | 0% | 0% | 0% | 0% | −5% | −7% |
| Aqua P2 Day 7 22 C. | 0% | 1% | 1% | 1% | 1% | −10% | −10% |
| Aqua P2 Day 11 22 C. | 0% | 0% | 0% | −1% | −1% | −12% | −13% |
| Aqua P2 Day 14 22 C. | −1% | 0% | 1% | 0% | 0% | −14% | −15% |
| Aqua P2 Day 18 22 C. | −1% | 3% | 3% | 0% | −2% | −15% | −17% |

TABLE 16B
MdFl % Difference for Fluorospheres having either Aqua Green or Jade
Green as a Function of Time (Day 0, Day 5, Day 7, Day 11, Day 14, Day
18) and Temperature (22° C.), across Several Channels for Peak 4.

| TubeName | U3-A | V3-A | B3-A | Y3-A | R3-A | IR1-A | IR2-A |
|---|---|---|---|---|---|---|---|
| Jade P4 Ctr | 0% | 0% | 0% | 0% | 0% | 0% | 0% |
| Jade P4 Day 5 22 C. | 0% | 0% | 0% | 0% | 0% | −3% | −3% |
| Jade P4 Day 7 22 C. | 1% | 0% | 0% | 0% | 0% | −7% | −7% |
| Jade P4 Day 11 22 C. | 0% | −1% | −1% | −1% | −1% | −7% | −7% |
| Jade P4 Day 14 22 C. | −1% | −2% | −1% | −1% | −1% | −9% | −9% |
| Jade P4 Day 18 22 C. | −1% | −1% | 0% | −1% | −1% | −10% | −10% |
| Aqua P4 Ctr | 0% | 0% | 0% | 0% | 0% | 0% | 0% |
| Aqua P4 Day 5 22 C. | 0% | 0% | 0% | 0% | 0% | −3% | −3% |
| Aqua P4 Day 7 22 C. | 0% | −1% | −1% | 0% | −1% | −6% | −6% |
| Aqua P4 Day 11 22 C. | 1% | 0% | 0% | 0% | −1% | −9% | −9% |
| Aqua P4 Day 14 22 C. | 0% | 0% | 0% | −1% | −1% | −11% | −11% |
| Aqua P4 Day 18 22 C. | −1% | 0% | 0% | −1% | −2% | −10% | −10% |
| Jade P4 Ctr | 0% | 0% | 0% | 0% | 0% | 0% | 0% |
| Jade MIX Day 5 22 C. | −1% | −1% | −1% | −1% | −1% | −2% | −2% |
| Jade MIX Day 7 22 C. | −1% | −1% | −1% | −1% | −1% | −5% | −5% |
| Jade MIX Day 11 22 C. | −1% | −1% | −1% | −1% | −1% | −6% | −6% |
| Jade MIX Day 14 22 C. | 0% | −1% | −1% | −2% | −2% | −9% | −8% |
| Jade MIX Day 18 22 C. | 0% | −1% | −1% | −4% | −3% | −9% | −9% |
| Aqua P4 Ctr | 0% | 0% | 0% | 0% | 0% | 0% | 0% |
| Aqua MIX Day 5 22 C. | −1% | −1% | 0% | −1% | −2% | −5% | −5% |
| Aqua MIX Day 7 22 C. | 1% | 0% | 0% | 0% | −2% | −10% | −10% |
| Aqua MIX Day 11 22 C. | 1% | 0% | 0% | 0% | −1% | −11% | −11% |
| Aqua MIX Day 14 22 C. | 2% | 1% | 1% | 0% | −1% | −11% | −10% |
| Aqua MIX Day 18 22 C. | 0% | 0% | 0% | −1% | −2% | −13% | −13% |

TABLE 16C
MdFl % Difference for Fluorospheres having either Aqua Green or Jade
Green as a Function of Time (Day 0, Day 5, Day 7, Day 11, Day 14, Day
18) and Temperature (22° C.), across Several Channels for Peak 7.

| TubeName | U3-A | V3-A | B3-A | Y3-A | R3-A | IR1-A | IR2-A |
|---|---|---|---|---|---|---|---|
| Jade P7 Ctr | 0% | 0% | 0% | 0% | 0% | 0% | 0% |
| Jade P7 Day 5 22 C. | 0% | 0% | 0% | 0% | 0% | 0% | 0% |
| Jade P7 Day 7 22 C. | 1% | 1% | 1% | 1% | 1% | 0% | 0% |
| Jade P7 Day 11 22 C. | 0% | 0% | 0% | 1% | 0% | 1% | 1% |
| Jade P7 Day 14 22 C. | 1% | 1% | 1% | 1% | 1% | 2% | 2% |
| Jade P7 Day 18 22 C. | 0% | −1% | 0% | −1% | −1% | 2% | 2% |
| Aqua P7 Ctr | 0% | 0% | 0% | 0% | 0% | 0% | 0% |
| Aqua P7 Day 5 22 C. | −2% | −1% | 0% | −1% | 0% | 0% | 0% |
| Aqua P7 Day 7 22 C. | −2% | −1% | −1% | −1% | −1% | −1% | −2% |
| Aqua P7 Day 11 22 C. | −1% | −1% | −1% | −1% | −1% | −1% | −1% |
| Aqua P7 Day 14 22 C. | −3% | −1% | −1% | −1% | −1% | 1% | 1% |
| Aqua P7 Day 18 22 C. | −3% | −2% | −1% | −2% | −2% | −2% | −2% |
| Jade P7 Ctr | 0% | 0% | 0% | 0% | 0% | 0% | 0% |
| Jade MIX Day 5 22 C. | 0% | 0% | 0% | 0% | 0% | 1% | 2% |
| Jade MIX Day 7 22 C. | 0% | 0% | 0% | 0% | 0% | 1% | 1% |
| Jade MIX Day 11 22 C. | −1% | 0% | 0% | 0% | −1% | 2% | 2% |
| Jade MIX Day 14 22 C. | 0% | 0% | 0% | −1% | −1% | 2% | 2% |
| Jade MIX Day 18 22 C. | 0% | 0% | 0% | −3% | −2% | 3% | 3% |
| Aqua P7 Ctr | 0% | 0% | 0% | 0% | 0% | 0% | 0% |
| Aqua MIX Day 5 22 C. | −3% | −1% | −1% | −1% | −1% | −1% | −1% |
| Aqua MIX Day 7 22 C. | −1% | 0% | 0% | 0% | −1% | −1% | −1% |
| Aqua MIX Day 11 22 C. | 0% | 0% | 0% | 0% | 0% | 0% | −1% |
| Aqua MIX Day 14 22 C. | 0% | 0% | 0% | 0% | 0% | 1% | 1% |
| Aqua MIX Day 18 22 C. | −2% | −1% | 0% | −1% | −1% | 1% | 1% |

TABLE 17A
MdFl % Difference for Fluorospheres having either Aqua Green or Jade
Green as a Function of Time (Day 0, Day 5, Day 7, Day 11, Day 14, Day
18) and Temperature (32° C.), across Several Channels for Peak 2.

| TubeName | U3-A | V3-A | B3-A | Y3-A | R3-A | IR1-A | IR2-A |
|---|---|---|---|---|---|---|---|
| Jade P2 Ctr | 0% | 0% | 0% | 0% | 0% | 0% | 0% |
| Jade P2 Day 5 32 C. | −3% | −4% | −1% | −7% | −7% | −18% | −20% |
| Jade P2 Day 7 32 C. | −5% | −5% | −2% | −7% | −8% | −22% | −24% |
| Jade P2 Day 11 32 C. | −6% | −6% | −1% | −8% | −8% | −25% | −27% |
| Jade P2 Day 14 32 C. | −7% | −6% | 0% | −8% | −9% | −29% | −31% |
| Jade P2 Day 18 32 C. | −7% | −6% | 0% | −6% | −9% | −29% | −31% |
| Aqua P2 Ctr | 0% | 0% | 0% | 0% | 0% | 0% | 0% |
| Aqua P2 Day 5 32 C. | −3% | −3% | −1% | −3% | −3% | −21% | −24% |
| Aqua P2 Day 7 32 C. | −1% | −2% | 0% | −2% | −3% | −25% | −27% |
| Aqua P2 Day 11 32 C. | −2% | −2% | 0% | −2% | −4% | −29% | −31% |
| Aqua P2 Day 14 32 C. | −4% | −2% | 0% | −2% | −4% | −31% | −34% |
| Aqua P2 Day 18 32 C. | −1% | 0% | 1% | 1% | −1% | −18% | −19% |
| Jade P2 Ctr | 0% | 0% | 0% | 0% | 0% | 0% | 0% |
| Jade MIX Day 5 32 C. | −5% | −5% | −1% | −5% | 7% | −20% | −21% |
| Jade MIX Day 7 32 C. | −6% | −6% | 0% | −6% | 2% | −22% | −23% |
| Jade MIX Day 11 32 C. | −6% | −6% | 0% | −5% | 1% | −25% | −26% |
| Jade MIX Day 14 32 C. | −6% | −6% | −1% | −6% | −1% | −25% | −27% |
| Jade MIX Day 18 32 C. | −7% | −7% | −1% | −7% | −1% | −26% | −29% |
| Aqua P2 Ctr | 0% | 0% | 0% | 0% | 0% | 0% | 0% |
| Aqua MIX Day 5 32 C. | −6% | −4% | −2% | −3% | −2% | −20% | −21% |
| Aqua MIX Day 7 32 C. | −3% | −3% | −1% | −3% | −3% | −24% | −26% |
| Aqua MIX Day 11 32 C. | −4% | −3% | 0% | −2% | −3% | −28% | −29% |
| Aqua MIX Day 14 32 C. | −4% | −3% | −1% | −3% | −4% | −28% | −30% |
| Aqua MIX Day 18 32 C. | −1% | 0% | 1% | 2% | −1% | −17% | −18% |

TABLE 17B
MdFl % Difference for Fluorospheres having either Aqua Green or Jade
Green as a Function of Time (Day 0, Day 5, Day 7, Day 11, Day 14, Day
18) and Temperature (32° C.), across Several Channels for Peak 4.

| TubeName | U3-A | V3-A | B3-A | Y3-A | R3-A | IR1-A | IR2-A |
|---|---|---|---|---|---|---|---|
| Jade P4 Ctr | 0% | 0% | 0% | 0% | 0% | 0% | 0% |
| Jade P4 Day 5 32 C. | −2% | −3% | −1% | −5% | −2% | −20% | −20% |
| Jade P4 Day 7 32 C. | −3% | −3% | −1% | −3% | −2% | −24% | −24% |
| Jade P4 Day 11 32 C. | −3% | −3% | −1% | −4% | −2% | −26% | −26% |
| Jade P4 Day 14 32 C. | −4% | −4% | −1% | −4% | −2% | −27% | −27% |
| Jade P4 Day 18 32 C. | −4% | −3% | −1% | −4% | −2% | −29% | −29% |
| Aqua P4 Ctr | 0% | 0% | 0% | 0% | 0% | 0% | 0% |
| Aqua P4 Day 5 32 C. | −1% | −1% | 0% | −2% | −1% | −15% | −15% |
| Aqua P4 Day 7 32 C. | −1% | −1% | −1% | −1% | −2% | −17% | −17% |
| Aqua P4 Day 11 32 C. | 0% | −1% | −1% | −1% | −2% | −20% | −20% |
| Aqua P4 Day 14 32 C. | −1% | −1% | 0% | 0% | −2% | −21% | −20% |
| Aqua P4 Day 18 32 C. | 0% | 0% | 0% | 2% | 1% | −13% | −12% |
| Jade P4 Ctr | 0% | 0% | 0% | 0% | 0% | 0% | 0% |
| Jade MIX Day 5 32 C. | −3% | −3% | −1% | −3% | −2% | −20% | −20% |
| Jade MIX Day 7 32 C. | −3% | −3% | −1% | −4% | −2% | −22% | −22% |
| Jade MIX Day 11 32 C. | −3% | −3% | −1% | −3% | −2% | −24% | −24% |
| Jade MIX Day 14 32 C. | −4% | −4% | −1% | −4% | −3% | −25% | −25% |
| Jade MIX Day 18 32 C. | −4% | −5% | −2% | −5% | −3% | −27% | −27% |
| Aqua P4 Ctr | 0% | 0% | 0% | 0% | 0% | 0% | 0% |
| Aqua MIX Day 5 32 C. | −3% | −2% | −1% | −2% | −3% | −17% | −17% |
| Aqua MIX Day 7 32 C. | 0% | −1% | 0% | −1% | −3% | −21% | −21% |
| Aqua MIX Day 11 32 C. | 0% | −1% | 0% | −1% | −2% | −23% | −23% |
| Aqua MIX Day 14 32 C. | 0% | −1% | 0% | −1% | −2% | −23% | −23% |
| Aqua MIX Day 18 32 C. | 0% | 0% | 1% | 1% | 1% | −14% | −14% |

TABLE 17C
MdFl % Difference for Fluorospheres having either Aqua Green or Jade
Green as a Function of Time (Day 0, Day 5, Day 7, Day 11, Day 14, Day
18) and Temperature (32° C.), across Several Channels for Peak 7.

| TubeName | U3-A | V3-A | B3-A | Y3-A | R3-A | IR1-A | IR2-A |
|---|---|---|---|---|---|---|---|
| Jade P7 Ctr | 0% | 0% | 0% | 0% | 0% | 0% | 0% |
| Jade P7 Day 5 32 C. | 0% | 0% | 0% | 0% | 0% | 0% | 0% |
| Jade P7 Day 7 32 C. | 0% | 0% | 1% | 1% | 0% | 1% | 0% |
| Jade P7 Day 11 32 C. | 1% | 0% | 1% | 1% | 0% | 1% | 1% |
| Jade P7 Day 14 32 C. | 1% | 1% | 1% | 2% | 1% | 1% | 1% |
| Jade P7 Day 18 32 C. | −1% | −1% | 0% | −1% | −1% | 3% | 2% |
| Aqua P7 Ctr | 0% | 0% | 0% | 0% | 0% | 0% | 0% |
| Aqua P7 Day 5 32 C. | −3% | −1% | 0% | −1% | −1% | −2% | −2% |
| Aqua P7 Day 7 32 C. | −1% | −1% | −1% | −1% | −1% | −2% | −2% |
| Aqua P7 Day 11 32 C. | −1% | −1% | 0% | 0% | −1% | −1% | −1% |
| Aqua P7 Day 14 32 C. | −3% | −2% | −1% | −1% | −1% | −1% | −2% |
| Aqua P7 Day 18 32 C. | −4% | −2% | −2% | 0% | −1% | −1% | −2% |
| Jade P7 Ctr | 0% | 0% | 0% | 0% | 0% | 0% | 0% |
| Jade MIX Day 5 32 C. | −1% | 0% | 0% | 0% | 0% | 0% | 0% |
| Jade MIX Day 7 32 C. | 0% | 0% | 0% | 0% | 0% | 1% | 1% |
| Jade MIX Day 11 32 C. | 0% | 0% | 0% | 0% | 0% | 2% | 2% |
| Jade MIX Day 14 32 C. | 0% | 0% | 0% | 0% | 0% | 2% | 2% |
| Jade MIX Day 18 32 C. | 0% | −1% | −1% | 0% | −1% | 2% | 1% |
| Aqua P7 Ctr | 0% | 0% | 0% | 0% | 0% | 0% | 0% |
| Aqua MIX Day 5 32 C. | −4% | −2% | −1% | −2% | −2% | −3% | −3% |
| Aqua MIX Day 7 32 C. | −1% | −1% | −1% | −1% | −1% | −2% | −3% |
| Aqua MIX Day 11 32 C. | −1% | −1% | 0% | −1% | −1% | −1% | −1% |
| Aqua MIX Day 14 32 C. | −2% | −1% | −1% | −1% | −1% | 0% | 0% |
| Aqua MIX Day 18 32 C. | −1% | 0% | 0% | 1% | 1% | 1% | 1% |

TABLE 18A
MdFl % Difference for Fluorospheres having either Aqua Green or Jade
Green as a Function of Time (Day 0, Day 5, Day 7, Day 11, Day 14, Day
18) and Temperature (50° C.), across Several Channels for Peak 2.

| TubeName | U3-A | V3-A | B3-A | Y3-A | R3-A | IR1-A | IR2-A |
|---|---|---|---|---|---|---|---|
| Jade P2 Ctr | 0% | 0% | 0% | 0% | 0% | 0% | 0% |
| Jade P2 Day 5 50 C. | −13% | −13% | −3% | −11% | −12% | −33% | −37% |
| Jade P2 Day 7 50 C. | −14% | −13% | −3% | −10% | −13% | −37% | −41% |
| Jade P2 Day 11 50 C. | −15% | −14% | −2% | −11% | −13% | −41% | −45% |
| Jade P2 Day 14 50 C. | 16% | −15% | −3% | −11% | −15% | −44% | −47% |
| Jade P2 Day 18 50 C. | −17% | −15% | −3% | −10% | −15% | −46% | −50% |
| Aqua P2 Ctr | 0% | 0% | 0% | 0% | 0% | 0% | 0% |
| Aqua P2 Day 5 50 C. | −6% | −6% | −1% | −3% | −6% | −37% | −40% |
| Aqua P2 Day 7 50 C. | −7% | −7% | −2% | −4% | −9% | −41% | −45% |
| Aqua P2 Day 11 50 C. | −8% | −8% | −2% | −4% | −10% | −44% | −49% |
| Aqua P2 Day 14 50 C. | −9% | −8% | −2% | −4% | −10% | −45% | −50% |
| Aqua P2 Day 18 50 C. | −10% | −9% | −2% | −6% | −11% | −47% | −52% |
| Jade P2 Ctr | 0% | 0% | 0% | 0% | 0% | 0% | 0% |
| Jade MIX Day 5 50 C. | −13% | −12% | −2% | −10% | −11% | −34% | −37% |
| Jade MIX Day 7 50 C. | −16% | −14% | −3% | −10% | −12% | −35% | −40% |
| Jade MIX Day 11 50 C. | −16% | −14% | −2% | −10% | −13% | −40% | −43% |
| Jade MIX Day 14 50 C. | −15% | −14% | −2% | −9% | −13% | −41% | −44% |
| Jade MIX Day 18 50 C. | −16% | −15% | −3% | −11% | −13% | −42% | −46% |
| Aqua P2 Ctr | 0% | 0% | 0% | 0% | 0% | 0% | 0% |
| Aqua MIX Day S 50 C. | −9% | −8% | −2% | −5% | −9% | −35% | −38% |
| Aqua MIX Day 7 50 C. | −7% | −8% | −2% | −4% | −9% | −39% | −41% |
| Aqua MIX Day 11 50 C. | −8% | −8% | −3% | −5% | −11% | −40% | −44% |
| Aqua MIX Day 14 50 C. | −9% | −7% | −1% | −3% | −10% | −43% | −47% |
| Aqua MIX Day 18 50 C. | −9% | −7% | −1% | −4% | −11% | −45% | −48% |

TABLE 18B
MdFl % Difference for Fluorospheres having either Aqua Green or Jade
Green as a Function of Time (Day 0, Day 5, Day 7, Day 11, Day 14, Day
18) and Temperature (50° C.), across Several Channels for Peak 4.

| TubeName | U3-A | V3-A | B3-A | Y3-A | R3-A | IR1-A | IR2-A |
|---|---|---|---|---|---|---|---|
| Jade P4 Ctr | 0% | 0% | 0% | 0% | 0% | 0% | 0% |
| Jade P4 Day 5 50 C. | −6% | −7% | −2% | −5% | −4% | −33% | −33% |
| Jade P4 Day 7 50 C. | −6% | −8% | −1% | −6% | −5% | −36% | −37% |
| Jade P4 Day 11 50 C. | −7% | −9% | −2% | −5% | −5% | −40% | −40% |
| Jade P4 Day 14 50 C. | −9% | −9% | −2% | −5% | −5% | −41% | −41% |
| Jade P4 Day 18 50 C. | −9% | −10% | −2% | −5% | −7% | −44% | −44% |
| Aqua P4 Ctr | 0% | 0% | 0% | 0% | 0% | 0% | 0% |
| Aqua P4 Day 5 50 C. | −2% | −2% | 0% | −1% | −2% | −24% | −24% |
| Aqua P4 Day 7 50 C. | −2% | −3% | −1% | −1% | −4% | −28% | −28% |
| Aqua P4 Day 11 50 C. | −3% | −4% | −1% | −2% | −5% | −31% | −31% |
| Aqua P4 Day 14 50 C. | −4% | −4% | −1% | −1% | −5% | −32% | −32% |
| Aqua P4 Day 18 50 C. | −4% | −4% | 0% | −1% | −6% | −35% | −34% |
| Jade P4 Ctr | 0% | 0% | 0% | 0% | 0% | 0% | 0% |
| Jade MIX Day 5 50 C. | −7% | −7% | −2% | −6% | −5% | −34% | −34% |
| Jade MIX Day 7 50 C. | −9% | −10% | −3% | −7% | −7% | −36% | −37% |
| Jade MIX Day 11 50 C. | −9% | −9% | −2% | −6% | −7% | −39% | −40% |
| Jade MIX Day 14 50 C. | −8% | −10% | −2% | −6% | −6% | −41% | −41% |
| Jade MIX Day 18 50 C. | −9% | −11% | −3% | −6% | −7% | −43% | −43% |
| Aqua P4 Ctr | 0% | 0% | 0% | 0% | 0% | 0% | 0% |
| Aqua MIX Day 5 50 C. | −3% | −3% | −1% | −2% | −4% | −29% | −29% |
| Aqua MIX Day 7 50 C. | −2% | −3% | 0% | −2% | −5% | −31% | −31% |
| Aqua MIX Day 11 50 C. | −3% | −4% | −1% | −2% | −6% | −34% | −34% |
| Aqua MIX Day 14 50 C. | −3% | −3% | 0% | −1% | −5% | −35% | −35% |
| Aqua MIX Day 18 50 C. | −4% | −3% | 0% | −1% | −6% | −37% | −37% |

TABLE 18C
MdFl % Difference for Fluorospheres having either Aqua Green or Jade
Green as a Function of Time (Day 0, Day 5, Day 7, Day 11, Day 14, Day
18) and Temperature (50° C.), across Several Channels for Peak 7.

| TubeName | U3-A | V3-A | B3-A | Y3-A | R3-A | IR1-A | IR2-A |
|---|---|---|---|---|---|---|---|
| Jade P7 Ctr | 0% | 0% | 0% | 0% | 0% | 0% | 0% |
| Jade P7 Day 5 50 C. | −2% | −2% | 0% | 0% | −1% | 1% | 1% |
| Jade P7 Day 7 50 C. | −2% | −2% | 1% | 1% | 0% | 3% | 2% |
| Jade P7 Day 11 50 C. | 0% | −2% | 2% | 2% | 0% | 5% | 4% |
| Jade P7 Day 14 50 C. | 0% | −2% | 2% | 3% | 1% | 6% | 4% |
| Jade P7 Day 18 50 C. | −2% | −3% | 2% | 2% | 0% | 9% | 8% |
| Aqua P7 Ctr | 0% | 0% | 0% | 0% | 0% | 0% | 0% |
| Aqua P7 Day 5 50 C. | −3% | −3% | 0% | 0% | −1% | −2% | −3% |
| Aqua P7 Day 7 50 C. | −3% | −4% | −1% | −1% | −3% | −1% | −2% |
| Aqua P7 Day 11 50 C. | −4% | −4% | 0% | 0% | −4% | 1% | 0% |
| Aqua P7 Day 14 50 C. | −5% | −4% | 0% | 0% | −4% | 1% | 0% |
| Aqua P7 Day 18 50 C. | −5% | −5% | 0% | 0% | −5% | 4% | 3% |
| Jade P7 Ctr | 0% | 0% | 0% | 0% | 0% | 0% | 0% |
| Jade MIX Day 5 50 C. | −2% | −2% | 0% | 0% | −1% | 2% | 1% |
| Jade MIX Day 7 50 C. | −3% | −4% | −1% | 0% | −2% | 3% | 2% |
| Jade MIX Day 11 50 C. | −3% | −3% | 1% | 1% | −1% | 6% | 5% |
| Jade MIX Day 14 50 C. | −2% | −3% | 1% | 2% | 0% | 7% | 6% |
| Jade MIX Day 18 50 C. | −2% | −4% | 1% | 2% | 0% | 10% | 9% |
| Aqua P7 Ctr | 0% | 0% | 0% | 0% | 0% | 0% | 0% |
| Aqua MIX Day 5 50 C. | −4% | −3% | −1% | −1% | −3% | −2% | −3% |
| Aqua MIX Day 7 50 C. | −2% | −3% | 0% | 0% | −3% | −1% | −1% |
| Aqua MIX Day 11 50 C. | −3% | −4% | −1% | −1% | −4% | 2% | 1% |
| Aqua MIX Day 14 50 C. | −3% | −4% | 0% | 1% | −3% | 2% | 1% |
| Aqua MIX Day 18 50 C. | −4% | −4% | 1% | 1% | −4% | 4% | 3% |

### NUMBERED CLAUSES

1. A suspension for quality control of a flow cytometer comprising:
fluorospheres, wherein the suspension of fluorospheres include individual fluorospheres having an infrared fluorescence emission greater than 800 nm when excited with an infrared laser and at least one fluorescence emission between 355 nm and 800 nm when excited at a wavelength of less than 800 nm;
at least one surfactant; and
at least one stabilizer or preservative.
2. The suspension of clause 1, wherein the individual fluorospheres are encapsulated with at least one dye having an infrared fluorescence emission greater than 800 nm when excited with an infrared laser and at least one dye having at least one fluorescence emission between 355 nm and 800 nm when excited at a wavelength of less than 800 nm.
3. The suspension of clause 2, wherein the at least one dye having an infrared fluorescence emission greater than 800 nm when excited with an infrared laser is selected from the group consisting of: Aqua Green, Jade Green, Cy Green, Indo cyanine green (ICG), Cy7, or Cy7.5, IR dye 800CW, or any combination thereof.
4. The suspension of clause 3, wherein the at least one dye having an infrared fluorescence emission greater than 800 nm when excited with an infrared laser is Aqua Green.
5. The suspension of any one of clauses 2-4, wherein the at least one dye having an infrared fluorescence emission greater than 800 nm is excited with an infrared laser at a wavelength of 808 nm.
6. The suspension of any one of clauses 2-5, wherein the at least one dye having at least one fluorescence emission between 355 nm and 800 nm when excited at a wavelength of less than 800 nm is selected from the group consisting of: a small organic dye, a phycobiliprotein, quantum dots, a polymer dye, a fluorescent protein, a tandem dye, UV, Light Yellow, Yellow, Nile Red, Purple, Blue, Sky Blue, or any combination thereof.
7. The suspension of any one of clauses 2-6, wherein the individual fluorospheres are encapsulated with at least seven dyes having seven fluorescence emissions between 355 nm and 800 nm when excited at a wavelength of less than 800 nm selected from the group consisting of: a small organic dye, a phycobiliprotein, quantum dots, a polymer dye, a fluorescent protein, a tandem dye, UV, Light Yellow, Yellow, Nile Red, Purple, Blue, Sky Blue, or any combination thereof.
8. The suspension of any one of clauses 2-7, wherein individual fluorospheres are encapsulated with seven dyes having seven fluorescence emissions between 355 nm and 800 nm when excited by five lasers having the following wavelengths: 355 nm, 405 nm, 488 nm, 561 nm, and 638 nm.
9. The suspension of any one of clauses 2-8, wherein the individual fluorospheres are encapsulated with eight dyes having eight fluorescence emissions when excited by six lasers having the following wavelengths: 355 nm (UV), 405 nm (Violet), 488 nm (Blue), 561 nm (Yellow-Green), 638 nm (Red), and 808 nm (Infrared).
10. The suspension of any one of clauses 1-9, wherein the fluorospheres are polystyrene beads.
11. The suspension of any one of clauses 1-10, wherein the fluorospheres have a diameter of between 2.5 μm and 6.5 μm.
12. The suspension of any one of clauses 1-11, wherein the fluorospheres have a diameter between 2.8 μm and 3.4 μm.
13. The suspension of any one of clauses 1-12, wherein the fluorospheres have a diameter of about 3.0 μm.
14. The suspension of any one of clauses 1-13, wherein the fluorospheres in the suspension have a concentration between 0.4×10⁶ fluorospheres/mL and 1.5×10⁶ fluorospheres/mL.
15. The suspension of any one of clauses 1-14, wherein the fluorospheres in the suspension have a concentration between 0.9×10⁶ fluorospheres/mL and 1.1×10⁶ fluorospheres/mL.
16. The suspension of any one of clauses 1-15, wherein the fluorospheres in the suspension have a concentration of about 1.0×10⁶ fluorospheres/mL.
17. The suspension of any one of clause 1-16, wherein the at least one surfactant is selected from the group consisting of: an ionic surfactant, a non-ionic surfactant, Sodium Dodecyl Sulfate (SDS), NP-40s, Ecosurf EH-9, Ecosurf SA-9, Ecosurf Tween 20, Triton X-11, or any combination thereof.
18. The suspension of any one of clauses 1-17, wherein the at least one surfactant is at a concentration between 0.01% and 1% based on the total volume of the suspension.
19. The suspension of any one of clauses 1-18, wherein the at least one surfactant is EcoSurf EH-9 is at a concentration is 0.05% based on the total volume of the suspension.
20. The suspension of any one of clauses 1-19, wherein the at least one stabilizer is selected from the group consisting of: a stabilized reducing agent, a stabilized thiol containing compound, (S)-2-Aminobutane-1,4-dithiol hydrochloride, dithiothreitol (DTT), Tris(2-carboxyethyl)phosphine (TCEP) or any combination thereof.
21. The suspension of any one of clauses 1-20, wherein the at least one preservative is selected from the group consisting of: sodium azide, thimerosal, or any combination thereof.
22. A method for quality controlling a flow cytometer using a single peak comprising:
(a) loading a quality control suspension of any one of clauses 1-21 into a flow cytometer;
(b) evaluating at least one of the following:
   (i) evaluating power of at least one laser in the flow cytometer based on a single peak analysis;
   (ii) evaluating EPS of at least one laser in the flow cytometer based on a single peak analysis;
   (iii) evaluating laser delay of at least one laser in the flow cytometer based on a single peak analysis;
   (iv) evaluating gain of at least one laser in the flow cytometer based on a single peak analysis;
   (v) evaluating rCV of at least one laser in the flow cytometer based on a single peak analysis; and
(c) determining whether the flow cytometer passes or fails quality control based on the evaluations in step (b).
23. The method of clause 22, wherein the evaluating in step (b) includes evaluating each of steps (b)(i) through (b)(v).
24. The method of any one of clauses 22-23, wherein the evaluation in step (b) is performed on an infrared laser and at least one laser with a wavelength of less than 800 nm.
25. The method of any one of clauses 22-24, wherein the evaluation in step (b) is performed on seven lasers having the following wavelengths: 355 nm (UV), 405 nm (Violet), 488 nm (Blue), 561 nm (Yellow-Green), 638 nm (Red), and 808 nm (Infrared).
26. The method of clause 25, wherein the 355 (UV) laser, 405 nm (Violet) laser, 488 nm (Blue) laser, 561 nm (Yellow-Green) laser, and 638 nm (Red) laser are evaluated on detector channel 3 or detector channel 4 of the flow cytometer, and wherein the 808 nm (Infrared) laser is evaluated on detector channel 1 or detector channel 2 of the flow cytometer.
27. The method of any one of clauses 22-26, further comprising: generating a quality control report following step (c).
28. The method of any one of clauses 22-27, wherein the method for quality controlling a flow cytometer is performed at least once per day.
29. The method of any one of clauses 22-27, wherein the method for quality controlling a flow cytometer is performed before using the flow cytometer.
30. A method for quality controlling a flow cytometer using multiple peaks comprising:
(a) loading a quality control suspension of any one of clauses 1-21 into the flow cytometer to perform a quality control analysis based on more than one peak,
(b) adjusting the brightest peak to a target median fluorescence intensity;
(c) reading the median fluorescence intensity and rCV for each of the peaks;
(d) unloading the quality control suspension from the flow cytometer following step (c);
(e) loading polystyrene beads without fluorescence into the flow cytometer;
(f) reading the median fluorescence intensity for the polystyrene beads without fluorescence; and
(g) calculating a sensitivity and background.
31. The method of clause 30, wherein there are three peaks, a bright peak, a mild peak, and a dim peak.
32. The method of any one of clauses 30-31, wherein the target median fluorescence intensity for step (f) is between 500,000 and 4×10⁶.
33. The method of any one of clauses 30-32, wherein the sensitivity and background comprise MESF sensitivity, Quantum efficiency, or Background.
34. The method of any one of clauses 30-33, wherein step (a) is concurrent with step (e).
35. The method of any one of clauses 30-34, further comprising: generating a quality control report following step (k).
36. A kit for performing the method according to any one of clauses 22-35, the kit comprising:
a suspension of any one of clauses 1-21;
at least one vial to hold the suspension; and
instructions for using the kit.
37. The kit of clause 36, further comprising a second vial to hold the suspension.
38. The kit of clause 37, wherein the two vials are each 10 mls.
39. The kit of clause 36, further comprising a second vial containing a suspension of polystyrene beads with no dye.
40. The kit of clause 39, wherein the diameter of the polystyrene beads in the second vial is about 1 μm.
41. The kit of any one of clauses 39-40, wherein the concentration of the polystyrene beads in the second vial is between 0.4×10⁶ fluorospheres/mL and 1.5×10⁶ fluorospheres/mL.
42. A suspension for quality control of a flow cytometer comprising:
fluorospheres encapsulated with at least one dye having a fluorescence emission, wherein the suspension of fluorospheres include individual fluorospheres having an infrared fluorescence emission greater than 800 nm when excited with an infrared laser and at least one fluorescence emission between 355 nm and 800 nm when excited at a wavelength of less than 800 nm;
at least one surfactant; and
at least one stabilizer or preservative.
43. The suspension of clause 42, wherein the suspension of fluorospheres having a fluorescence emission greater than 800 nm when excited with an infrared laser are encapsulated with at least one dye selected from the group consisting of: Aqua Green, Jade Green, Cy Green, Indo cyanine green (ICG), Cy7, or Cy7.5, IR dye 800CW, or any combination thereof.
44. The suspension of clause 42 or 43, wherein the suspension of fluorospheres having a fluorescence emission between 355 nm and 800 nm when excited at a wavelength of less than 800 nm are encapsulated with at least one dye selected from the group consisting of: a small organic dye, a phycobiliprotein, quantum dots, a polymer dye, a fluorescent protein, a tandem dye, UV, Light Yellow, Yellow, Nile Red, Purple, Blue, Sky Blue, or any combination thereof.
45. The suspension of any one of clauses 42-44, wherein the individual fluorospheres are encapsulated with at least seven dyes having seven fluorescence emissions between 355 nm and 800 nm when excited at a wavelength of less than 800 nm selected from the group consisting of: a small organic dye, a phycobiliprotein, quantum dots, a polymer dye, a fluorescent protein, a tandem dye, UV, Light Yellow, Yellow, Nile Red, Purple, Blue, Sky Blue, or any combination thereof.
46. The suspension of any one of clauses 42-45, wherein the individual fluorospheres are encapsulated with eight dyes having eight fluorescence emissions when excited by six lasers having the following wavelengths: 355 nm (UV), 405 nm (Violet), 488 nm (Blue), 561 nm (Yellow-Green), 638 nm (Red), and 808 nm (Infrared).
47. The suspension of any one of clauses 42-46, wherein the fluorospheres have a diameter of between 2.5 μm and 6.5 μm.
48. The suspension of any one of clauses 42-47, wherein the fluorospheres in the suspension have a concentration between 0.4×10⁶ fluorospheres/mL and 1.5×10⁶ fluorospheres/mL.
49. The suspension of any one of clauses 42-48, wherein the at least one surfactant is selected from the group consisting of: an ionic surfactant, a non-ionic surfactant, Sodium Dodecyl Sulfate (SDS), NP-40s, Ecosurf EH-9, Ecosurf SA-9, Ecosurf Tween 20, Triton X-11, or any combination thereof and the at least one stabilizer is selected from the group consisting of: a stabilized reducing agent, a stabilized thiol containing compound, (S)-2-Aminobutane-1,4-dithiol hydrochloride, dithiothreitol (DTT), Tris(2-carboxyethyl) phosphine (TCEP) or any combination thereof and the at least one preservative is selected from the group consisting of: sodium azide, thimerosal, or any combination thereof.
50. The suspension of any one of clauses 42-49, wherein the at least one surfactant is at a concentration between 0.01% and 1% based on the total volume of the suspension.
51. A method for quality controlling a flow cytometer using a single peak comprising:
(a) loading a quality control suspension of any one of clauses 42-50 into a flow cytometer;
(b) evaluating at least one of the following:
   (i) evaluating power of at least one laser in the flow cytometer based on a single peak analysis;
   (ii) evaluating EPS of at least one laser in the flow cytometer based on a single peak analysis;
   (iii) evaluating laser delay of at least one laser in the flow cytometer based on a single peak analysis;
   (iv) evaluating gain of at least one laser in the flow cytometer based on a single peak analysis;
   (v) evaluating rCV of at least one laser in the flow cytometer based on a single peak analysis; and
(c) determining whether the flow cytometer passes or fails quality control based on the evaluations in step (b).
52. The method of clause 51, wherein the evaluating in step (b) includes evaluating each of steps (b)(i) through (b)(v).
53. A method for quality controlling a flow cytometer using multiple peaks comprising:
(a) loading a quality control suspension of any one of clauses 42-49 into the flow cytometer to perform a quality control analysis based on more than one peak,
(b) adjusting the brightest peak to a target median fluorescence intensity;
(c) reading the median fluorescence intensity and rCV for each of the peaks;
(d) unloading the quality control suspension from the flow cytometer following step (c);
(e) loading polystyrene beads without fluorescence into the flow cytometer;
(f) reading the median fluorescence intensity for the polystyrene beads without fluorescence; and
(g) calculating a sensitivity and background.
54. The method of clause 53, wherein there are three peaks, a bright peak, a mild peak, and a dim peak.
55. The method of any one of clauses 53-54, wherein the target median fluorescence intensity for step (f) is between 500,000 and 4×10⁶.
56. The method of any one of clauses 53-55, wherein the sensitivity and background comprise MESF sensitivity, Quantum efficiency, or Background.

1. A suspension for quality control of a flow cytometer comprising:
fluorospheres encapsulated with at least one dye having a fluorescence emission, wherein the suspension of fluorospheres include individual fluorospheres having an infrared fluorescence emission greater than 800 nm when excited with an infrared laser at a wavelength of 808 nm and at least one fluorescence emission between 355 nm and 800 nm when excited at a wavelength of less than 800 nm;
at least one surfactant; and
at least one stabilizer or preservative.

2. The suspension of claim 1, wherein the suspension of fluorospheres having a fluorescence emission greater than 800 nm when excited with an infrared laser are encapsulated with at least one dye selected from the group consisting of: Aqua Green, Jade Green, Cy Green, Indo cyanine green (ICG), Cy7, Cy7.5, IR dye 800CW, and any combination thereof,
optionally wherein the suspension of fluorospheres having a fluorescence emission greater than 800 nm when excited with an infrared laser are encapsulated with at least one dye selected from the group consisting of: Aqua Green and Jade Green.

3. The suspension of claim 1, wherein the suspension of fluorospheres having a fluorescence emission between 355 nm and 800 nm when excited at a wavelength of less than 800 nm are encapsulated with at least one dye selected from the group consisting of: a small organic dye, a phycobiliprotein, quantum dots, a polymer dye, a fluorescent protein, a tandem dye, UV, Light Yellow, Yellow, Nile Red, Purple, Blue, Sky Blue, or any combination thereof.

4. The suspension of claim 1, wherein the individual fluorospheres are encapsulated with at least seven dyes having seven fluorescence emissions between 355 nm and 800 nm when excited at a wavelength of less than 800 nm selected from the group consisting of: a small organic dye, a phycobiliprotein, quantum dots, a polymer dye, a fluorescent protein, a tandem dye, UV, Light Yellow, Yellow, Nile Red, Purple, Blue, Sky Blue, and any combination thereof.

5. The suspension of claim 1, wherein the individual fluorospheres are encapsulated with eight dyes having eight fluorescence emissions when excited by six lasers having the following wavelengths: 355 nm (UV), 405 nm (Violet), 488 nm (Blue), 561 nm (Yellow-Green), 638 nm (Red), and 808 nm (Infrared).

6. The suspension of claim 1, wherein the fluorospheres have a diameter of between 2.5 μm and 6.5 μm.

7. The suspension of claim 1, wherein the fluorospheres in the suspension have a concentration between 0.4×10⁶ fluorospheres/mL and 1.5×10⁶ fluorospheres/mL.

8. The suspension of claim 1, wherein the at least one surfactant is selected from the group consisting of: an ionic surfactant, a non-ionic surfactant, Sodium Dodecyl Sulfate (SDS), NP-40s, Ecosurf EH-9, Ecosurf SA-9, Ecosurf Tween 20, Triton X-11, or any combination thereof, optionally wherein the at least one surfactant is selected from the group consisting of SDS, Ecosurf EH-9 (CAS: 64366-70-7), and Ecosurf SA-9 (CAS: 68937-66-6), further optionally wherein the at least one surfactant is at a concentration between 0.01% and 1% based on the total volume of the suspension.

9. The suspension of claim 1, wherein
the at least one stabilizer is selected from the group consisting of: a stabilized reducing agent, a stabilized thiol containing compound, (S)-2-Aminobutane-1,4-dithiol hydrochloride, dithiothreitol (DTT), Tris(2-carboxyethyl)phosphine (TCEP), and any combination thereof;
the at least one preservative is selected from the group consisting of: sodium azide, thimerosal, or any combination thereof.

10. A method for quality controlling a flow cytometer using a single peak comprising:
(a) loading a quality control suspension of claim 1 into a flow cytometer;
(b) evaluating at least one of the following:
(i) evaluating power of at least one laser in the flow cytometer based on a single peak analysis;
(ii) evaluating EPS of at least one laser in the flow cytometer based on a single peak analysis;
(iii) evaluating laser delay of at least one laser in the flow cytometer based on a single peak analysis;
(iv) evaluating gain of at least one laser in the flow cytometer based on a single peak analysis;
(v) evaluating rCV of at least one laser in the flow cytometer based on a single peak analysis; and
(c) determining whether the flow cytometer passes or fails quality control based on the evaluations in step (b).

11. The method of claim 10, wherein the evaluating in step (b) includes evaluating each of steps (b)(i) through (b)(v).

12. A method for quality controlling a flow cytometer using multiple peaks comprising:
(a) loading a quality control suspension of claim 1 into the flow cytometer to perform a quality control analysis based on more than one peak,
(b) adjusting the brightest peak to a target median fluorescence intensity;
(c) reading the median fluorescence intensity and rCV for each of the peaks;
(d) unloading the quality control suspension from the flow cytometer following step (c);
(e) loading polystyrene beads without fluorescence into the flow cytometer;
(f) reading the median fluorescence intensity for the polystyrene beads without fluorescence; and
(g) calculating a sensitivity and background.

13. The method of claim 12, wherein the multiple peaks comprise three peaks, a bright peak, a mild peak, and a dim peak.

14. The method of claim 12, wherein the target median fluorescence intensity for step (f) is between 500,000 and 4×10⁶.

15. The method of claim 12, wherein the sensitivity and background comprise MESF sensitivity, Quantum efficiency, or Background.

16. The suspension of claim 2, wherein the suspension of fluorospheres having a fluorescence emission greater than 800 nm when excited with an infrared laser are encapsulated with at least one dye selected from the group consisting of: Aqua Green and Jade Green.

17. The suspension of claim 8, wherein the at least one surfactant is selected from the group consisting of SDS, Ecosurf EH-9 (CAS: 64366-70-7), and Ecosurf SA-9 (CAS: 68937-66-6).

18. The suspension of claim 8 wherein
the at least one stabilizer is selected from the group consisting of: a stabilized reducing agent, a stabilized thiol containing compound, (S)-2-Aminobutane-1,4-dithiol hydrochloride, dithiothreitol (DTT), Tris(2-carboxyethyl)phosphine (TCEP), and any combination thereof; and
the at least one preservative is selected from the group consisting of: sodium azide, thimerosal, and any combination thereof.

19. The suspension of claim 18, wherein the at least one surfactant is at a concentration between 0.01% and 1% based on the total volume of the suspension.

20. The suspension of claim 1, wherein the suspension of fluorospheres having a fluorescence emission greater than 800 nm when excited with an infrared laser are encapsulated with at least one dye selected from the group consisting of: Aqua Green and Jade Green.
